(19) United States
(12) Patent Application Publication
(10) Pub. No.: US 2011/0155192 A1
(43) Pub. Date: Jun. 30, 2011

(54) SYSTEM AND APPARATUS FOR AUTOMATIC BUILT-IN VEHICLE WASHING AND OTHER OPERATIONS

(76) Inventors: NADEEM AHMAD, ELK GROVE, CA (US); NAEEM AHMAD, ELK GROVE, CA (US)

(21) Appl. No.: 12/869,634

(22) Filed: Aug. 26, 2010

Related U.S. Application Data
(63) Continuation-in-part of application No. 12/071,832, filed on Feb. 27, 2008.

(30) Foreign Application Priority Data
Feb. 27, 2009 (US) PCT/US09/35594

(51) Int. Cl. B60S 1/66

(52) U.S. Cl. 134/56 R

(57) ABSTRACT

A self-contained built-in automatic vehicle washing system is constructed from a water supply, a delivery system (e.g., manifold and tubular lines), and spray nozzles. The washing system can be pressurized at a reservoir or at the manifold. The nozzles can be strategically positioned to effective coverage for the application of cleansers, water, wax, and/or heat for washing the vehicle. A rotating bar can slide out from under the vehicle to provide wash nozzles mounted to the bar access to the body exterior of the car. The rotating bar and mounted wash nozzles may also be used in undercarriage cleansing of the vehicle. The nozzles can be turned on and off via valves and a controller in a sequence for washing the vehicle.

### PRIORITY CLAIM

This application is a continuation-in-part and claims the benefit of priority of commonly assigned U.S. patent application Ser. No. 12/071,832, filed Feb. 27, 2008, the entire disclosures of which are incorporated herein by reference.

This application claims the benefit of priority of the International Patent Application number PCT/US09/35594, filed Feb. 27, 2009, the entire disclosures of which are incorporated herein by reference.

### BACKGROUND OF THE INVENTION

1. Field of Invention

The present invention relates to systems for automated vehicle washing, and more particularly to an automated built-in vehicle washing system. The washing system may be partially or entirely self-contained on the vehicle.

2. Discussion of Background

Automatic car washing systems have been built for many years. These prior art systems include substantial investment in heavy equipment and operational costs. Although useful for cleaning cars, they are not always available (being limited to certain locations), and, particularly if utilized on a regular basis (e.g., daily, weekly), users stand to incur substantial user fees and time.

### SUMMARY OF THE INVENTION

The present inventor has realized the need for automated built-in wash systems for cars and other vehicles. The systems are, for example, entirely self-contained or may utilize outside resources for the supply of water, chemicals, and/or pressurization. The systems are also customizable and programmable to match unique characteristics of structurally different vehicles, environments in which the vehicles are operated, and preferences of individual operators.

In one embodiment, the present invention provides a self-contained built-in automatic vehicle washing system, comprising a main wash reservoir, at least one wash nozzle, a delivery system coupled to the main wash reservoir and the wash nozzle and configured to deliver liquid from the main reservoir to the wash nozzle, a pressure mechanism configured to pressurize the delivery system, and a control device configured to operate the pressure mechanism and delivery system in a manner according to at least one wash cycle. The at least one wash nozzle may comprise, for example, a plurality of wash nozzles arranged in a pattern such that when pressurized liquid is delivered to the wash nozzles such that all areas of the vehicle to be washed are inundated with liquid spray from the wash nozzles. At least one wash nozzle may be mounted on a moveable support member intended to direct a flow from the nozzles to a greater range of coverage of areas to be washed.

The control device may be optimally configured to initiate a plurality of wash cycles including any of, for example, an exterior wash cycle, engine wash cycle, a tire cleaning cycle, a wax cycle, and a rinse cycle. In one embodiment, system pressure and washing power are concentrated on difficult cleaning areas of the vehicle including a frontal impact areas and lower panel impact areas.

The present invention may be embodied as a device, apparatus, mechanism, or system attached to a vehicle. Any of the individual aspects of the invention as described herein may also be applied to commercial grade, or particularly custom-built, washing systems at traditional fixed location washing stations (for example, programming that controls a washing arm or wand such that is movement matches a contour of a vehicle is an ideal enhancement that advantageously improves fixed location systems).

The present invention provides, for example, an on board vehicle/automobile washing system. The washing system is an on board vehicle washing system that can be a totally self-contained system to pre-soak wash, clean rinse, and shine the exterior surface of a vehicle (or interior areas such as engine compartments). In one embodiment, the system is installed in a vehicle comprising of external water supply line hookup, water filtering system, and water softening system. The system preferably includes a hot water or liquid heating system (e.g., any of instantaneous, filament, engine exhaust, or other heaters) so liquids can be heated (e.g., to specific temperatures) for each wash cycle before spraying and, for example, to keep the liquids from freezing in cold climates. Fluid storage tanks are used, for example, to hold soaps & detergents, hot or cold wax, water repellent liquids and any other liquids that may be used in the system (e.g. plurality of storage tanks for storage of various liquids). Having a single or plurality of pumps (depending on design) for pressurization/pumping of fluids to be transmitted through fluid transmission lines (hoses, high pressure hoses, hollow metal lines, etc), valves, manifolds, and discharge nozzles (e.g., nozzles located on the exterior surface of the vehicle). Plurality of various fluid discharge nozzles including but not limited to: 1. High-pressure nozzles, 2. Zero Degrees Nozzle, 3. Fast Rotating Turbo Nozzles, 4. Slow rotating turbo nozzles, 5. Oscillating nozzles, and 6. Scrubbing nozzles. Each type of nozzle may be installed singularly by itself or plurality of nozzles arranged in clusters along with other types of nozzles through out the vehicle surfaces. i.e. vehicle roof, left sides, right side, back and front, on the hood, on the trunk, on back and front bumpers etc to ensure complete coverage and washing of all vehicle surfaces.

In another embodiment nozzles may be installed at specific points of the under belly/chassis and wheel wells of the vehicle depending on the type and shape of vehicle in strategic locations through out the vehicle to afford maximum coverage for a complete wash, soak, rinse and any other process that may be needed specific to the design and shape of the vehicle the system is installed in. Timers (and/or controllers) and solenoid valves to turn on and off all pre-programmed cycles to wash vehicles including but not limited to the following: pre-soak, lathering, rinsing and application of various liquids to enhance and preserve the shine and finish of the surface of the vehicle depending on the cycle.

Pumps, timers and actuators may be run electrically, by mechanical power, hydraulic power, and/or by pneumatic power depending on the desired design. Self contained versions of the system include, for example, a built in air compressor 123 to supply air to the various discharge nozzles to, for example, to purge the lines of remaining liquids by blowing air through the lines and nozzles after each cycle, and, in another embodiment, to blow air through all lines and nozzles at the same time or one section at a time to blow dry the vehicle. Also, in cold climates air purge provides line clearing so no fluid is left over in the lines, especially water that may freeze and thereby expand and damage spray nozzles, valves, manifolds, and fluid transmission lines. Alternatively, any liquid remaining in any of the line may be sucked back into holding tanks so as to not waste expensive fluids.

An on board water storage tank of various capacities may be installed in the trunk or the under belly of the vehicle to store water for use by the washing system in the event water is not readily available for washing the vehicle.

In another embodiment, vehicle shall have plurality of nozzles located at strategic locations in the under belly and wheel wells of the car to rinse the under carriage and wheel wells of the vehicle to wash off road dust, debris, mud, snow, ice and salt accumulated as a result of driving in dusty, muddy or in winter snow conditions where salt and dirt mixtures are sprinkled on the roads to melt the snow. Nozzles placed to wash and rinse the under carriage and wheel wells of the vehicle are, for example, of the pre wash and rinsing type that do not require spot free rinse or water repellant or wax liquid applications.

In another embodiment soap dispensing nozzles may also be placed to lather up and soap wash the under carriage before rinse cycle starts. This under carriage washing system will allow frequent washes of the under carriage and wheel wells of the vehicle thereby greatly decrease the oxidation caused by salt which in turn will greatly reduce the rusting of under belly, chassis, wheel wells and lower body.

In another embodiment, lines can be run so they come out at dead center of each vehicle wheel. Nozzles coming out through the center of the wheel can be used to spray liquid to wash brake dust on rims and to apply special liquid to clean tires. At the end of the cycle special liquids may be applied through one of the nozzles to apply tire treatment and enhancing liquid (e.g., Tire black and shine).

Preferably, the nozzles are retractable (i.e. will pop out of the surface of the vehicle via any of liquid pressure, air pressure, or mechanical devices, depending on the design. Turning or oscillating of the nozzles may be achieved by liquid pressure, pneumatic pressure, or mechanical devices, and so that each nozzle will retract flush and stay in stowed position when not in use.

This system may be installed in brand new vehicles at the factory or in the alternative designed and marketed as retrofit kits as an after market accessory. Installation on existing vehicles may be performed at a mechanics or body shop or other shops with suitable vehicle, mechanical, electrical and/or hydraulic experience.

This system will greatly increase the cleaning ability compared to tradition drive through car wash systems because the nozzles placed in closer proximity to surfaces being washed, and, spray nozzles have a limited effective range (e.g., typical drive through car wash nozzles have little if any effectiveness beyond 25-30 inches, depending on nozzle type, pressure, etc.). In this system the nozzles can be place so distances of nozzles is as close to the various vehicle surfaces as possible thereby allowing maximum yield in terms of achieving desired results.

This system also may be installed in pickup trucks, sport utility vehicles, trucks, buses, tractor trailer rigs, railroad cars, farming vehicles & equipment, boats, ships, earth moving equipment, hovercraft, snow cats (especially de-icing applications), rail road locomotives & railway cargo and passenger cars, aircraft, (in which case the nozzles can also be used to not only wash the aircraft but also to use the nozzles to spray de-icing liquids onto exterior surfaces (particularly the wings and control surfaces) thereby reducing accidents due to ice on the wings and control surfaces. Other vehicles used to transport men or materials whether on the land (road, rails), water, or in the air, may utilize a combined washing/de-icing system.

In another embodiment alternative to the above claim vehicles can be roughed in with a number of items, including, for example, spray nozzles, fluid transmission lines, and manifolds but without more expensive items such as, for example, motors, valves, pumps, timers, switches, water filtering and water softening system, various fluid storage tanks, air compressors. In one embodiment, the roughed-in lines are powered by external pumps and water sources according to a control program to effect any combination of wash, rinse, and wax (or other objects of the invention, including, but not limited to de-icing operations).

Water detergents and soap and various cleaning fluids storage and pumping and air compressors units can be purchased separately as an external unit which will have all the necessary motors, pumps, timers, switches, water filtering and water softening system, various fluid storage tanks, external water hookups and air compressors that can be attached to the vehicle via a quick attach/disconnect coupling and can be attached to a regular garden hose and house hold electrical outlet to run the unit thereby enabling one unit to wash several vehicles one at a time. This will be especially advantageous to families having several vehicles or fleet owners of commercial vehicle to purchase vehicles with spray nozzles and a fluid distribution system only. Such owners would then buy a separate unit for supplying, pumping, and transporting liquids that can be used to wash several vehicles by one unit translating into substantial savings in equipment acquisition cost.

Further to the above, while traveling one could pull into a commercial establishments like a gas station that can provide stations with individual units containing all the necessary liquids for a much lower cost then the cost of regular car wash. A vehicle operator could pull up and hook up to the unit via a quick connect/disconnect coupling, wash their vehicles and then simply drive away.

Various embodiments of the invention may include one or more of:
1. A shroud to cover up plumbing lines if not concealed in the vehicle's body (e.g., see 450, FIG. 4). The shroud is utilized, for example, preferably in after market installations.
2. Side view of a spray nozzle cluster (e.g., see 405, FIG. 4 including a plurality of nozzles installed depending on the design, nozzles shown in extended positions—the exact number and locations of nozzles to be decided per design choice.)
3. Spray nozzle clusters, which may have zero degree high pressure nozzles, or high pressure turbo nozzles or any other type of nozzle most suitable for the objects of the present invention (including, but not limited to spraying, pre-soaking, scrubbing action, and rinsing through water jets).
4. A plurality of low pressure (and/or foaming) nozzles for application of foam or regular type soaps/detergents.
5. Low pressure nozzles may be used, for example, for the application of spot free rinse or soft water rinse, hot or cold wax and jet dry liquids (or the same nozzles used for high pressure applications but run by a pump providing low pressure).
6. Blade antenna type housing for cluster of spray nozzles (e.g., shroud 450, of varying sizes, used in factory installations or after market retrofit kits).
7. A connection point for external water supply hook up.
8. Unit in the trunk (or any other suitable place in the vehicle) housing fluid storage tanks for water, soaps and detergents, hot & cold wax, water repellent liquids and any other liquids that the design may call for. Water softening unit, water filters, pumps and air compressors etc.

The present invention includes a method comprising the steps of pressurizing a self-contained built-in vehicle washing system, and activating at least one wash cycle. The wash cycle may include, for example, sub-cycles of pre-soak and wash (or soak and rinse, or any number of combinations available from the disclosure presented herein. The method may also include at least one wash cycle having activation of a rotatable feed mechanism with a series of wash heads mounted thereon which are fed liquid from the pressurized system through a channel in the rotatable feed mechanism, and the rotating feed mechanism may be slidably mounted underneath the vehicle and configured to slide out from underneath the vehicle and rotate causing the mounted wash heads to rotate and impact predetermined areas of the vehicle. The method may be implemented for example, as a set of computer instructions and/or executable program stored on a computer readable media.

Portions of both the device and method may be conveniently implemented in programming on a general purpose computer, or networked computers, and the results may be displayed on an output device connected to any of the general purpose, networked computers, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s), etc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a diagram of an exemplary layout of an automated vehicle washing system according to an embodiment of the present invention;

FIG. 1B is a diagram of a second exemplary layout of an automated vehicle washing system according to an embodiment of the present invention;

FIG. 2 is a diagram of rotating arm and undercarriage subsystems according to an embodiment of the present invention;

FIG. 3A is a diagram of subsystems of an automated vehicle washing system according to an embodiment of the present invention;

FIG. 3B is a diagram of bars and nozzles configured according to several embodiments of the present invention;

FIG. 4 is a block diagram of a pop-out nozzle system/subsystem according to an embodiment of the present invention;

FIG. 5A is a flow chart of an embodiment of system processes according to an embodiment of the present invention;

FIG. 5B is a flow chart of another embodiment of system processes according to an embodiment of the present invention;

FIG. 6A is a drawing of a brushless tire washing subsystem according to an embodiment of the present invention;

FIG. 6B is an illustration of an exemplary tire washing nozzle according to an embodiment of the present invention;

FIG. 7A is a drawing of an installed exemplary tire shine applicator according to an embodiment of the present invention;

FIG. 7B is a drawing of an installed 2^{nd} exemplary tire shine applicator according to an embodiment of the present invention;

FIG. 8A is a drawing of a rolling type tire shine applicator according to an embodiment of the present invention;

FIG. 8B is a drawing of the tire shine applicator of FIG. 8A in an extended position according to an embodiment of the present invention;

FIG. 8C is a drawing of an operational view of a brush/sponge style tire shine applicator according to an embodiment of the present invention;

FIG. 9 is a diagram of a dual sided rotating arm and undercarriage subsystems according to an embodiment of the present invention;

FIG. 10A is a diagram of an extension apparatus for a rotating arm according to an embodiment of the present invention;

FIG. 10A-1 is a diagram of a portion of a drive mechanism and tray for a rotating arm according to an embodiment of the present invention;

FIG. 10A-2 is a diagram of a portion of a drive mechanism and tray for a rotating arm according to an embodiment of the present invention;

FIG. 10B is a diagram of a portion of a drive mechanism and tray for a rotating arm according to an embodiment of the present invention;

FIG. 10C is a diagram of a portion of a drive mechanism and tray for a rotating arm according to an embodiment of the present invention;

FIG. 10D is a diagram of a portion of a drive mechanism and tray for a rotating arm according to an embodiment of the present invention;

FIG. 10E is a diagram of a portion of a drive mechanism and tray for a rotating arm according to an embodiment of the present invention;

FIG. 10F is a diagram illustrating an extension of a rotating arm according to an embodiment of the present invention;

FIG. 11A is a diagram of a layout of an automated vehicle washing system according to an embodiment of the present invention;

FIG. 11B is a diagram of a layout of an exemplary 1^{st} rinse cycle according to an embodiment of the present invention;

FIG. 11C is a diagram of a layout of components in an exemplary bug, tar, and tree sap chemical cleaning cycle according to an embodiment of the present invention;

FIG. 11D is a diagram of a layout of an exemplary soap cycle according to an embodiment of the present invention;

FIG. 11E is a diagram of a layout of an exemplary tire and engine shampoo cycle according to an embodiment of the present invention;

FIG. 11F is a diagram of a layout of an exemplary triple wax cycle according to an embodiment of the present invention;

FIG. 11G is a diagram of a layout of an exemplary reverse osmosis water rinse (spot free rinse) cycle according to an embodiment of the present invention;

FIG. 11H is a diagram of a layout of an exemplary total body protectant cycle according to an embodiment of the present invention;

FIG. 11I is a diagram of a layout of an exemplary underbody protectant cycle according to an embodiment of the present invention;

FIG. 11J is a diagram of a layout of an exemplary tire shine cycle according to an embodiment of the present invention;

FIG. 11K is a diagram of a layout of an exemplary final RO rinse cycle according to an embodiment of the present invention;

FIG. 11L is a diagram of a layout of an exemplary air drying and purging of all lines cycle according to an embodiment of the present invention;

FIGS. 12A-12G are a series of drawings illustrating exemplary nozzle types that may be used alone or in any combination in various embodiments of the invention;

FIG. 13A is a diagram of a solenoid operated two-way valve utilized as a component in various parts of different embodiments of the present invention.

FIG. 13B is a diagram of an exemplary solenoid operated 3-way valve utilized as a component in various parts of different embodiments of the present invention; and

FIG. 14 is a diagram of a front/rear bumper stored washing system according to an embodiment of the present invention.

### DESCRIPTION OF THE PREFERRED EMBODIMENTS

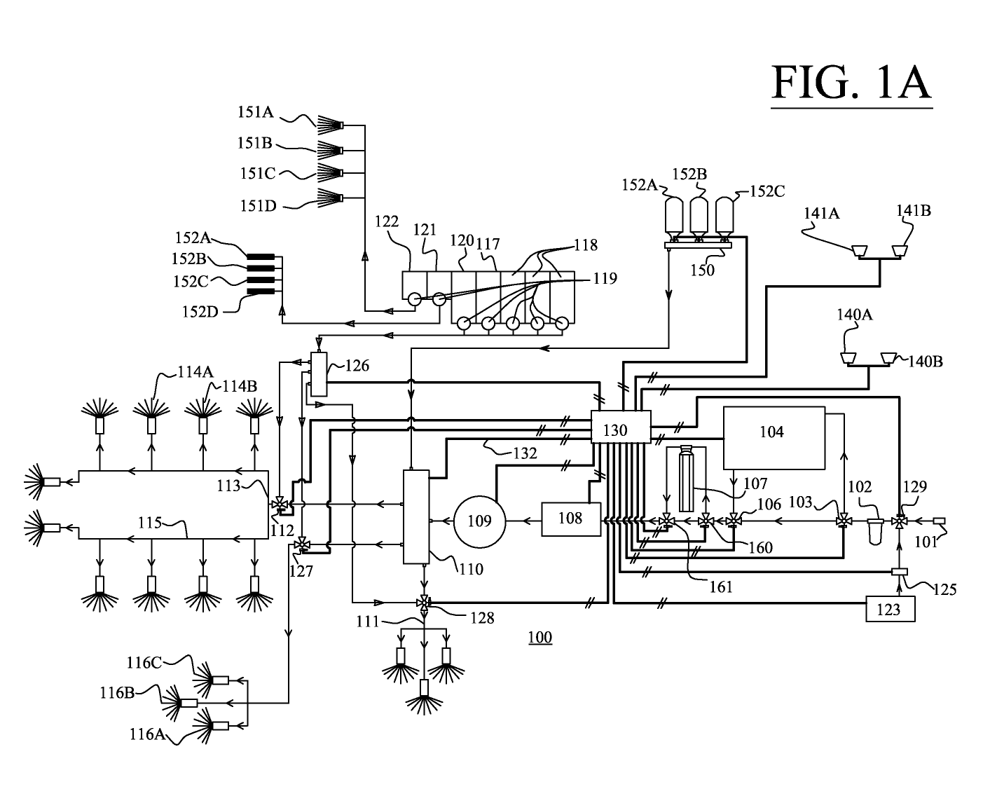

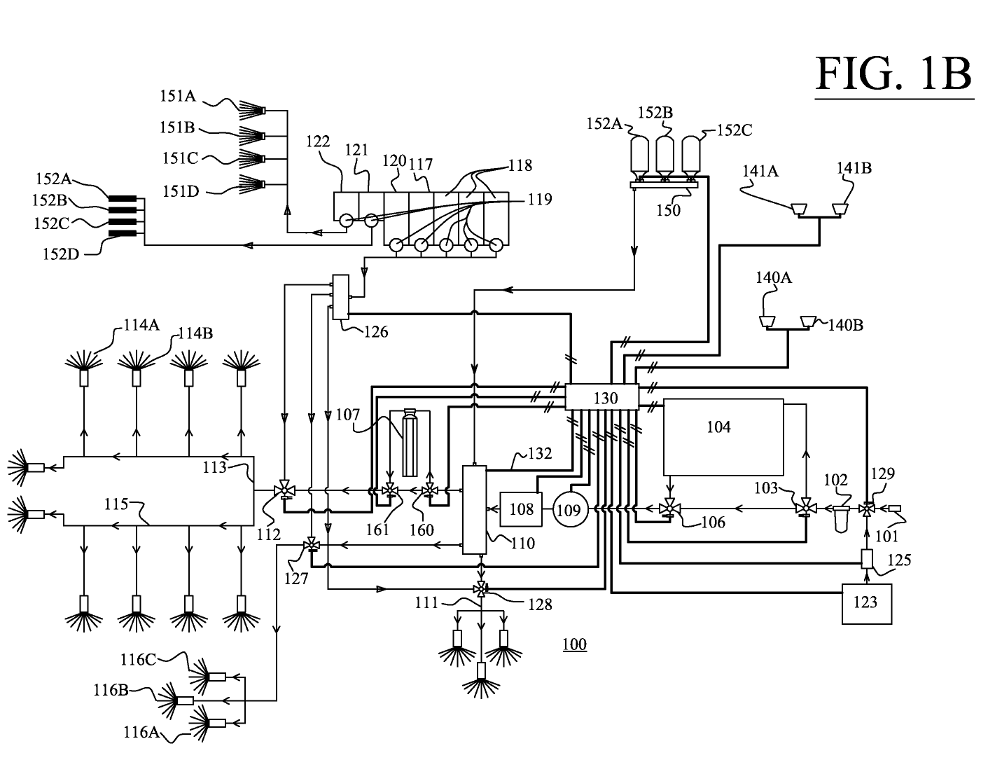

Referring now to the drawings, wherein like reference numerals designate identical or corresponding parts, and more particularly to FIG. 1A thereof, there is illustrated a diagram of an exemplary layout of an automated vehicle washing system 100 according to an embodiment of the present invention. The automated vehicle washing system includes components installed at strategic locations on a vehicle for the provision of an embodiment of a self-contained built-in automatic washing system.

The automated washing system illustrated utilizes touchless or brushless cleaning nozzles that are fed high pressure cleaning solutions (e.g., chemicals, water, tire/engine cleaners, soaps and/or other cleansers, degreasers) selected according to a wash cycle being performed. Although preferably entirely brushless, depending upon the application, certain nozzles in the system may include brushes that, for example, rotate (e.g., rotate from water pressure or attached electric motor, or, alternatively, pneumatic or hydraulic motors). Brush type nozzles may be used, for example, on areas that are difficult or cumbersome to clean, for example, impact areas on the vehicle surface or anywhere large amounts of grime build-up (e.g., undercarriage, engine compartment, vehicle nose (bug strike areas), etc).

In addition to cleaning the vehicle, in various embodiments, the automated washing system also applies any of wax, silicone sealer, or other protection type coatings or finish preserving fluids (e.g., rain-x™, simonize™, armor-all™, blue coral™, etc, which are, for example, applied to the entire exterior surface of the vehicle including glass, painted surfaces, rubber, vinyl, chrome plastics etc). The protectorants (chemicals or coatings designed to protect or restore a surface) and/or other chemicals used by the system are applied to appropriate corresponding portions of the vehicle. For example, tire cleaners are applied to tire areas, rain-x applies to glass areas (newer versions of rain-x may be applied to other surfaces as well), and waxes are applied to painted surfaces. Total body protectorants (e.g. newer versions of rain-x) may be applied to the entire vehicle (e.g., all exterior surfaces). In addition, tire dressing fluids may be applied to tires over and above the tire cleaning fluids that might also be applied in other cycles.

The components include an inlet coupling 101 that provides a source for water or another liquid to be used by the automated washing system. An optional water (or another liquid) storage tank 104 may be provided to make the system self-contained (meaning that, once filled, no outside sources are needed in order for the washing system to be operable). Other storage tanks are also provided, including a pre-soak/soap tank 117, triple foam wax storage tank(s) 118, bug cleaning chemical storage tank 120, tire shine liquid storage tank 121, and tire cleaning fluid 122. Additional other tanks may be provided with any type of fluid or chemical useful in washing or other systems of the present invention.

The liquid storage tanks are preferably mounted low in the vehicle (to lower the center of gravity) and are optimally placed near the drive wheels of the vehicle to increase tracking (especially useful in colder climates where snow conditions occur or where traction can be improved by adding weight over the drive wheels). The liquids contain, for example, an anti-freeze solution or any freezing point depressing agent (e.g., engineered agents) added to the fluid to prevent freezing. The same anti-freeze solutions may also be used for de-icing operations described elsewhere herein.

The contents stored in the tanks may be concentrated (e.g., a concentrate to be used in combination with water or other liquid) or may be used directly without dilution (direct use of a tank is performed by, for example, pressurization of the tank, and then routing a downstream flow (e.g., via valves activated by a controller to one or more current segments in a wash cycle) from the tank to one or more nozzles.

The pre-soak operations may be performed using tire cleaners, bug cleaning solutions, or any other chemicals provided in any of the tanks in the system (applied to appropriate locations of the vehicle). The pre-soak solutions may be pre-programmed to use a variety of chemicals and/or detergents, or other solutions, and the final selection of the pre-soak solution may be based upon what is available (e.g., if certain more effective solutions are unavailable (e.g., detergents), then the controller can decide to use other available chemicals, or even water. Certain restrictions on the selection of pre-soak solutions would be implemented to avoid using a chemical or other solution that might cause damage to sensitive vehicle surfaces.

In one embodiment, the washing system includes a float/mixing valve. For example, a hydrominder mix valve. The hydrominder allows for a precise mixture of concentrated chemicals and water to create an appropriate solution mix (the hydrominder keeps a reservoir ready with an accurately mixed solution, and, instead of filling a reservoir with the mixture, the same valve can be configured to produce a mixture on-the-fly from raw materials (e.g., chemicals and water)). The solution mix may be more concentrated or less concentrated depending upon a wash cycle being performed as directed by the controller. The precise solution mixture is created by activating the hydrominder such that water and selected chemicals flow through the hydrominder (through a metering tip) that mixes them in an appropriate solution. Metering tips installed on the hydrominder provide the precise mixing ratios, and are selected based on the concentrate of the materials being mixed (e.g., a stronger, more concentrated chemical would be paired with a metering tip that results in a higher water to chemical ratio).

Thus, the mixed flow of the chemicals is tuned to create the desired concentration once mixed with water or other solution from the water storage tank. Pressure differences and available flow from different sized lines of the water tank compared to the chemical tanks may also be utilized to create desired concentrations of chemicals in the wash solutions.

The controller is, for example, any of a number of commercially available controllers—including controllers specifically designed to accept programming and send control signals to operate valves, adjust various settings (e.g., settings that affect individual component operations such as pressure, temperature, flow rate, etc) and turn devices on and off. Commercially available controllers, control devices, etc., are available, for example, from Johnson Controls, Siemens, or, for example, a programmable Automation Controller (PAC) such as the type produced by Opto22 (e.g., see http://www.opto22.com), Allen Bradley, or other control device suppliers. Such controllers need only have enough capability to implement the programming described and illustrated in the tables presented herein. Other controls may include for example, a microprocessor with programming installed.

Many microprocessors have sufficient signaling capability and processing power to implement the required control operations. For example, IBM XT level processing power found in 8088 family of microprocessors is more than sufficient. Programming in the microprocessor versions may be performed in any language having facilities to receive needed data from sensors within the system and send control signals to control the various components of the system according to one or more wash cycles. In embodiments utilizing a sophisticated Graphical User Interface (GUI) or heads up display, more processing power may be necessary (e.g., Pentium based processing system). Alternatively, the GUI may be presented from another system (e.g., manufacturer's built-in display system) with signaling between the GUI and controller to provide commands such as wash-start, selection of wash program, etc.

The controller includes, for example, programming steps stored in memory that operate the hydrominder, or mixing valves, (open, shut, partial open) at appropriate times to implement a wash cycle. For example, a first wash cycle may require a heavy dose of solvent, a wait (soak in time) and then a high pressure wash of less concentrated solution. In such a case the controller is programmed to open the hydrominder valve for a tank containing solvent and pressurize a particular line or set of lines (further instructions sent to one or more pressure regulators/pumps), and then wait for the soak-in time, after which the controller closes the hydrominder valve (but not necessarily shutting it) and initiates a high pressure sequence. The hydrominder valve remains open so that appropriate quantities of water to other liquids are mixed in a desired ratio. The mixing quantities can be dialed in so that controller sends a signal corresponding to the desired mixing ratio to the hydrominder controlling output of the tank(s) holding the liquid(s) to be mixed.

The washing system operates to spray the solutions (e.g., water alone or water in combination with one or more contents of a storage tank) onto the vehicle at strategic locations and with an appropriate volume and pressure according to a wash cycle. Typically, one or more wash cycles are utilized. The wash cycles are implemented by a controller that controls the path of the solutions, pressure, and volume of flow throughout the washing system. The paths controlled include, for example, which storage tank contents are being used (making a solution) and being sprayed, how they are being sprayed (e.g., amount of pressure, movement of nozzles or nozzle platforms, etc.), the order in which they are sprayed, the length of time that they are sprayed, and which part of the vehicle is being sprayed (may be a fixed path, or may be a path that incorporates a mechanical or preprogrammed movement.

The pre-soak solution is, for example, a combination of pre-soak tank contents and water tank contents. The pre-soak solution is a solution for soaking operations that loosen grime and other debris attached to the vehicle. The pre-soak solution is sprayed onto the vehicle and then given a pre-determined amount of time to soak. The pre-determined amount of time to soak is, for example, a dwell time that allows the pre-soak solution to work its way into the grime, dirt, etc, after being applied.

The bug cleaning chemical makes a solution that is, for example, a solvent sprayed on the leading edges of the vehicle where most insect and other debris impact the vehicle (e.g., windshield areas, front surfaces of side rear view mirror housings, front grill, front bumper, etc). Typically, the bug cleaning chemical is the strongest of the solvents utilized by the washing system because the impact and drying effects of these impacts at the vehicle's leading edges create the most difficult debris to remove from the vehicle. Bug cleaning chemicals may also be utilized as an effective tar and tree sap remover and may be applied to areas with significant tar build-up (e.g., rocker panels behind wheel wells, at/near mud flaps, etc).

A triple foam wax (or another liquid wax solution) is stored in the triple foam wax storage tank(s) 118. The waxes are, for example, one color per tank. Although illustrated as a single tanks in a set of tanks, the triple foam wax tank, as with all other tanks stored solutions described herein may be stored in multiple tanks and those multiple tanks may include the same solution or contain staged solutions (e.g., pre-wax solution and final wax solutions stored in separate tanks). In one embodiment, one or more, or all, of the multiple tanks are of a “cartridge” type. That is, the tanks are designed to be easily pulled and re-inserted into the washing system on the vehicle. The design may encompass, for example a tank with optional tracks and corresponding track receptors on the vehicle or visa-versa that guide the tank into installation. The hydrominder valve can be built-into the tank or the lines that couple to the tank once it is installed. An attachment valve on the tank opens when inserted into a corresponding receptor on the line installed in the vehicle. Similarly, electrical connectors on the tank and corresponding electrical connector acceptors are installed on the vehicle, and are designed to transfer control and data signals to and/or from the tank(s). In one embodiment, a fluid level indicator provides fluid level signals to the controller, and the controller sends control signals to the hydrominder valve according to wash cycles, status, or testing functions. The fluid levels are used by the controller to send status data to a heads-up display or other GUI providing system status to the vehicle operator.

Other signals may include a signal that identifies the contents of the tank. Upon filling a tank, a vehicle operator, or filling station attendant, may program a sensor chip or dip switches on the tank to identify the content of the tank (factory provided re-fill tanks would be pre-programmed at the factory). After re-installation into the vehicle, an identification signal derived from the sensor chip or dip switches indicating the tank's contents are sent to the controller via one or more of the electrical connections to the tank. The controller then sets the valves and flow within the system to use appropriate wash solutions regardless of which tank the underlying chemicals are stored in.

The sensor chip may also be utilized to prevent unauthorized re-filling, and unauthorized re-filling would then void part or all of any system warranty. Preventing unauthorized re-filling is useful because the chemicals are preferably in a highly concentrated form so that the tanks can be of a very compact size. Finally, a latch snaps the tank into place once inserted and connected to the appropriate line and electrical connections. The design may be similar to ink-printer cartridges and can be popped in and out. Additional empty slots may be provided for future expansion (e.g., new or added chemical capacities).

Alternatively any of the tanks, manifolds, lines, or segments within the system may be dedicated to a single wash or solution (e.g., dedicated lines for water, pre-soak solutions, bug-cleaning solutions, detergents, wax and other total body protectorant liquids. In yet another alternative, all lines and nozzles may be utilized in, for example, pre-soak, final rinse, and/or air drying operations.

A strainer 102 is provided downstream of the inlet coupling 101 to prevent particles and other debris contained in liquid entering the system from the inlet coupling. The strainer is, for example, a fine mesh strainer or a quick filter. The inlet coupling is, for example, a quick release valve fitting (or standard hose fitting) to which a water supply hose with a corresponding quick release (or standard hose) fitting installed. A sensor proves an indication to the vehicle's dashboard that the hose is attached (may include, for example, a starter or ignition cut-off so that the vehicle will not start with the hose attached). Alternatively, the ignition cut-off does not occur until the vehicle is put in gear (this allows the engine to be running during system operations which may be necessary in colder climates).

A solenoid valve 103 is controlled by the wash controller and is opened to allow a path directly from inlet coupling 101 into the system in a first position. A second position of the solenoid valve allows liquid from the inlet coupling to enter the water storage tank 104. The inlet itself includes a 3-way solenoid operated valve 129 that is set to either allow water or compressed air to enter the system.

The water storage tank 104 may be filled and pressurized from the inlet coupling via, for example, an outside hose connection (may also be pressurized internally via a bladder that is gas filled) (accumulator tank). In fill mode, a containment solenoid valve and air escape valve (not shown) in combination prevent inlet coupling fluid from flowing any further than the tank and allows air to escape the system—as would occur when filling. Alternatively, the inlet coupling may be replaced with an open fill neck similar to a gas tank style fill neck, which allows air to escape during filling operations through the fill neck itself (A one way valve is then implemented to maintain pressure in the washing system during operation).

In one embodiment, a hose is included for emergency fills of the water tank from a nearby pond, lake, or stream. The hose includes, for example, a suction cup and filter. Preferably, the hose is maintained on a self-winding (motorized or spring loaded) spool and stored inside the vehicle with easy external access. An on-board pump may be utilized to assist in pumping the water. This embodiment is particularly useful for off-road vehicles.

The storage tank 104 is, for example, a water storage tank. The storage tank 104 may include an optional heater to raise the liquid to a more effective cleaning temperature (e.g., approximately 140 degrees Fahrenheit, more or less). A three-way valve 106 allows flow directly from the inlet coupling 101 or storage tank 104.

A water conditioning unit 107 is configured to condition liquids flowing downstream through the system (as with the several components described herein that are not essential to operability of the washing system, the water conditioner is optional or could be replaced with a filter). In one embodiment, 3-way solenoid operated valves 160 and 161 provide a gate which allows the filter/water conditioning unit 107 to be bypassed. The conditioning may include filtering and/or water softening (or hardening) as needed for a particular wash cycle. The water conditioning unit may be implemented as simply a single stage filter, or may be a multi-stage filter and further conditioning as directed by the controller implementing a current washing cycle. In one embodiment, the water conditioning unit is, or includes a reverse osmosis filter that is used particular to create spot free rinse water to be used in at least a final rinse cycle.

As noted above, the storage tank 104 may include a heater to bring the fluids up to an effective cleaning temperature. The heater may be, for example, an element in the tanks, or a heat exchanger using engine coolant as a heat source. Alternatively, and also optionally, an instantaneous hot water heater 108 may be installed in line with the flow of liquid from the tank/inlet to supplement or affect that temperature increase.

In one embodiment, the tank includes a heat exchanger that utilizes hot engine exhaust gasses to bring the fluid to an effective cleaning temperature. Alternatively, an electrical heater may be utilized.

In one embodiment, the heating elements are utilized to heat liquids and/or air expelled by the nozzles. Heated air is utilized, for example, in the blow-drying process. In addition, an optional clear windshield ice cycle may be initiated to clear the vehicle's windshield of ice or snow build-up.

Additional cycles may be implemented for clearing ice or snow from any of side windows, side rear-view mirrors, door locks, and/or trunk locks, etc. The cycles may be programmed individually or together or grouped in pre-arranged or custom groups specified by a vehicle operator.

For example, a vehicle operator may customize a de-icing command by selecting a series of de-icable components from a list presented on a GUI. The GUI may include options to select one of from windshield, rear windshield, side rear view mirrors, trunk lock, door locks, etc. Thus, the lines, segments, and nozzles of the present invention may be utilized for the delivery of all types of solutions (including de-icing solutions and/or heated solutions), and/or air (including heated air) for blow drying and/or as a part of de-icing operations.

An example customized de-icing command may include selections of, for example, rear windshield and trunk lock, and a indication of whether those selections use de-icing solution, heated air, or a combination of both. The customized list is then saved as a custom de-icing cycle that is selectable along with pre-programmed options. When invoked, the controller commands the system to heat air and/or a combination of heated air and de-icing solution to be applied to the customized selected portions of the vehicle. A pre-programmed option may include a hot air blast to melt and remove ice and snow and then a coating of de-icing liquid to remove any residual ice and leave a de-icing fluid film to protect against future build up.

A water pump with pressure booster 109 pressurizes the system downstream to an operational pressure (alternatively, the water pump is separate from a downstream pressure booster). Additional valves or other pressure regulators may be installed to reduce pressure for specific nozzles or other equipment downstream from the pressure booster 109 if necessary. The pressure applied to any specific nozzles, set of nozzles, or segment of the washing system can be customized. For example, nozzles placed in close proximity to the surface of the vehicle to be washed may be effectively operated with a lower pressure.

Some nozzles may be better placed (e.g., in close proximity to a surface of the vehicle to be washed) and operated at a lower pressure compared to nozzles that are further from the washing surface. Some nozzles may be rotated such that during certain angles of rotation the vehicle surface being washed is closer or further away—and the pressure at that nozzle may be regulated to have higher pressure when the surface is further away and lower pressure when the surface is closer. The pressure is adjusted, for example, by the controller 130 that sends signals to the water pump with pressure booster 109 (or pressure increasing or decreasing manifold with pressure regulating valve—e.g., installed on an upstream side of a bank of nozzle supply lines or a pressure booster pump) that indicates the amount of pressure that should be applied for various time periods with in one or more washing cycles. In one embodiment, in addition to rotation and changing pressure of the spray, the nozzles may be oscillated in either horizontal and/or vertical planes.

Table 1A illustrates an exemplary rotation implemented in programming at the controller for an exemplary nozzle on a rotatable platform in the washing system.

TABLE 1A
(0-90 degree rotation/pressurization table)

| | |
|---|---|
| 0-19 degrees | 200 PSI |
| 20-44 degrees | 400 PSI |
| 45-59 degrees | 800 PSI |
| 60-90 degrees | MAX PSI |

Thus, in one cycle, the controller activates, for example, a stepper motor (alternatively the controller may initiate the use of hydraulics (e.g., water pressure) or pneumatics) to rotate a nozzle or group of nozzles (e.g., cause movement of a platform containing multiple nozzles) from 0 to 90 degrees (e.g., 0 degrees being directly toward a normal surface, and 90 degrees being parallel to a normal surface). The rotation is configured, for example to occur in both vertical and horizontal planes.

As the nozzles(s) rotate to pre-determined positions (20, 45, and 60 degrees in this example), the pressure is adjusted according to the table. In one embodiment, each rotatable nozzle or platform includes a rotation/pressurization table, and both the pressure and rotation are implemented by commands sent from the controller to either a stepper motor or other rotation implementing device and the pressurizer.

As noted above, such rotations may also include oscillations in any direction (e.g., horizontal, vertical, or rotational planes). Alternatively, a hydraulic by-pass device or pneumatic oscillating device can be positioned or attached to affect the oscillations. The oscillations may also be induced by mechanical devices (e.g., motor with off-center cam coupled to the lines/spray heads).

The rotation and pressurization is customized to the vehicle being washed. Such customization is dependent upon the location of nozzles, the contours of the areas being washed, and is, for example, specific to each vehicle model on which the washing system is installed. Although some generic wash cycles may be implemented, to maximize the effectiveness of the present invention, each vehicle model will have its own specific customized programming in the controller.

In one embodiment, one or more of the segments or nozzles within the washing system have control valves that can regulate pressure in that segment independent of the water pump with pressure booster 109. In time with those pressure changes, the controller also commands the opening or shutting of segment or nozzle valves to activate valves or segments, control their flow(s), and control other aspects of the operation of the washing system including the rotation of platforms on which the nozzles are mounted (e.g., via rotational signals supplied to, for example, stepper motors connected to the rotatable platforms). The ultimate placement of any particular nozzle, amounts of rotation, and other factors (including programming of the controller 130) are ultimately specific to the model of the vehicle being washed.

In one embodiment, a distribution manifold 110 (e.g., manifold with solenoid valves on each port) routes a pressurized flow of water to a plurality of lines with one or more washing attachment(s) (e.g., nozzles) utilized to wash the vehicle. The nozzles are, for example, any of low, medium, or high pressure nozzles that are fixed, rotating (e.g., turbo) oscillating, or any combination of the above independently or on a platform that rotates or oscillates. The selection of nozzles being dependent upon design factors including the location and function of the nozzle (for example, higher pressure more concentrated nozzles are utilized in difficult cleaning areas, and lower pressures and foaming type nozzles may be used in pre-soak and soaping operations).

The manifold 110 includes solenoid valves for routing the pressurized flow to individual lines (e.g., a line that is operated that is exclusively fed by the pressurized flow within the system), or, to a combination of lines. Such lines or combinations of lines and one or more wash nozzles are also referred to herein as segments. The segments contain, for example, valves that allow downstream flow into and through the segments. The valves are opened, shut, or partly opened (e.g., via electrical control signals applied to the solenoid control terminals by the control device) according to programming in the control device for a particular wash sequence being performed. In another embodiment, manifold 126 distributes various chemicals from tanks 117-120 (e.g., cleaning and preserving liquids) to various lines/segments as shown in FIG. 1A.

Control device 130 sends signals according to a wash cycle to control valves, solenoids and/or other controllable items utilized to implement various wash cycles. In the illustrated embodiment, control device 130 includes control lines connected to each of solenoid valve 103, water storage tank 104 (to activate optional heater), instantaneous hot water heater 108, water pump with pressure booster 109, and manifold 110 (to control solenoid valves in the manifold). Control lines to the zone manifold 110 are illustrated as multiple lines 132 (two wires to each solenoid/port on the manifold), the number of lines depending upon the implementation of the manifold, and specifically depending upon the number of solenoid valves (or groups of solenoid valves) configured for independent control. In addition, control lines connected to portion valves configured to control an amount of cleanser, detergents, or chemicals dispensed from one or more of the storage tanks 120, 118, and 117.

The system includes various lines or segments through which flow is directed to nozzles at strategic locations throughout the vehicle. For example, a top sides and front segment 113 is a flow initiated by opening an appropriate valve on the manifold (e.g., a zone manifold) 110. The flow contains, for example, liquid from storage tank 104 in solution with one or more combination of chemicals, cleansers, etc. from one or more of the storage tanks, 117, 118, and 120. The flow eventually exits the system through nozzles (e.g., nozzles 114A, 114B, etc connected to segment 113). The nozzles are directed, for example, to the top, sides, front, back and undersides of the vehicle. Typically, all spray nozzles include check valves to control or eliminate drips.

The flow directed by controller 130 comprises, for example, pressurization of the system to create a flow from the storage tank 104 to the nozzles 114A, 114B, etc. The pressurization is supplied, for example, via any of pumps, pressure booster pumps (pressure boosters), and/or accumulator tanks that are charged prior to initiation of a washing cycle (e.g., charged during normal vehicle operation). Additional pressure from pumps 119 cause chemicals (e.g. pre-soak cleaning solution, bug cleaning solution) to be mixed with the water from the holding tank. The pre-wash solution is then sprayed onto portions of the vehicle to which the nozzles are directed (e.g., nozzles may, for example, be in fixed positions directed toward certain areas of the vehicle, or may be mounted on a movable platform and directed toward strategic locations. After the pre-soak is applied, the controller may pause to allow the solution to soak in. After the pause, the controller may then direct water pump 109 to apply maximum pressure, direct storage tanks to release cleaning solution, and direct instantaneous hot water heater to come up to operational temperature, all causing a hot washing spray to be applied to the vehicle.

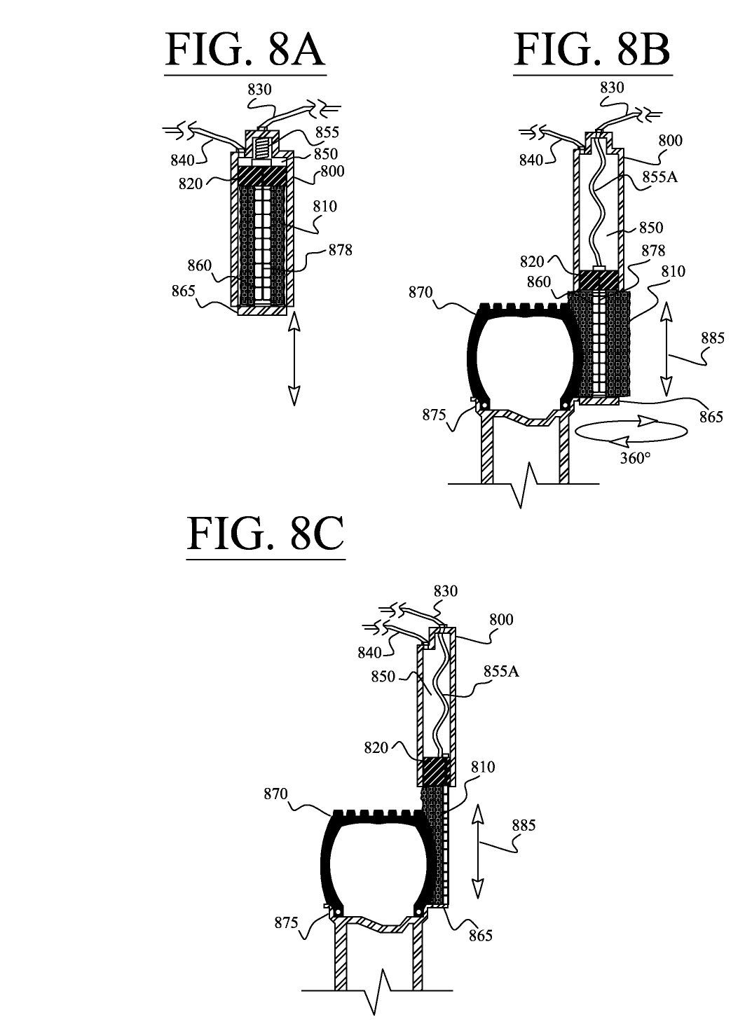

Additional hardware includes chemical tire applicators 151A, 151B, 151C, and 151D which may take one or more forms of nozzles as described herein, where each nozzle is directed to an individual tire, are shown for example on a single segment. Further, extendable tire shine applicator sponges (or brushes) 152A, 152B, 152C, and 152D (e.g., as illustrated in FIGS. 8A-8C, for example) may be utilized one for each tire, are shown, for example on a single segment (any set of nozzles shown on a single segment may alternatively be constructed with each nozzle or applicator on an individual segment with corresponding changes in segment activation).

The controller may activate one or more segments in sequences, such that the top of the car is washed (or pre-soaked, or rinsed) first, sides second, and underside of the car last. After presoak and wash, the car is rinsed using similar set of commands, absent the washing chemical.

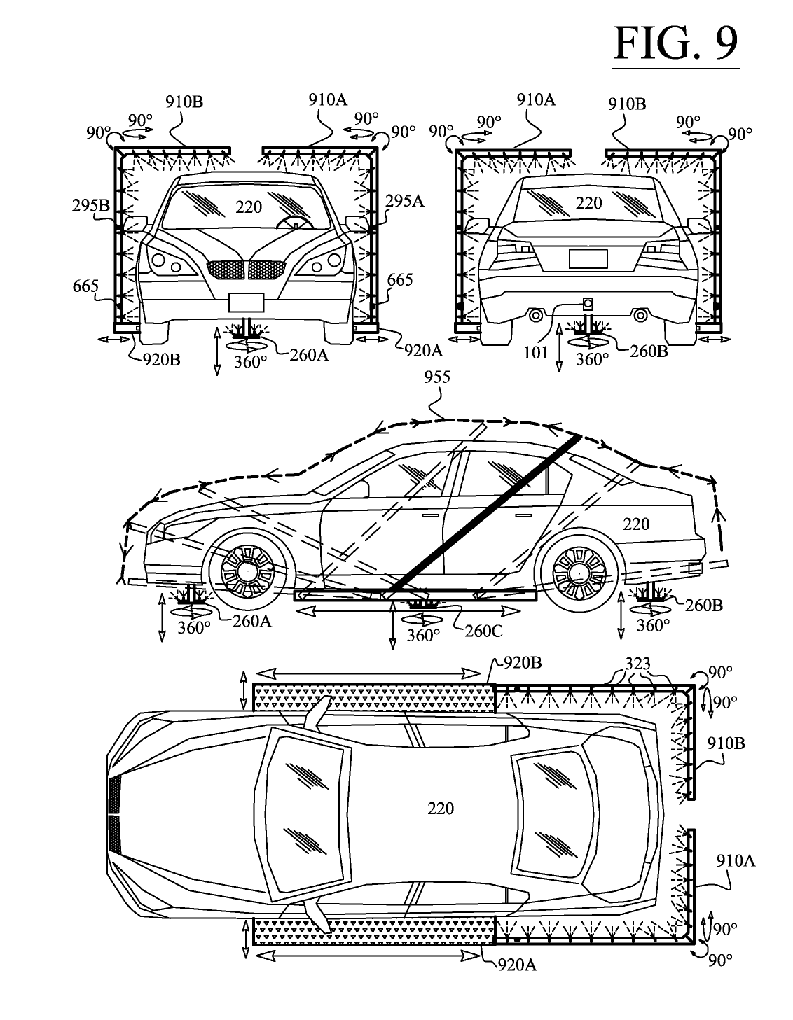

A three-way valve (e.g., solenoid operated) 112 directs flow from either one or more storage tanks and/or the distribution manifold 110 to lines 113, 115, et al. One or more nozzles may each include check valves (in one embodiment, every nozzle includes a check valve to prevent dripping). 3-way solenoid operated valve 127 controls distribution of water and cleaning/preserving chemicals to nozzles 116A, 116B, etc. Nozzles 116A, 116B, etc., are illustrated to show heavy duty washing areas (e.g., rocker panels, bug strike areas, such as the fronts of rear view mirror housing(s), etc.) and are intended to be operated under higher pressure and include check valves to prevent dripping when not in use. Heavy duty washing performed at the front sides of rear view mirrors is illustrated, for example, as nozzle placement 295A and 295B in FIG. 9, and may be operated on separate parallel lines or on the same lines as other nozzles on the illustrated rotating arms 910A and 910B).

The invention includes a segment that is, for example, dedicated to washing/rinsing an underside of the vehicle. For example, segment 111 includes nozzles that are directed towards an undercarriage of the vehicle and is intended to remove road grime, sand, mud, salt, and chemicals that have attached to the underside of the vehicle during use. Since vehicle undercarriages are particularly vulnerable in areas where climate conditions dictate the use of salt, dirt, or sand and/or chemicals to remove ice, which also tend to corrode or otherwise degrade undercarriage components and other body parts of a vehicle, the undercarriage wash abilities of the present invention are viewed as particularly valuable for some vehicle operators. In addition to cold climates, other climates including dry dusty/sandy climates can reap similar benefits to remove grit and dust or sand buildup.

The nozzles attached to segment 111 are, for example, high pressure and high speed turbo rotating or oscillating nozzles. A selection of whether the nozzles are rotating or oscillating type will depend upon the selected location of the nozzle, and dependent upon which spraying format is best suited to provide the best coverage of the vehicle areas within an effective spraying distance of the nozzle. Other types of nozzles may be utilized, for example, any of Floodjet®, Veejet®, Fulljet®, WashJet®, FlatJet®, FoamJet®. rotating ball type rinsing nozzle, showerhead type rotating high pressure nozzles, etc. Nozzles may be rotated mechanically, pneumatically, or via reaction jet or water pressure (e.g., water pressure/flow through a nozzle is also used to cause rotation).

During washing cycles activating segment 111, other segments are, for example, shut off (e.g., solenoid valves controlling other segments are commanded shut by the controller 130 during the washing cycles utilizing segment 111). Thus, segment 111 is afforded the highest level of pressure and volume that the system can maintain. The water pump with pressure booster 109 is, for example, capable of producing, for example, pressures in the range of 300-1500 PSI.

In one embodiment, controller 130 first sets the solenoids to activate flow for segment 111 and then sets solenoids to activate flow including wash (or pre-wash solutions), then sets pressure of the pumps to provide the flow (e.g., sets pressure of pumps 119 to maximum). 3-way solenoid operated valve 128 controls flow from either manifold 126 or manifold 110 to segment 111. The flow is maintained for a predetermined amount of time designed to allow the spray from the flow exiting segment 111 to completely wash the underside of the vehicle. A final coat may include, for example a spray that coats the underside of the vehicle with a protective substance (for example, a thin coating of oil (or, silicone based solution, or other natural/synthetic solutions—preferably a biodegradable solution) on the underside of the vehicle).

In one embodiment, rather than utilizing a separate pump 119 to deliver wash chemicals into the segment flows, a separate line from pump 109 is routed to storage tanks 117, 118, and 120, and causing a flow from one or more of the tanks into one or more segments of the washing system. Each tank may include an individual solenoid valve that allows or prevents the pressure from reaching the tank, thereby controlling whether the contents of the tanks reach the segment. An amount of flow from the tanks may be regulated, for example, through a reduced diameter line connecting the tanks to one or more segments. The pressure supplied by the pump 109 may be slightly increased over the pressure supplied in a staccato fashion to the rest of the system to insure flow from the tanks into the intended segments of the system. An increased staccato frequency and/or amplitude may be used to increase the flow from the tanks.

Another segment 115 flows from the same source (manifold valve) and provides additional nozzles to other locations (or similar locations) as nozzles 114A, 114B, etc. Other segments may be combined or have independent flows. For example, segment 111 and the segment providing flow to nozzles 116A, 116B, etc, are independent as each draw from an independent opening (and solenoid valves) of the manifold 110.

FIG. 1B is a diagram of a second exemplary layout of an automated vehicle washing system according to an embodiment of the present invention. FIG. 1B illustrates one of many possible additional arrangements of components that may be utilized according to the present invention. As shown, the pump 109 and instantaneous hot water heater 108 have been moved to a different location, and the water filter 107 has been moved to a location downstream of the manifold 110. Other arrangements swapping positions of parts or changing locations may be performed without departing from the basic designs and concepts of the present invention.

In addition to the vehicle washing capabilities, the present invention may also be applied to a fire suppression system. A special tank containing a fire suppressant can be utilized (e.g., routed into lines used for engine compartment cleaning). Alternatively, water from tank 104, or even soap and some other (non-flammable) washing chemical can be applied to the engine compartment if sensors indicate a fire is occurring (or manually initiated from a dash GUI by the vehicle operator). Exterior surfaces may also be inundated with wash/rinse and/or fire suppressant (in one embodiment, at least one tank includes fire suppressant/retardant that can be directed to be expelled from the nozzles) materials upon emergency command by the controller after receiving sensor inputs (e.g., temperature or smoke detector mounted in the engine compartment) indicating a fire or manual signaling received from the vehicle operator.

In fire suppressant embodiments, more than one type of fire suppressant may be stored in one or more of the tanks (or in a bottle). The tanks and/or bottles containing fire suppressant are pre-pressurized and activated upon release of a valve (e.g., solenoid operated). The types of fire extinguisher are Type B for gasoline fires, CO2 and dry chemical ABC types of extinguishers. For example, a fire indication from a fire sensor (which may be embodied as a plurality of sensors at strategic locations, e.g., 141A and/or 141B which may be one or more of fire, heat, and/or smoke sensors) located in an engine compartment may dictate a CO2 or dry chemical extinguisher. A fire indication from a fire sensor located near the gas tank (e.g., sensor 140A) or near the gas filler neck (e.g., 140B), may dictate a gasoline fire suppressant. Fire/smoke/temperature sensors at other locations may be configured so as to cause controller programming to dictate other responses from the system. In these embodiments, the controller is programmed to recognize the location of a fire alert and apply an appropriate suppressant to at least the areas near the sensor (alternatively, the entire vehicle is covered).

Tanks 152A, 152B, and 152C contain fire suppressants and are activated, for example, by opening a valve via a solenoid based on a signal from the controller. Manifold 150 connected to the tanks distributes the different types of fire suppressants in each tank. Depending on the type (or location) of fire the appropriate tank's contents will be released into the manifold & transmission lines and routed to the location of the fire. Tanks 152A, 152B & 152C, are, for example, canisters holding different types of fire retardants to fight, for example, any of engine fires, grease fires, gasoline fires, electrical fires, etc.

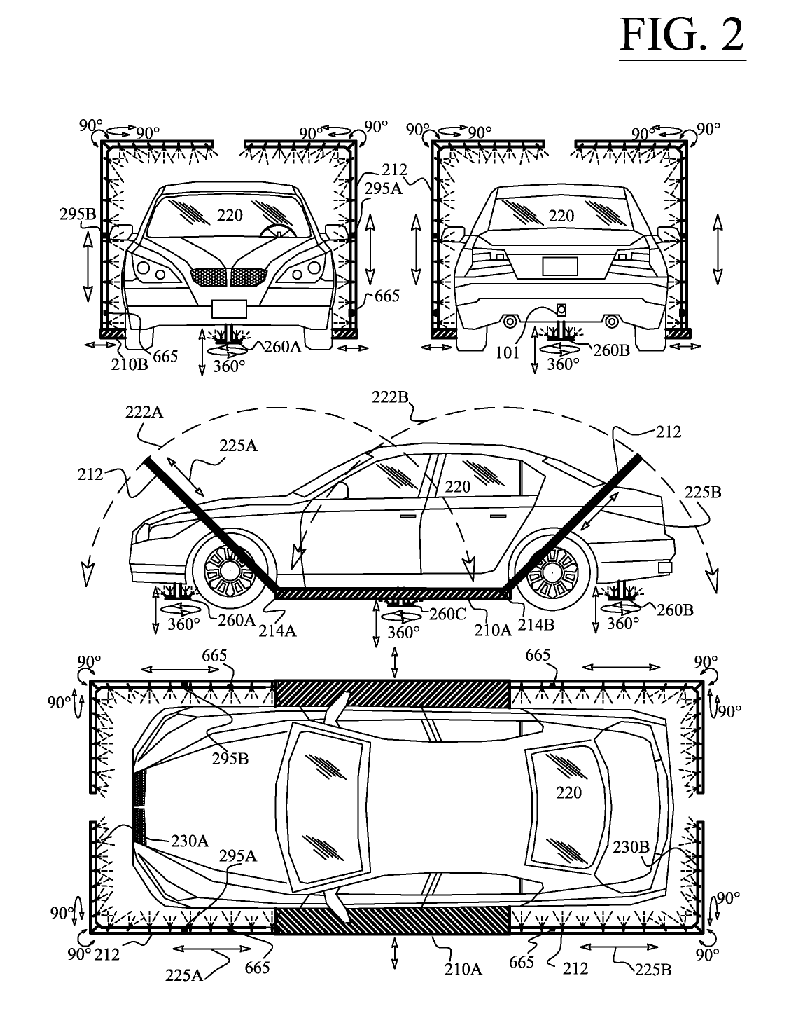

FIG. 2 is a diagram of rotating arm and undercarriage subsystems according to an embodiment of the present invention. A sliding undercarriage mount (210A or 210B) provides a platform from which arms 212 are unfolded (and optionally extended) and then, during operation rotated about a pivot points 214 (e.g., pivot points 214A and 214B). The arms 212 include high pressure lines that are, for example, a segment of the washing system. The arms may constitute a single segment, or each arm may be a separate and individual segment of the washing system.

Nozzles are attached at various locations on the arms 212. The arms are configured to rotate while applying high pressure spray of water and/or cleaning solutions to the vehicle 220. An exemplary rotation is illustrated by motion arcs 222A and 222B. In particular, the arms are intended to provide coverage for the rocker panels and sides of vehicle 220. The rotation is implemented, for example, via a stepper motor mounted at each pivot point and connected to the arm corresponding to the pivot point. The stepper motors are stepped by control signals sent from the controller 130 according to programming of each wash cycle in which the arms 212 are utilized. In combination with the stepper motor caused motion of the arms, the controller also sends signals to the pump 109 to activate pressure, the manifold valves to activate the specific segment(s) of the arms, and controls the flow of solutions from the tanks according to the current wash cycle being performed.

The arms 212 may be constructed such that once pressure is applied, the arms extend (e.g., exemplary extensions 225A and 225B). The unfolded arms increase the range and coverage of spray emanating from nozzles attached to the arms. The arms are extensions that may be implemented, for example, by a set of “piping” (not necessarily circular) having inside and outside diameters roughly equivalent that are fitted together at the inside and outside diameters. Stops may be used to set specific extension lengths and to prevent the pipes from separating. Alternatively, a spring load tensioner that extends with the pipes under pressure and automatically retracts the pipes once pressure in the segment is removed. In yet another alternative, the extensions or other movements of segments described herein may be performed using a combination of motors and gears or pneumatics.

In one embodiment, special nozzles 665 are provided to directly wash the tires/wheels of the vehicle. Special nozzles operate, for example, on a separate line run through arms 212. The separate line carries, for example, special tire cleaning fluid and tire shine chemicals.

An optional top portion (e.g., 230A and 230B) may be angled out from the arms to increase coverage to portions of a top, nose, and back sides of the vehicle 220 (and/or front, back, vertical (or near vertical surfaces). Additional arms symmetrical to those just described are implemented on the opposite side of vehicle 220. On another segment, a rotating turbo nozzle 260 (e.g., 260A, 260B, 260c, etc.) is utilized as part of an undercarriage wash cycle. The aforementioned wash nozzles may also be utilized.

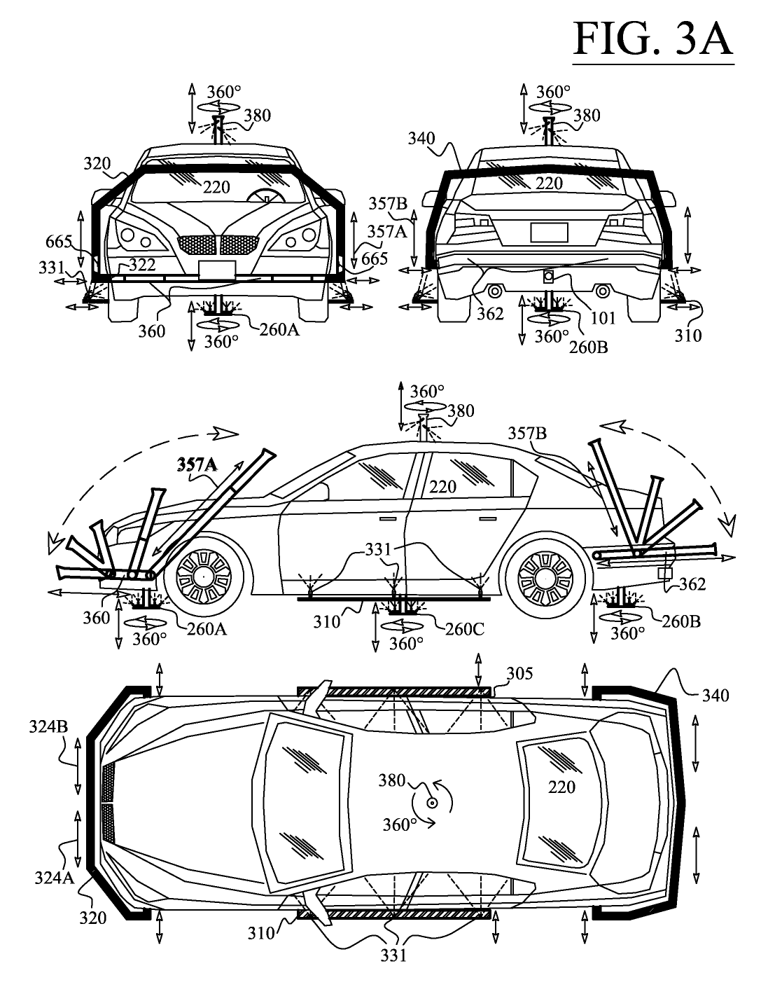

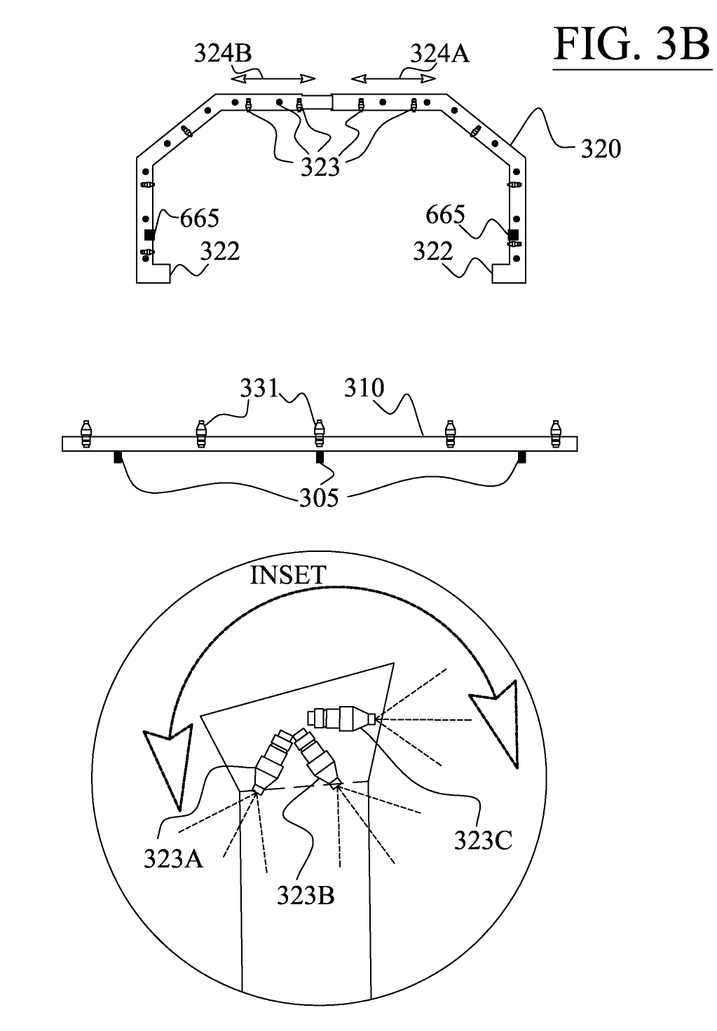

FIG. 3A is a diagram of various washing subsystems according to an embodiment of the present invention. As with all subsystems, segments, and arrangements of parts described herein, any one or more of such systems may be put together to be part of or make a complete washing system. For example, FIG. 3A illustrates an embodiment of a rocker panel washer 310 that may be used alone or in combination with rotating arms 212 previously described.

In one embodiment, a portion of the rotating arm is positioned to wash wheels and tires. Specific (but not dedicated) nozzles on the rotating arm are allocated specialized tire cleaners and protectorants, tire shine liquids or preservers, etc. Alternatively this may be performed via dedicated lines (tire lines) to a specific set of nozzles having a spray pattern that reaches the wheels and tires.

The controller opens valves that route tire cleaners and/or protectorants to the shared and/or dedicated lines according to a pre-programmed wash cycle.] In one embodiment, the tires themselves are taken care of in an independent tire washing cycle or sub-cycle.

Undercarriage rotating turbo wash 260 may be implemented alone (e.g., an optional undercarriage wash system offered to buyers in extreme climates), or in combination with any other wash processes or concepts described herein (e.g., undercarriage rotating turbo wash 260 offered in combination with rocker panel washer 310—which may also be offered alone or in combination with others). Although referred to herein as a “rocker panel washer”, unit 310 will wash the entire side of the car not just the rocker panel, the spray will reach all the way up to the windows the area between the 2 wheel wells.

The rocker panel washer 310 provides a base and conduit for fluids and other washing system materials for nozzles (e.g., nozzles 331) and is mounted on a slidable bar 305. The slidable bar 305 is slidably attached to the vehicle under the rocker panel. Alternatively, the slidable bar may be maintained inside the rocker panel when not in use and slide out via a trap door (not shown) when activated. The slidable bar 305 is, for example, attached to a segment feeding nozzles mounted on the rocker panel washer 310.

FIG. 3B includes an illustration of a U-bar embodiment of the present invention. A U-bar 320 is illustrated as having an inverted U-shape. The U-bar 320 includes a channel (e.g., line/line(s) or segment(s)) (the channel could be embodied, for example, as a hollow tube where the interior is the tube is a long and narrow manifold) for delivery of fluids introduced at one or more ends 322 (in the illustrated embodiment, the ends and pivots points are located at the same positions) to a series of nozzles 323 on the U-bar. A first U-bar 320 is mounted at a front of the vehicle. For example U-bar 320 may be mounted at a pivot point 322. Upon activation of water pressure, the U-bar extends out from under the vehicle (or from the bumper) and is rotated upward around a front of the vehicle and then back over the hood of the vehicle. Upon activation of, for example, a release valve and an amount of pressure in the line of U-bar 322, the U-bar slides out (e.g., inside perimeter of an upper portion of the U-bar slides over a matching outside perimeter of a lower portion on the U-bar) causing an extension (e.g., extension 324 A/B).

A seal prevents leakage from the sliding U-bar portions. In one embodiment, O-rings are utilized for the seal. In another embodiment, the seal includes some leakage, but is not of an amount sufficient to significantly alter the effectiveness of the washing system. In yet another embodiment, pieces 324A and 324B are fed with pressurized liquids, etc from opposite ends, each piece meeting in the middle and being slidably attached, but they are blocked off (do not transmit fluids from one end of the u-bar to the other). The nozzles may be configured to oscillate in vertical and/or horizontal planes in a manner that assures full coverage of direct impact from the spray pattern of the nozzles. Flexible line may be used at joints & sliding areas to prevent leaks.

The amount of extension may be regulated via a series of stops and releases on the sliding portions of the U-bar, and activated in time (e.g., via solenoids) according to programming of a wash cycle utilizing the U-bar. Ideally, the controller is programmed to extend the U-bar just enough to give the spray heads a reasonable effective spraying area and such that they will have sufficient force to be effective in cleaning/rinsing the vehicle (depending on the particular wash/rinse cycle).

Second U-bar 340 is mounted at a rear of the vehicle. The rear U-bar 340 operates in a similar manner to the front U-bar except that it first extends out sideways then back out from the rear of the vehicle and then rotates up and forward, causing spray/washing on the rear sides and trunk deck (and/or rear windows) of the vehicle.

Inset of FIG. 3B illustrates an exemplary construction of a U-bar according to an embodiment of the present invention. The U-bar has a cross-section that is hollow allowing for flow through the U-bar. Nozzles (e.g., nozzle 323A, 323B, and 323C) are mounted on the U-bar at a frequency such that the effective spray pattern, based on a distance from the vehicle surface, provides adequate coverage and cleaning power. Each nozzle provides, for example, a 15-120 degree spray pattern. 3 nozzles are illustrated, each mounted at a different angle (e.g., in a staggered pattern). In one embodiment, a three nozzle pattern is repeated at short intervals across the entire length (or portion) of the U-bar.

The nozzles may utilize a variety of spray patterns to enhance the effectiveness of spray coverage across areas of the vehicle being washed. For example, spray patterns may include, long and narrow, flat, elongated thin rectangular and/or rounded edges, conical—hollow cone, conical—solid cone, thin point, etc, the ultimate selection dependent upon the ability of the pattern to effectively cover a target area being washed. For example, conical high speed turbo-rotating nozzles may be used.

Nozzles on the U-bar are, for example, nozzles from pressure washing devices. Some overlap (e.g., overlap of approximately 10-20%) between sprays assures full coverage without blank spots in the resulting cleaning pattern. A check valve or combination solenoid and check valve may be placed in each line which checks backflow into the segment corresponding to each nozzle or set of nozzles.

In one embodiment, rather than rely on overlap between spray patterns, full coverage may be assured through the use of an oscillation induced upon the U-bar. For example, a mechanical movement may be induced on the U-bar through a motor and camshaft just off the pivot point 322. Alternatively, the solenoid switches on the U-bar may be programmed through the controller 130 (or 1187) to fire in a pattern that utilizes the system pressure and spray patterns to induce motion in the U-bar. The induced motion provides variation on the coverage area of each nozzle to assure complete coverage. The induced motion also enhances the cleaning effectiveness of the spray patterns.

The controller also includes connections to sensors that provide a status for certain items of the vehicle. For example, a current status of windows, sunroofs and other items are available to the controller (ideally, the controller would “tap into” existing sensors, or alternatively, new sensors could be installed and wired directly to the controller—(e.g., sensors 199C). The status is used to implement safety measures such as, prevent washing the sides/top of the vehicle if the windows are rolled down, the sunroof is open, or if the doors and/or trunk are open or partially open (or to automatically halt operations if a door, window, or trunk are opened during operation). In some cases, an override capability may be provided which is accessed (like other optional capabilities, including remote control or initiation of the washing system) through a touch screen GUI or other user interface.

A starting lock-out preventing the vehicle from starting if the connection status indicates a hose is connected to an inlet coupling of the vehicle. However, in certain cases the engine will have to be running for the car wash cycles to execute as designed. In such cases, the controller is programmed to cut-off the engine if the transmission shifter is taken out of park.

Maintaining an optimal distance from the surface of the vehicle being washed may be accomplished through various mechanisms. In one embodiment, one or more rollers (not shown) are attached to the U-bar and are used to maintain a fixed distance between the bar/attached nozzles and a surface of the vehicle being washed. Alternatively, an electric eye can be used to judge distances and provide feedback for adjusting the distance between the nozzles and vehicle surface.

In another embodiment, a rack and pinion gear arrangement (alternatively, a worm gear arrangement) dictates a distance the bar is maintained from the vehicle surface. The rack and pinion gear is located, for example, inside the inside diameters of two opposing parts fitted together such that the gear is fixed to one of the opposing parts and a driving gear fixed to the opposed part. Driving the rack and pinion gear in one direction increases the distance of a portion of the U-bar and driving the rack and pinion gear in the opposite direction decreases the distance. The rack and pinion gear is driven, for example, via attachment to a stepper motor. The rack and pinion gear stepper motor is controlled by the controller 130 which is programmed to maintain the U-bar a specified distance from a surface of the vehicle being cleaned. In one embodiment, both rollers and a rack and pinion gear are utilized. Alternatively, the mechanism described may be driven pneumatically or hydraulically (e.g., pumping air into an air cylinder will increase the size of the u-bar and releasing air will make it smaller).

The controller includes programming that is specific to the vehicle being washed so that movement of the U-bar matches a contour of the vehicle for the portion of the vehicle being washed by the U-bar (e.g., the programming is dependent, for example, on a profile or contour of the vehicle being washed and the movements of the U-bar approximate that profile or a portion of the profile). The varying distances of the U-bar are illustrated in positions 357A and 357B, for example.

As noted above, when not in use, the U-bar may be maintained under the vehicle. Alternatively, as illustrated at 360/362, a cavity in a bumper (or air foil/spoiler) of the vehicle may be utilized to fit the U-bar (e.g., U-bar pops out of the bumper (or an air foil/spoiler) when a washing cycle utilizing the U-bar is activated). The U-bar has, for example, a shape that is similar to the contour of the vehicle bumper, or, alternatively, has a basic U-shape.

In one embodiment, nozzles utilized by the invention may be located at nearly any location of the vehicle. The nozzles may be individually mounted or mounted in clusters on pop-out platforms. The pop-out platforms may be constructed similarly to lawn sprinkler pop-ups, but would generally be of smaller diameter feed lines compared to lawn sprinkler pop-ups. In addition, the nozzles and lines are of higher pressure, and generally directed in the opposite direction of the pop-up. Pop-outs move in a direction away from a surface of the vehicle and the nozzles generally spray back towards a surface of the vehicle. Pop-outs may be stationary or may utilize any number of rotating or oscillating mechanisms (e.g., oscillating in one or more plane). Such oscillations can be used to effect a partial or full coverage wash pattern on the vehicle.

An over carriage rotating turbo wash 380 may be implemented alone, or in combination with any other wash processes or concepts described herein (e.g., undercarriage rotating turbo wash 260 offered in combination with rocker panel washer 310, and over carriage system 380). The over carriage system 380 is placed, for example, on a pop-out (pop-up platform and is designed to wash top exterior surfaces of the vehicle.

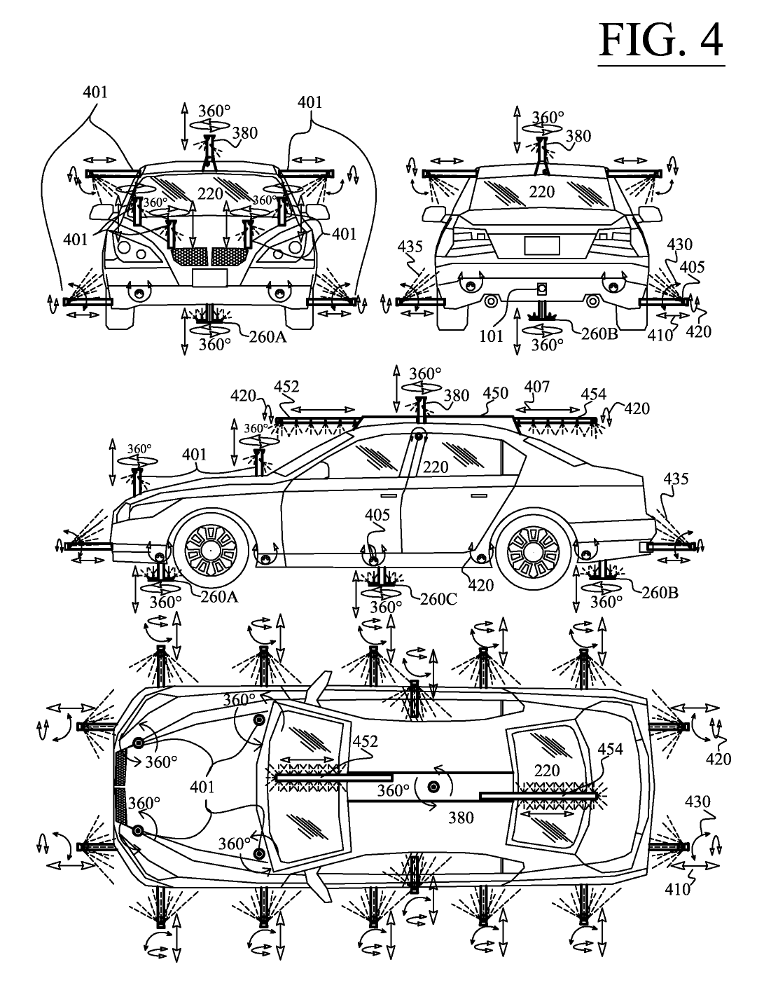

FIG. 4 illustrates a number of likely locations for pop-outs 401. The pop-outs are located in recessed areas (e.g., including a vehicle color matching cover on a spring loaded hinge). Each pop-out moves out from a vehicle surface (e.g., movement 410, to allow a spray pattern (e.g., pattern 435) to impact the vehicle surface. Each pop-out may also rotate (e.g., rotation 420). Each pop-out is fed by a high pressure line or segment of the washing system. Each pop-out may also include a solenoid valve for customized on/off operations as directed, for example, by the controller. In one embodiment, the pop-outs are configured to rotate in one plane and oscillate (e.g., oscillation 430) in another plane (e.g., 90 degree plane).

The pop-outs, just like all other washing mechanisms described herein, may be used alone or in combination with other washing mechanisms and use varying types of nozzles depending on the location of the pop-out and the type of washing to be performed. For example, a washing system utilizing the U-bar and rocker panel arms might also benefit from a select number of pop-outs strategically located at hard to reach crevices or corners in a vehicle's body design. Pop-ups may also be utilized on undercarriage washing devices to reach specific areas on the vehicle undercarriage. Alternatively, the entire washing system may be constructed using a sufficient number of pop-outs (the sufficient number being determined by a combination of vehicle profile, nozzle spray patterns, pressurization, rotation, etc sufficient for coverage of all surfaces desired to be washed). Further refinements illustrated in FIG. 4 include pop-outs 401 for washing selected surfaces of the vehicle. In addition, a double slide mechanism 452/454 (horizontal forward and rear extending (e.g., extension 407) roof-mounted pop-outs housed in optional enclosure 450) and pop-out 380 provide coverage for top surfaces of the vehicle.

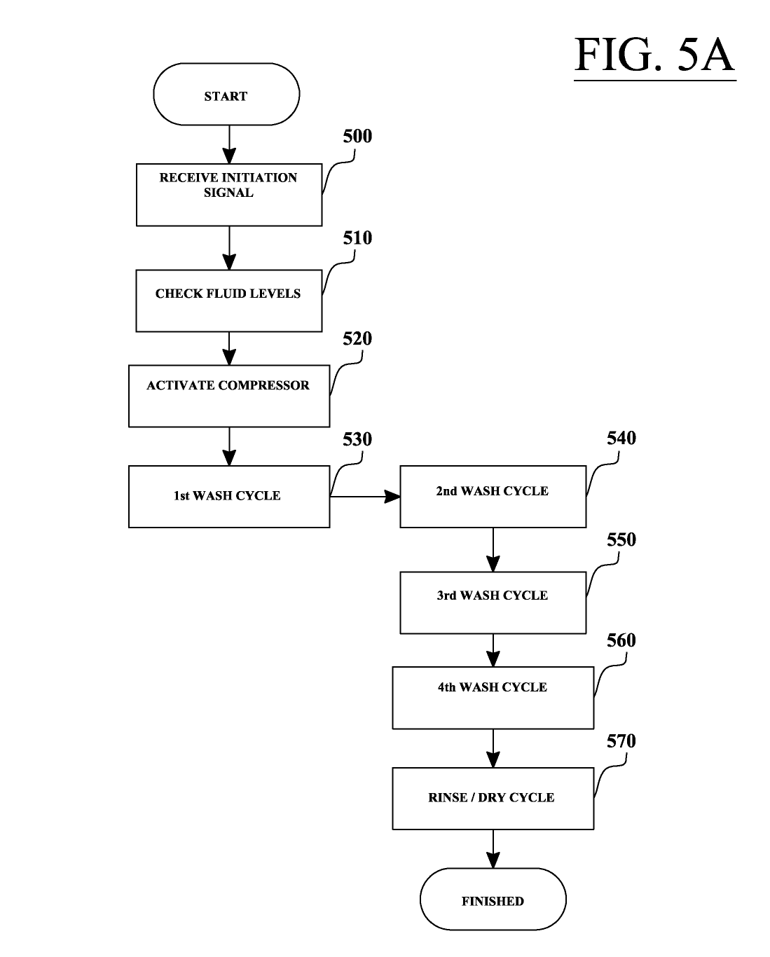

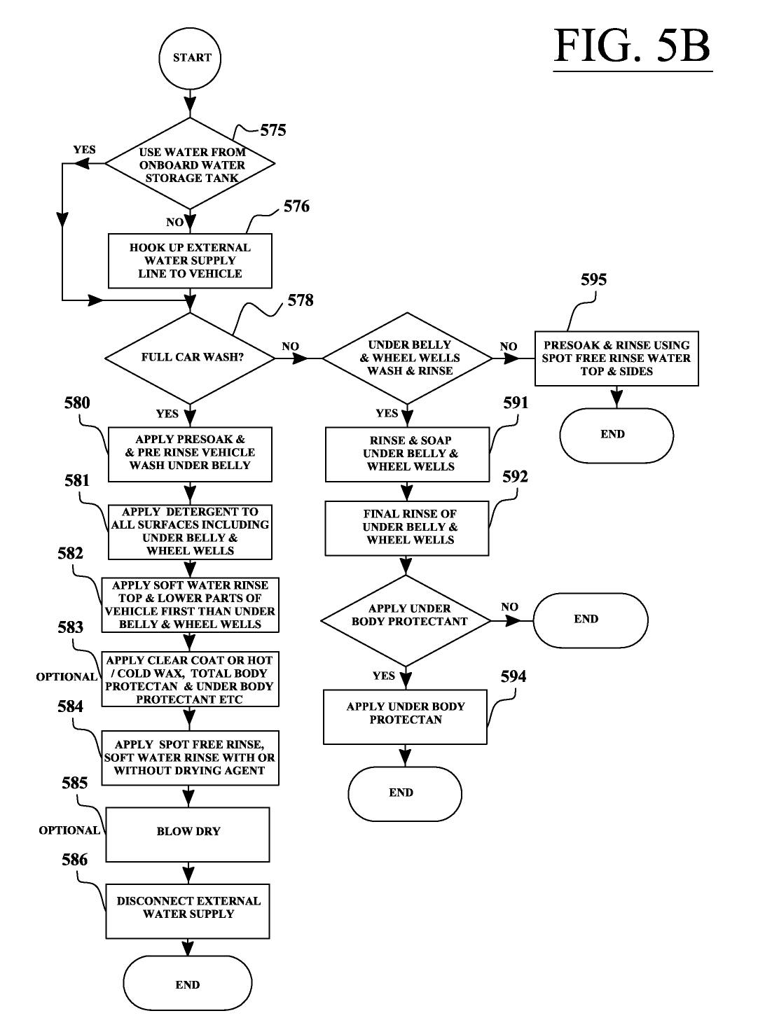

FIG. 5A is a flow chart of an embodiment of system processes according to an embodiment of the present invention. At step 500, the controller receives a wash signal that indicates that the vehicle is to be washed. The wash signal is initiated, for example, by an operator pressing a wash button on the dash of the vehicle (e.g., mechanical button, or virtual buttons on a GUI interface, heads-up display, or via a voice command (e.g., voice recognition via digital signal processing (DSP) or other technologies). The wash signal may be transmitted partially or entirely via wireless devices (e.g., remote initiation via a wireless network communication (e.g., 802.11 signal, infrared signal, or a wireless communication available as an option on a remote car unlock keyfob (implemented, for example, as a separate button or specific pattern of other buttons already on the keyfob (e.g., press lock 4 times in rapid succession).

To insure that the wash system is not activated unintentionally, a very unique pattern may be used for the car wash initiation. Alternatively a more proactive confirmation (step 510) may be implemented. The confirmation may be, for example, a wash warning signal (e.g., voice prompt indicating a wash is about to start, please confirm) and reply (e.g., a repeat the initiation signal, or a separate unique wash confirmation key sequence). If the confirmation is not received in its entirety, the sequence for initiating the wash is repeated. In addition, fluid levels are checked via sensors (or check for hose attached) and the controller is programmed to not initiate a wash process unless enough fluids are available to complete all cycles in the wash. Alternative, low fluid wash cycles may be optionally (or automatically) initiated when warranted by low fluid levels.

Although only one wash signal is illustrated, a complete wash cycle may be a series of sub wash cycles. Preferably, the operator is provided the option for initiating a complete wash cycle or any selected sub-wash cycle, or a custom programmed wash cycle (e.g., a custom wash cycle that particularly suits the cleaning requirements of the operator). A custom wash cycle for an operator that frequents dusty roads where the grime does not solidify too much onto the surface of the vehicle may only require an often quick spray rinse rather than a full wash (or wash and a full application of wax, protectorants, rain-x, etc.). The custom wash can be set to be easily activated, and other wash cycles needed less frequently (e.g., full wash and wax) can be accessed, for example, view alternate menus or button presses.

At step 510, system levels are checked. The levels include, for example, levels of fluid maintained in each of the storage tanks. Depending on the specific capacities of reservoirs (or tanks) in a particular embodiment of the invention, certain levels of wash fluid (e.g., water, conditioned water, or a specific wash formulation) may be required before the system begins a wash cycle.

Additional level checks include an amount of air pressure maintained in an air tank. In one embodiment, an air tank is used to maintain a volume of pressurized air for turning ordinary soap or wax into foam and blow drying operations and/or clearing of lines to remove residual fluids and/or winterize the lines and nozzles. The air tank is similarly configured to the fluid tanks in that it includes valves controlled by the controller and lines to route the air pressure to points in the system for clearing lines (removing residual liquids and/or clearing dust.

Additionally, the air tank is configured to pressurize the entire system including various other tanks for operation of one or more wash cycles. Lines and valves permit an air compressor (e.g., a separate air compressor, or a dual use pressure booster already installed in the system) to charge the air tank as needed to maintain pressure between washes or just prior to wash initiation. The air compressor may be connected directly to the air tank or compressed air is routed to the air tank via lines which may be re-routed (e.g., via setting valves by the controller to create a path) such that the compressed air charges other tanks in the system. Therefore, the embodiments include an embodiment in which the air tank is charged and then the air tank is used to pressurize the system and/or individual other tanks of the system, and an embodiment in which each of the individual tanks is charged directly from the air compressor to pressurize the system.

In one embodiment, the air is heated within the system at a point prior to exiting the system through one or more of the nozzles (e.g., a heater element in the manifold or a heating chamber). The heated air assists in drying the vehicle during blow dry operations and/or used in de-icing operations. In one embodiment, heated air is specifically directed at key locks.

If the levels are low but not empty, a warning is displayed and may also give the operator the option of continuing with the caveat that the wash may not be completed before running out of fluids. The warnings and other communications may occur through a GUI that interfaces with the controller, via dashboard lights, voice prompts, and/or other alternatives.

At step 520, the pressurizer (pump/pressure booster pump) is activated and, depending on the programming of the wash cycle signal (or other signals received), wash cycles begin (e.g., step 530). The wash cycles are controlled by activating valves used to initiate/perform the wash cycles. Each wash cycle includes, for example, a pressurization table that indicates how much pressure should be used during the wash cycle and/or portions of the wash cycle. The controller signals the pressurizer to increment or decrement the pressure according to programming that, for example, utilizes the pressurization table to specify the amount of pressure to be applied. The pressurization table represents an optimized pressurization for a particular wash cycle. In one of the simpler alternatives, the amount of pressure is maximized throughout the entire wash cycle (abrogating the need for a table or other programming regarding pressure—the pressurizer is simply switched on at the beginning of the cycle and off upon completion of the wash and/or wash cycle).

Step 530 represents a 1^{st} wash cycle which is, for example, an undercarriage wash sub-cycle that comprises a cleanser soak phase (wet and soap the undercarriage of the vehicle) and an undercarriage rinse phase. In one alternative, the undercarriage rinse phase may be completed or followed by a spray of an undercarriage protectorant that prevents or resists the attachment of salt and/or road dirt and grime that comes in contact with the undercarriage of the vehicle. In one embodiment, the undercarriage protectorant is liquid silicon sprayed onto the undercarriage. In another embodiment, the undercarriage protectorant is an oil based liquid (e.g., heat resistant oil base engineered formulation).

The cleanser utilized in the undercarriage sub-cycle may be ordinary detergent, but is preferably a more heavy duty solvent for dissolving the type of grease/grime mixes that often occur on vehicle undercarriages. The heavy duty solvent is maintained in a separate solvent reservoir and is applied to the undercarriage by pressurization and valve settings (the controller opens and closes the combination of valves that cause heavy duty solvent to flow under an appropriate level of pressurization to the wash nozzles on the underside of the vehicle, causing the solvent to be applied to the undercarriage of the vehicle. The appropriate amount of pressure is an amount sufficient to apply and cover the underside of the car.

In one embodiment, a high pressure spray is applied to the underside of the vehicle prior to applying the solvent (thus first knocking off loosely adhered dirt and grime upon which the more expensive solvent would be inefficiently used to remove. The high pressure spray (e.g., a pre-solvent cycle) is, for example a hot water/steam spray at high pressure, the controller signals the pressurizer for maximum pressure and the heating unit provides maximum heat creating a hot water and steam spray. The maximum heat and pressure will be different depending on the quality of tubing and other components used in the system. An acceptable design criterion for reservoirs, connectors, tubing, nozzles, valves, etc, is when they are of sufficient strength and quality such that pressures generated from portable commercial pressure washing systems can be safely handled.

After the solvent is applied, the controller implements a wait period in which the solvent is given an opportunity to soak further into accumulated grime. To more effectively utilize the available time, during the soak phase, other parts of the vehicle (e.g., upper body surfaces, wheels & tires, etc}, may be given an initial rinse/soak. Once undercarriage soak phase is completed a high pressure rinse (e.g., a hot water/steam combination) rinses the solvent and loosened grime from the undercarriage. In one embodiment, the high pressure rinse may be prefaced with a quick high pressure application of the same or another solvent.

The cleansers and rinses of the wash cycles/sub-cycles and various phases are applied, for example, using nozzles mounted in nozzle bodies that extend outward when system pressure is applied (e.g., away from the body surface which the treatment is being applied, thereby providing a better angle for application of the treatment). In one embodiment, for undercarriage mounted nozzles, the nozzle body is mounted in a fixed position such that the outward extension of the nozzle body is basically in a downward direction away from the vehicle undercarriage. The nozzle itself, is then mounted on the nozzle body extension so that spray from the nozzle is directed upwards (or towards the surface of the undercarriage. In one embodiment, the nozzles are mounted in fixed positions of sufficient quantity and of a combined spray pattern to cover the entire underside of the vehicle (although selected portions of the undercarriage may be purposely left without wash or may be washed at reduced pressure (e.g., undercarriage portions having electronics or sensitive parts). Alternatively, the nozzles may be of the type that rotates (e.g., reaction rotation due to water jet as it is expelled from the nozzle).

In another embodiment, nozzles are mounted on a bar that is attached to a track that is configured to allow the bar to be slid under the vehicle (a slidable/sliding or slideably attached bar) to allow application to the entire underside of the vehicle with fewer nozzles. In yet another embodiment, a combination of a slidable bar and fixed nozzles are utilized. As with the rocker panel embodiment described below, the slidable bar may also be arranged so that it can be rotated (e.g., stepper motor attached to the bar and the stepper motor increments are controlled by the controller). Rotation through, for example, 10 or 15 degrees of rotation of the slidable bar increases the reach of the spray pattern of the nozzles mounted on the bar and provides increased number of angles of incident of the treatment being applied throughout the coverage range of the nozzles.

The programmability of the controller and the ability to rotate the bar in fine increments or to precise angles provides for the ability to program the wash cycle and rotations of the nozzles to match physical features of the vehicle's undercarriage. For example, a vehicle may have certain undercarriage areas that extend further away from the overall vehicle (such as a muffler or spare tire holder), and the programming takes into account such protrusions and rotates the nozzles to a position that misses those protrusions when passing by as the bar slides under the vehicle.

The length of time each nozzle sprays at any one position is part of the programming implemented by the controller. The nozzle includes a spray head that is, for example, a rotating turbo wash head.

The wash fluid may be colored with dyes (e.g., non-permanent color biodegradable dyes) or other substances to improve the appearance of the wash process. For example, an operator with a blue car may wish to use a blue tinted wash fluid. Food dyes or other additives may be utilized to achieve the desired color. Although less necessary for an undercarriage wash cycle, an ending phase of any cycle, sub-cycle, or phase may include, for example, a high pressure air blast (e.g. heated air) to remove remaining rinse droplets and perform a drying process.

After completion of the undercarriage sub-cycle, the 2^{nd} wash cycle 540 is initiated, and is, for example, a top panel sub-cycle. The top panel sub-cycle comprises, for example, cleanser and rinse phases implemented by wash nozzles mounted on upper surfaces of the vehicle. The upper surface mounted nozzles are designed to pop-up when pressurized and then spray down toward the upper surfaces of the vehicle. Other mechanisms, such as unfolding arms, may be utilized to place nozzles in appropriate positions to apply the cleanser and rinse fluids. The cleanser is, for example, an auto wash cleanser applied from an auto wash reservoir.

After completion of the top panel sub-cycle, a 3^{rd} wash cycle 550 is initiated, which is, for example, a side panel wash cycle (or sub-cycle). The side panel sub-cycle comprises, for example, a cleanser phase and a rinse phase. The side panel sub-cycle may utilize a rocker panel area mechanism as described above. The pivoting arm portion of the rocker panel area mechanism may be extended further to, for example, clean the wheels and tires. Addition cycles, such as a 4^{th} wash cycle 560 may also be initiated. And, a rinse dry cycle 570 rinses all remaining wash residues from the vehicle. The rinse portion of the cycle is implemented at least in part using spot-free rinse water. The rinse portion may be implemented, for example, by first rinsing with tap water, and then applying a final rinse using water that has been treated to be spot-free (e.g., water run through a reverse osmosis (RO) system or treated, for example, with a jet dry type additive similar to those used in household dishwashers for a spot-free rinse).

The rinse dry cycle optionally, includes a blast of air from the nozzles (compressed air tank/pressurizer alone—without fluids from any tanks) to help remove any remaining rinse droplets and expedite drying. In colder climates, the blast of air also provides a purge of the residual liquid is the segments and thereby prevents them from freezing in place. The blast of air may include, for example, air blasted to remove residual liquid from a water filter (in this embodiment, compressed air heater 125 heats air from compressor 123 being routed through the filter 102).

FIG. 5B is a flow chart of another embodiment of system processes according to an embodiment of the present invention. At step 575 a determination is made on whether to use water from the onboard water storage tank. Alternatively, water is supplied from an external water source (step 576). If a full car wash is desired (step 578), pre-soak (step 580), detergent (step 581), soft water rinse (step 582), optional clear coat (step 583), spot free rinse (step 584), and optional blow dry (step 585) cycles are performed. The external water supply, if connected, is disconnected (step 586).

Alternatively, a partial washes may be performed such as an underbelly rinse & soap (step 591), rinse (step 592), and optional under body protectorant (step 594). Another partial wash that may be performed is, for example, a pre-soak and rinse of tops and sides of the vehicle (step 595).

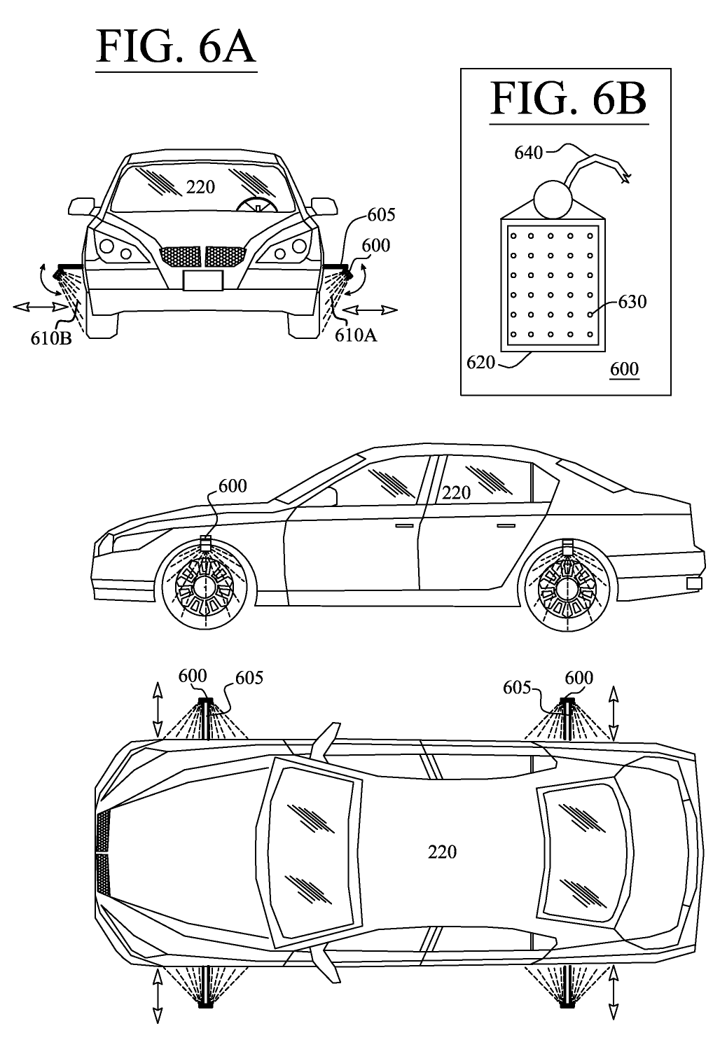

FIG. 6A is a drawing of a brushless tire washing subsystem according to an embodiment of the present invention, and provides a 3 view illustration of devices according to an embodiment of the present invention. Tire/wheel cleaning pop-outs platforms 605 are located near the tires of the vehicle. The pop-out platforms are illustrated above the tire on a perimeter of the wheel well, but could be placed in other positions such as in front of the wheel or to the rear of the wheel. The pop-out platforms include a tire washing nozzle that is connected to one of the lines or segments of the washing system, which is either a separate line or integrated into the pop-out platform structure (e.g., spray heads 610A & 610B operating on separate lines for tire washing).

Each wheel/tire is provided with a washing nozzle, which may be individually angled (e.g., mechanically or via varying pressure in the segment feeding the nozzle) to provide wash/rinse coverage for the entire wheel and tire. Each tire is equipped with a tire washing nozzle 600 and a pop-out arm 605 that produces a spray pattern 610.

As shown in FIG. 6B, the tire washing nozzle 600 includes, for example, a base 620 with an array of outlets 630 from which high pressure wash, rinse, protectorants, and/or air is ejected (and fed via segment 640). The rinse is applied at high pressure (e.g., 500 to 1500 PSI), soap or tire cleaning chemicals are applied at low pressure (e.g., 60-100 PSI), rinse at high to medium pressure (e.g., 100-500 PSI), tire dressing chemical at low pressure, final rinse at medium pressure. After application of spray-on type of tire dressings, an RO rinse is preferably performed to rinse off excess tire dressing to eliminate sling of those chemicals to other parts of the vehicle as the tire turns while being driven.

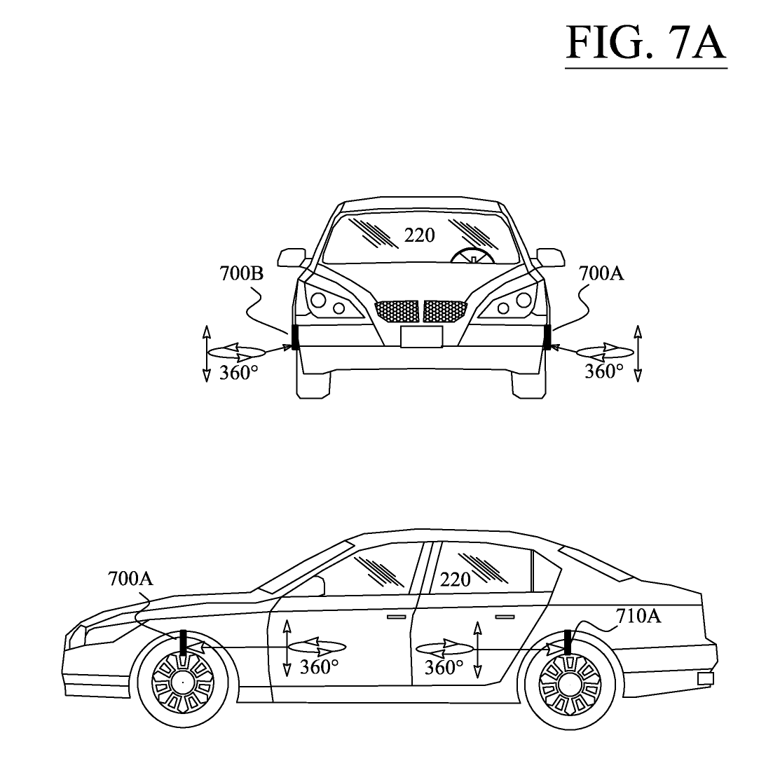

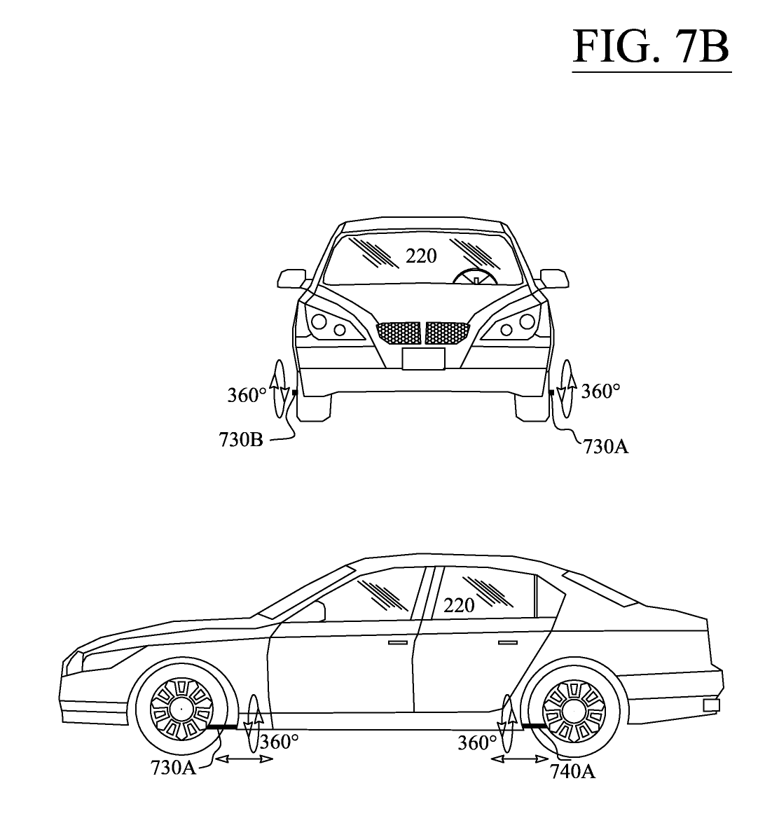

FIG. 7A is a drawing of an installed exemplary tire shine applicator 700/710 (e.g., applicator 700A, 710A, and 700B) according to an embodiment of the present invention. The tire shine applicator 710 pops down and reveals a rotating sponge/brush that applies tire shine chemicals/fluids/solutions according to programming of the controller.

FIG. 7B is a drawing of an installed 2^{nd} exemplary tire shine applicator 730/740 (e.g., applicators 730A, 740A, and 730B) according to an embodiment of the present invention. The tire shine applicators 730 and 740 slide out to reveal a rotating brush that applies tire shine or tire dressing according to programming of the controller. Applicators 700/710 and/or 730/740 may be either the illustrated rolling type applicator, or alternatively be a stationary applicator (or could be adapted to use a brushless applicator like that illustrated in FIG. 6).

FIG. 8A is a drawing of a rolling type tire shine applicator 800 according to an embodiment of the present invention. The applicator is fed tire shine solutions via segment/line 830. A roller style brush/sponge 810, when not in use, is enclosed in a housing 802.

FIG. 8A includes a solenoid provided to control ejection of the brush from housing 802. The brush is ejected when control signals command the solenoid to open an air supply line 840 and air under pressure enters chamber 850, pushing piston 820 down, ejecting the brush. The air pressure is released and a retention spring 855 pulls the brush back into the housing 802 upon completion of the cycle. Alternatively, the air supply line provides a negative pressure that pulls the piston (and brush) back into the chamber. An optional end cap 865 may be provided to seal the housing.

FIG. 8B provides an operational view of a rolling brush or sponge style tire shine applicator according to an embodiment of the present invention. As shown in FIG. 8B, the spring 855 is extended as 855A. The spring 855/855A is, for example, a hollow coil that transfers fluid from line 830 to the brush/sponge 810 (through channels 860, for example). Upon activation, compressed air forces the roller brush to slide out 885. The rolling type tire shine applicator is disposed near a wheel well such that, upon activation, the roller brush contacts the exterior sidewall surfaces of tire 870. Tire shine fluids supplied via segment 830 inundate the brush materials which are then applied by the brush (or sponge type) materials to the tire surfaces.

In the illustrated exemplary embodiment, a last portion of the segment 878 doubles as an axle around which the brush rotates. Rotation of the brush may be effected by water pressure jetting out at angles from within the brush or by movement of the vehicle's wheels. After operation, the brush is retracted, for example, via springs back into the housing.

FIG. 8C is a drawing of an operation view of a stationary (non-roaing) sponge tire shine applicator according to an embodiment of the present invention. In this embodiment, a non-rotating sponge 890 contacts the tire surface to apply tire shine fluids. In one embodiment, as the wheel turns, tire shine fluid is deposited on the tire's surface.

The brushed/sponge (rolling/stationary) washing sub-systems include brushes of a cylindrical or other shape that extend out toward the tire/wheel of the vehicle. The brushes are designed, for example, to drop down from the wheel wells, and, when extended in the down position, brush against the tire (or extend further and brush against the tire and wheel simultaneously). The brushes include outlets that feed tire shine to the brushes according to a cycle in a program implemented by the controller.

As with each of the tire cleaning embodiments described herein, the controller is programmed to apply wash and rinse according to a predetermined wash/rinse cycle or sub-cycle. In addition, optional applications of tire protectorants are also performed (e.g., running protectorants through the same or parallel lines to at least one of the tire washing nozzles).

The tire shine applicator sponge/brush preferably includes an enclosure/housing, but may be used with or without an enclosure. The enclosure is mounted, for example, above the vehicles tire in each of the front and rear wheel wells. On activation the tire shine applicator sponge/brush extends down toward the tire/wheel. In an alternative, the tire washing brushes, housing, and lines, are mounted on a track in the shape of an arc to allow repositioning of the brushes at any point along the arc (the arced track is, for example, mounted in the wheel wells of the vehicle.

Recapping FIG. 8, the following items are shown in the figures, as further enumerated by example in Table 1B:

TABLE 1B

| | |
|---|---|
| 800 | Tire shine applicator |
| 802 | Tire shine applicator housing |
| 810 | Tire shine rotating sponge. |
| 820 | Piston or plunger |
| 830 | Supply line - tire shine (or cleaning) chemical. |
| 840 | Compressed air supply line supply compressed air into |
| | cylinder to push piston. |
| 850 | Cylinder or air chamber. |
| 855 | Coiled supply line spring combination shown in |
| | retracted position. |
| 855A | Item No. 855 in extended position. |
| 860 | Holes in sponge mounting shaft, allowing flow of tire |
| | shine (or cleaning) chemical from shaft into sponges. |
| 865 | End cap of sponge housing, doubles as rim guide in |
| | extended position. |
| 870 | Vehicle tire |
| 875 | Vehicle tire rim |
| 878 | Tire shine supply channel in sponge housing. |
| 885 | Movement of sponge from stowed position. |

FIG. 9 is a diagram of a dual sided rotating arms 910A-910B and undercarriage subsystems according to an embodiment of the present invention. Arm 910A operates on a driver's side of the vehicle 220 and arm 910B operates on a passenger side of the vehicle 220. Each arm (e.g., 910A) extends, slides forward and back, and rotates according to a contour of the vehicle 220. The result is that a top portion of the arm follows a path 955 that closely matches the vehicle contour. When folded (typically not in use) the arm is stored, for example, on a platform/tray (e.g., 920A/920B) that slides out from under the vehicle (e.g., under the rocker panels). In one embodiment, the nozzles on the arm are still able to be used when folded and stowed under the car (in such an embodiment, the folded and stowed position of the arm places the nozzles on the arm in a position that they can be utilized for at least part of an undercarriage wash cycle).

The combined extension and rotation is programmed into the controller which controls the amounts of extension and rotation such that the arm maintains a distance from a surface of the vehicle to optimize cleaning effectiveness of wash spray from nozzles attached to the arm. Alternatively, mechanical stops are set at distances appropriate for a particular vehicle (e.g., a vehicle having a max extension of 4 ft would have a mechanical hard stop at slightly more than 4 ft, such as 4′6″, to ensure an effective spraying distance from the vehicle surface).

An effective distance from the vehicle surface is, for example, 25-30 inches or less (e.g., ˜6″ in the hard stop example above). The actual distance maintained may be adjusted based on, for example, a spray pattern of the nozzles, an amount of pressure under which the nozzles operate, and/or an amount of motion induced in the arm or nozzles during washing operations. The final distance is determined such that the vehicle's surface receives adequate spray coverage. In one alternative, instead of precise contour following as illustrated by 955, the arm scribes an arc over the contour of the vehicle.

Platforms 920A and 920B are platforms that move out from under a rocker panel of the vehicle 220. Platforms 920A and 920B may alternatively be stowed inside rocker panels of the vehicle (e.g., behind a rocker panel trap door). The platforms move out away from the vehicle and allow the arms to extend. Once extended, the motion of the arms can be caused by a combination of extension/contraction of the arms and rotating of the arm. The platforms 920A and 920B provide a platform from which such rotation may be implemented. In other embodiments, the base itself is just an attachment point for the arm, and the base is mounted on a sliding platform riding on a track that allows the entire arm assembly to move from just in front of the rear wheel to just behind the front wheel.

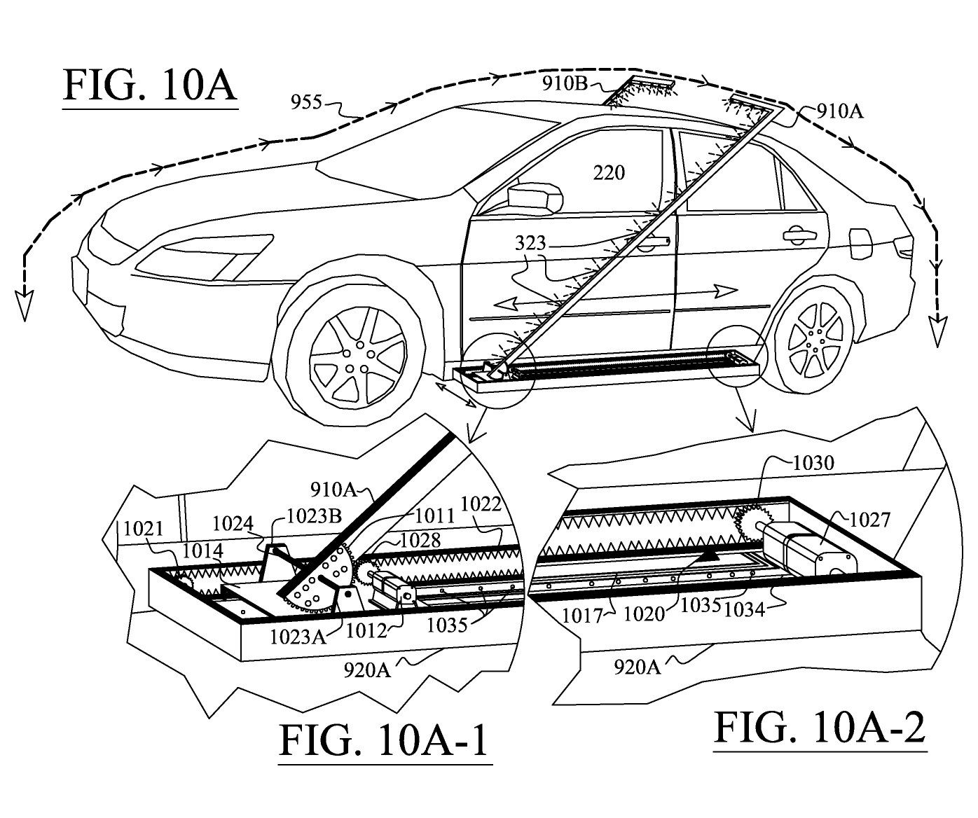

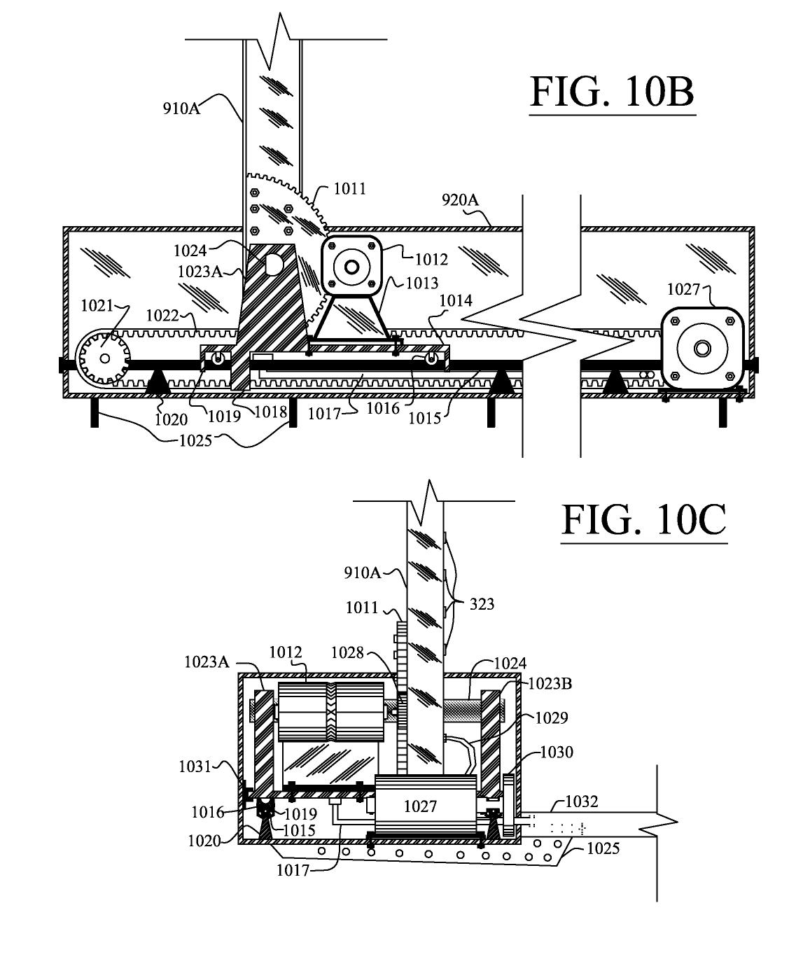

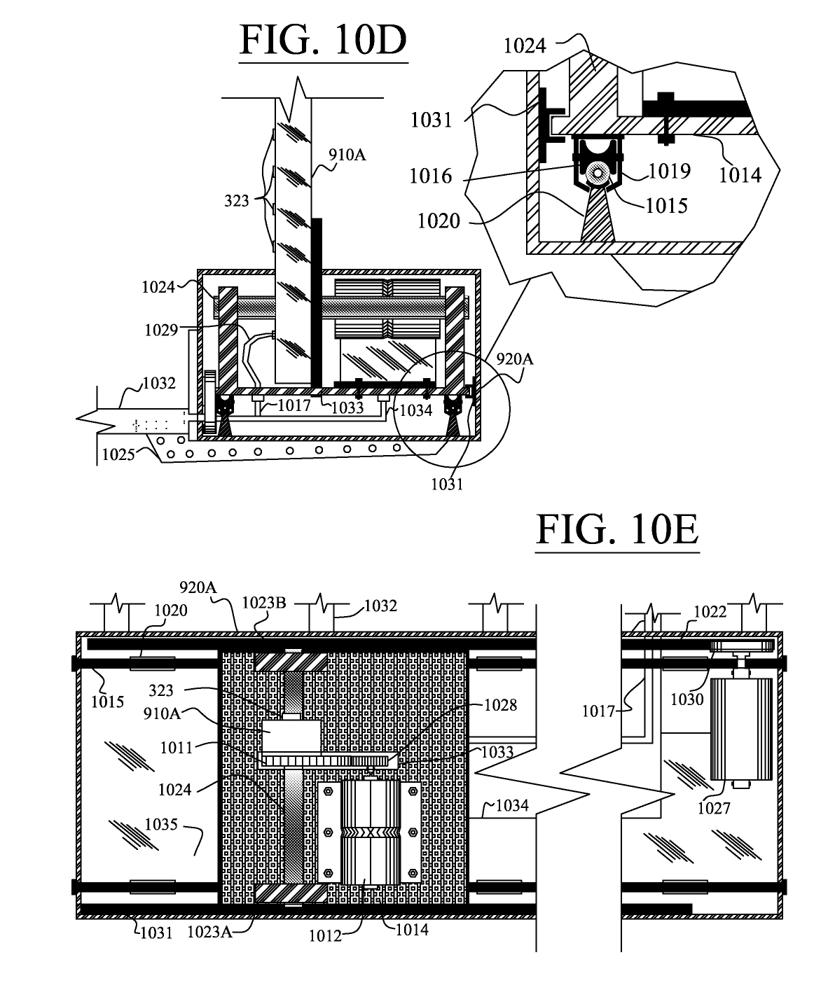

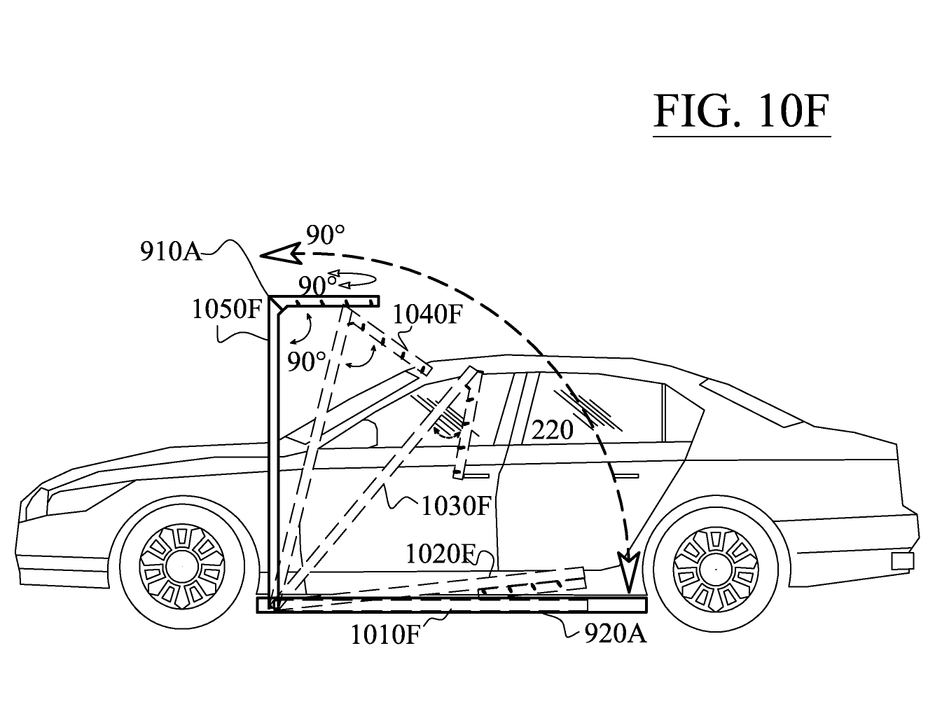

FIGS. 10A-10E provide details of one possible arrangement of mechanical components for implementing an arm and platform according to an embodiment of the present invention. As with other systems/subsystems described herein, many other arrangements of components are possible to implement the arm and platform portions of the present invention, and such other arrangements will be apparent to those skilled in the relevant arts upon review of the present disclosure.

In more detail, FIG. 10A provides details of a mechanical arrangement capable of stowing and moving the arms (e.g., 910A and 910B) as described to effect the various wash cycles described herein. A drawer-like platform 920A includes gears, motors, and more as described in Table 1C and arranged as shown in FIGS. 10A-10E.

TABLE 1C

| | |
|---|---|
| 910 | 910A and 910B Wand housing spray nozzles. |
| 1011 | Half round gear attached to spray nozzles wand to swing wand through 180° during |
| | various wash cycles. |
| 1012 | Electric motor and gear combo to mesh with item 1011 to swing wand through 180° |
| | during various wash cycles. |
| 1013 | Electric motor mounting bracket. |
| 1014 | Sliding platform to house spray wand, drive motor and gear etc. |
| 1015 | Round guide rail or track for item 1014 to slide on from one end of the wash |
| | mechanism equipment tray to the other. |
| 1016 | Roller or wheel attached to item 1014 and riding on item 1506. |
| 1017 | Flexible chemical, water and air supply line to spray nozzles. |
| 1018 | Bracket to attach drive belt to sliding platform items No. 1014. This will allow the |
| | belt to drag the platform from one end to the other. |
| 1019 | Bracket attaching the roller wheel to the moving platform and guide rails. Note: - |
| | bracket has closed ends so as to not allow the platform to come off the guide rails. |
| 1020 | Guide rail stand. |
| 1021 | Free moving gear for platform-geared belt. |
| 1022 | Geared belt. |
| 1023 | 1023A & 1023B pivoting pin/axel mounting hard points. |
| 1024 | Pivoting pin (shaft)/Axel for spray wand. |
| 1025 | Brackets attached to extending shafts for sliding the entire wash mechanism-housing |
| | tray into wash position. |
| 920 | 920A & 920B (not shown, not visible on FIG. 10A) Sliding wash mechanism |
| | equipment tray. |
| 1027 | Electric drive motor to turn geared belt that in turn moves the sliding platform housing |
| | the spray wand. |
| 1028 | Gear attached to motor used to rotate the spray wand through 180°. |
| 1029 | Flexible supply line attached to moving platform and spray wand. |
| 1030 | Gear attached to drive motor from turning the geared drive belt attached to moving |
| | platform. |
| 1031 | Guide rails to restrict vertical movement of sliding platform. |
| 1032 | Extendable shaft to (either electrically, pneumatically or hydraulically extendable) |
| | slide wash mechanism tray in and out of vehicle. |
| 1033 | Cut out in moving platform to allow items No. 1502 to pass through as it rotates |
| | during various wash cycles. |
| 1034 | Conduits housing electrical wire for drive motors. |
| 1035 | Weep holes (drain holes) at bottom of equipment tray. |
| 323 | Individual spray nozzles. |

FIG. 10A-1, 10A-2, 10B, 10C, 10D, and 10E provide additional details of draftsman quality layout for various components that may be utilized in various embodiments of the present invention, and particularly for moving the arms as described herein. In essence, in this specific embodiment, electric drive motor 1027 drives geared belt 1022 which is fixed to sliding platform 1014. Sliding platform 1014 contains electric motor 1012 which moves/rotates half-round gear 1011 and corresponding arm 910A. Both motors 1027 and 1012 are controlled by the controller to rotate and elevate the arm 910A according to predetermined movements to cause the arm to travel, for example, path 955. Other movements may be programmed into the controller to effect other paths according to a particular wash cycle.

FIG. 10F is a diagram illustrating an extension of a rotating arm according to an embodiment of the present invention. Arm 910A is illustrated in various stages of extension. First, at 1010F, the arm 910A is entirely stowed under the vehicle. At 1020F, example stage 1, the arm 910A is still folded, but out from under the vehicle and slightly elevated. At 1030F, example stage 2, the arm 910A is further elevated at partially unfolded. At 1040F, example stage 3, the arm 910A is nearly more fully unfolded and nearly erect. At 1050F, example stage 4, the arm 910A is fully unfolded. The stowed, partially extended, and/or fully extended arm can then be utilized according to one or more wash cycles programmed into the controller.

The various stages of extension reflect a motion from full stowage to operational readiness which occurs upon command of stepper motors or pressure increases along lines and segments in the arm. Such stepper motor commands and/or pressure increases are at the command of the controller which includes programming to send signals to step the motor predetermined amounts at predetermined intervals and/or pressure increases in the aforementioned lines and segments.

Lines or segments maintained within the arm may include, for example, flexible elbows (e.g., high pressure poly tubing or the like) that tend to straighten upon application of water pressure. Using that characteristic, the flexible elbows can be used to effect or assist unfolding of the arms. Pressurization of the lines and/or segments within the arms is, for example, performed in stages during extension of the arm. The lines or segments within the arm may include shut-off valves that reduce or prevent pressurization of portions of the arm that remain folded until the next stage.

In yet further embodiments, a track may be installed along an entire length of the vehicle (e.g., just above the wheel wells), and the track itself can be configured to contain a bus attachment for sending signals to a stepper motor or other locomotion device running along the track. The entire track and folded arm may be concealed behind a trap door in a front or rear fender, and close tolerances for doors and other body parts are implemented so the track physically operates as if it were seamless, with additional bus connections utilized for electrical continuity.

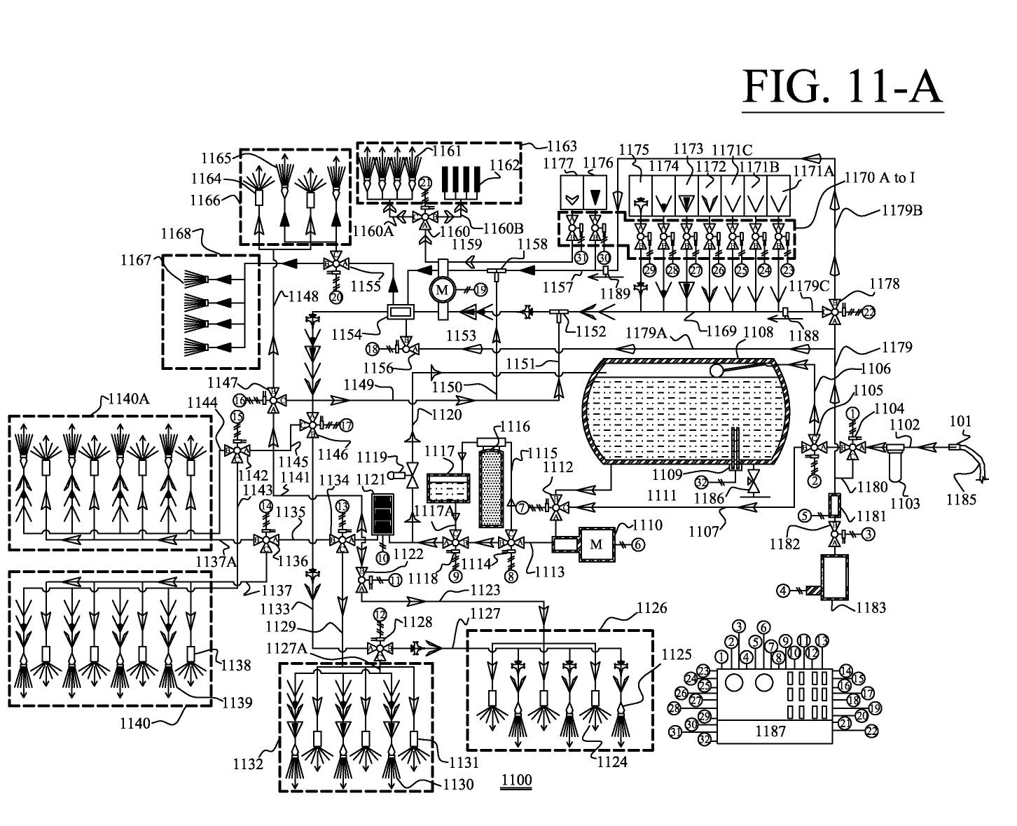

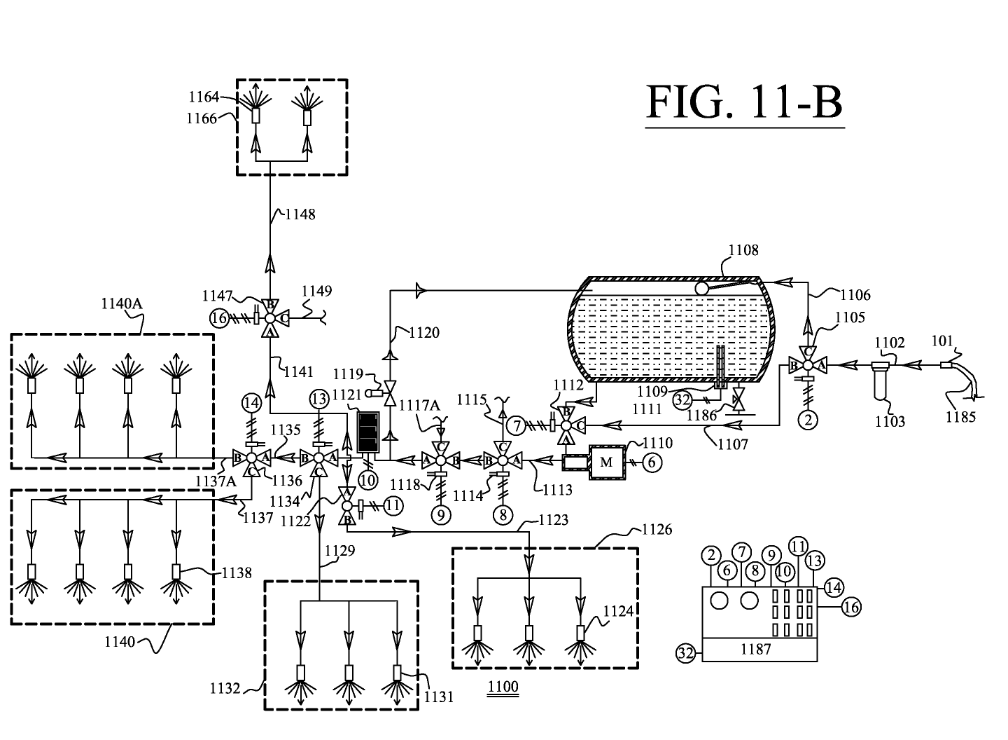

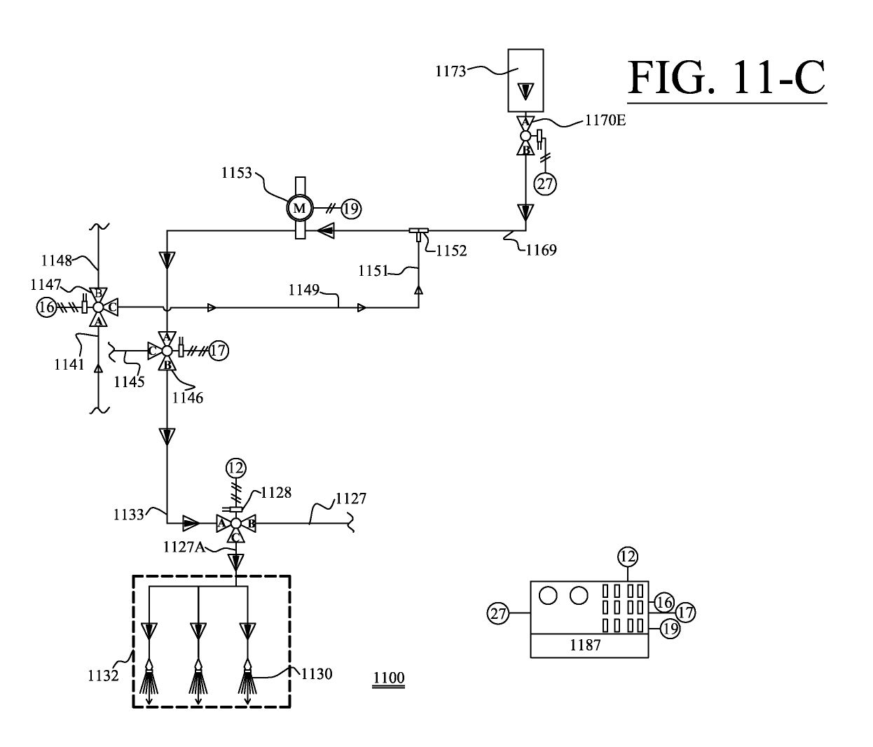

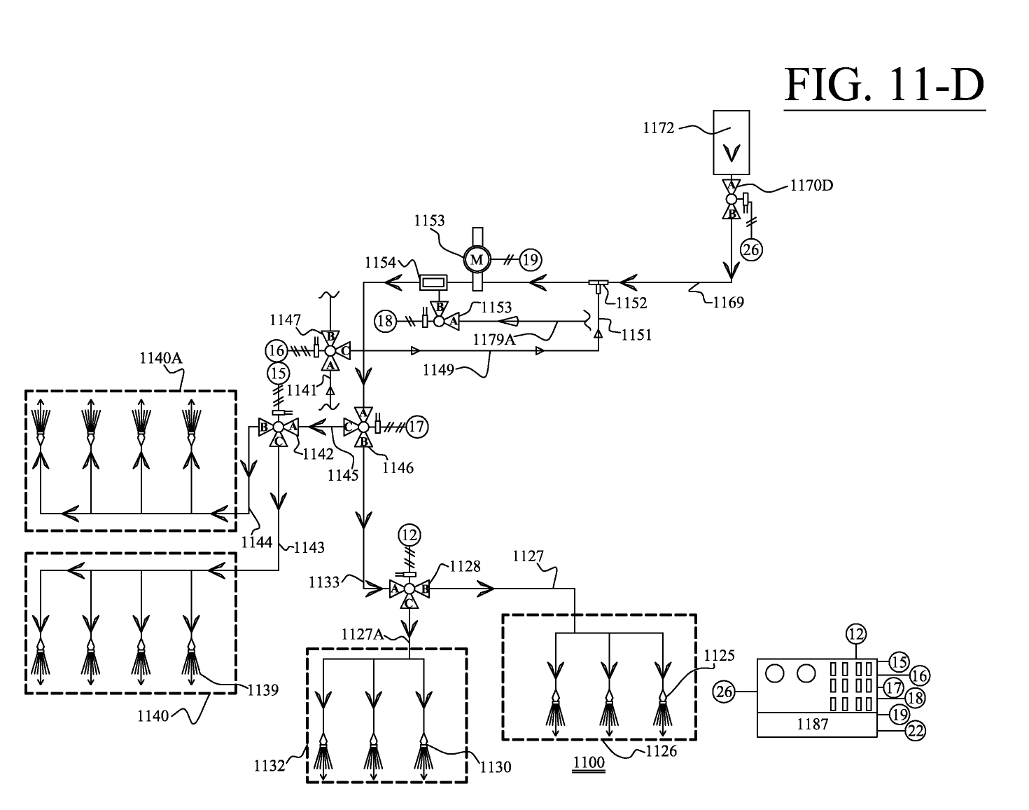

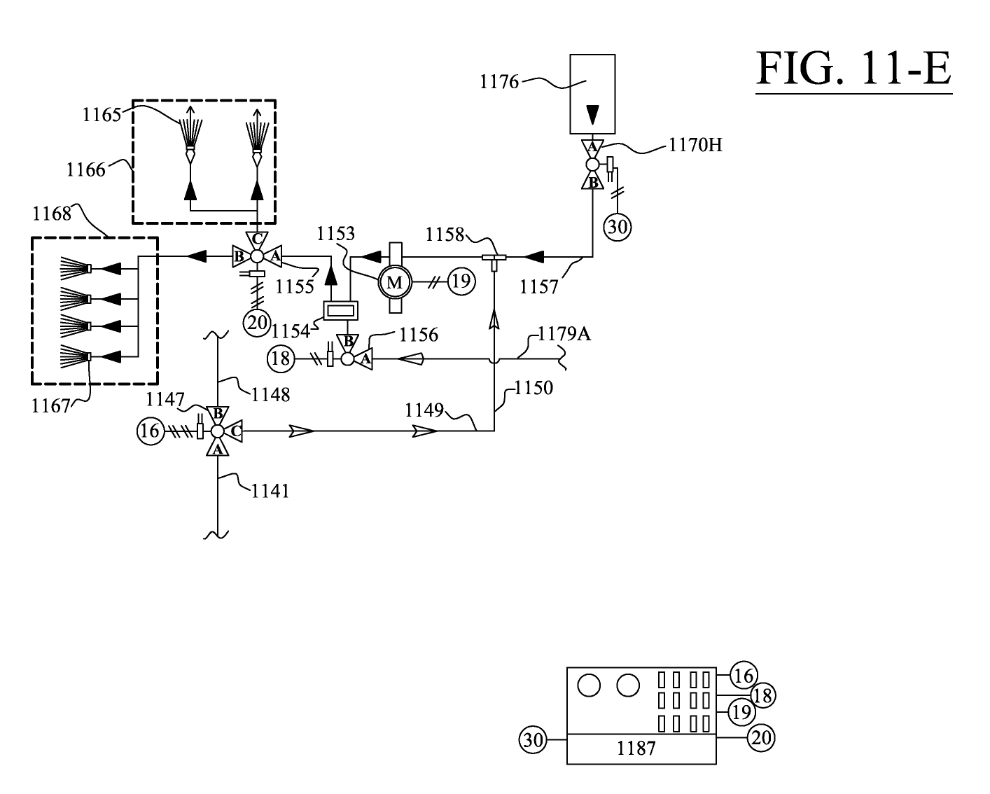

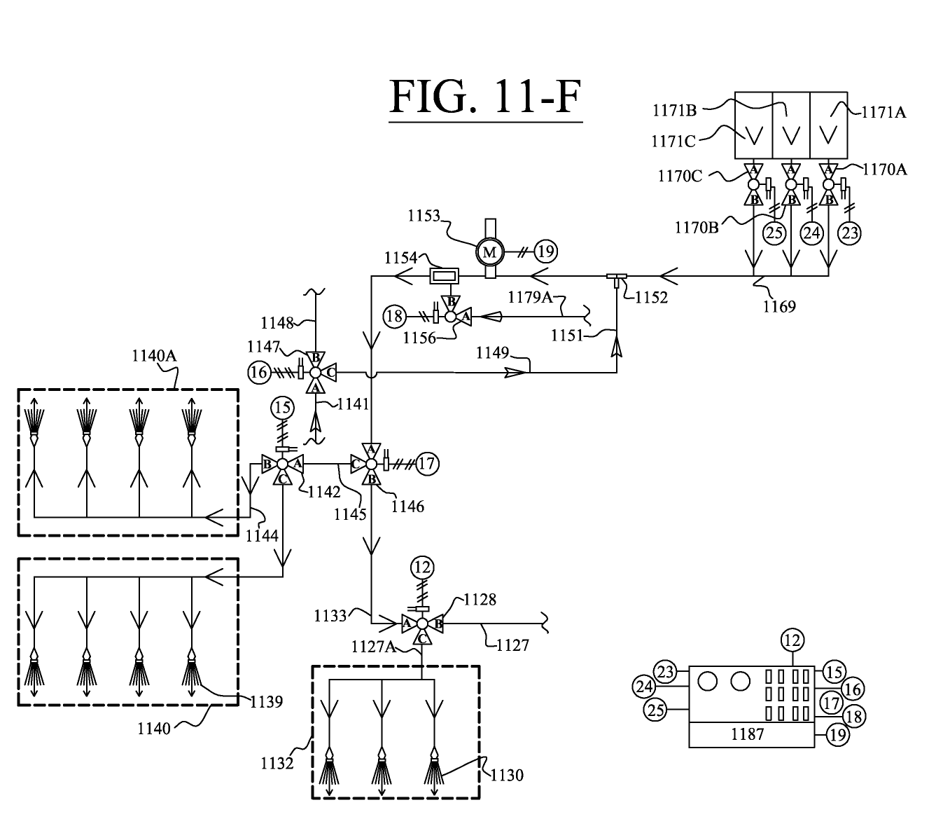

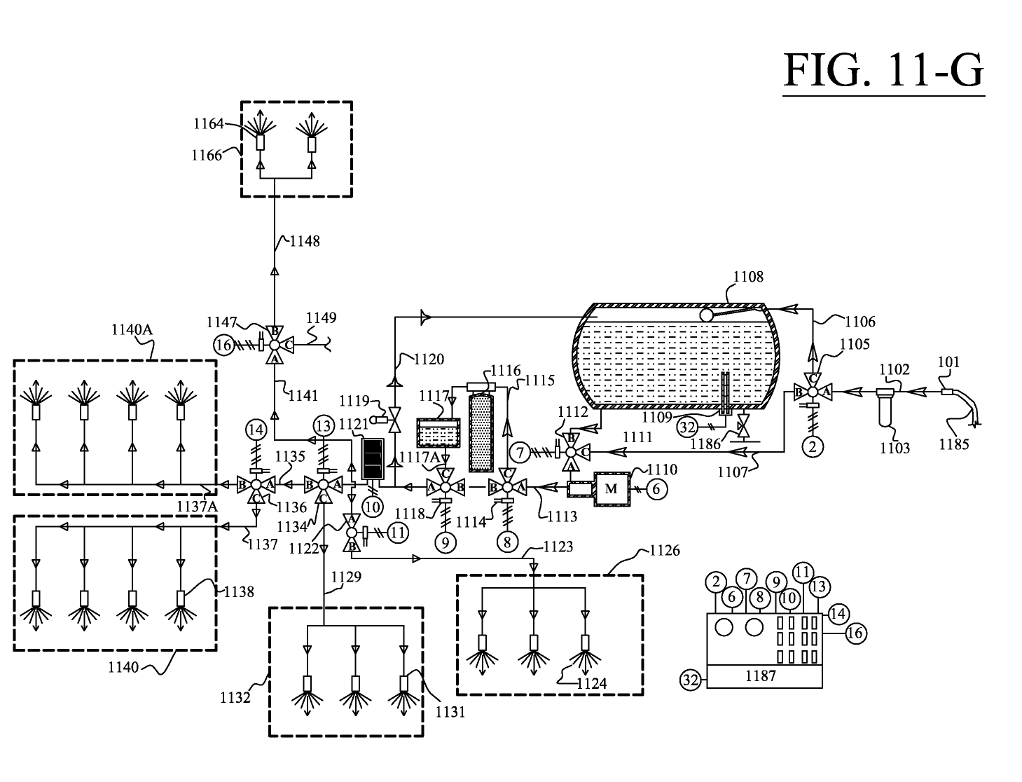

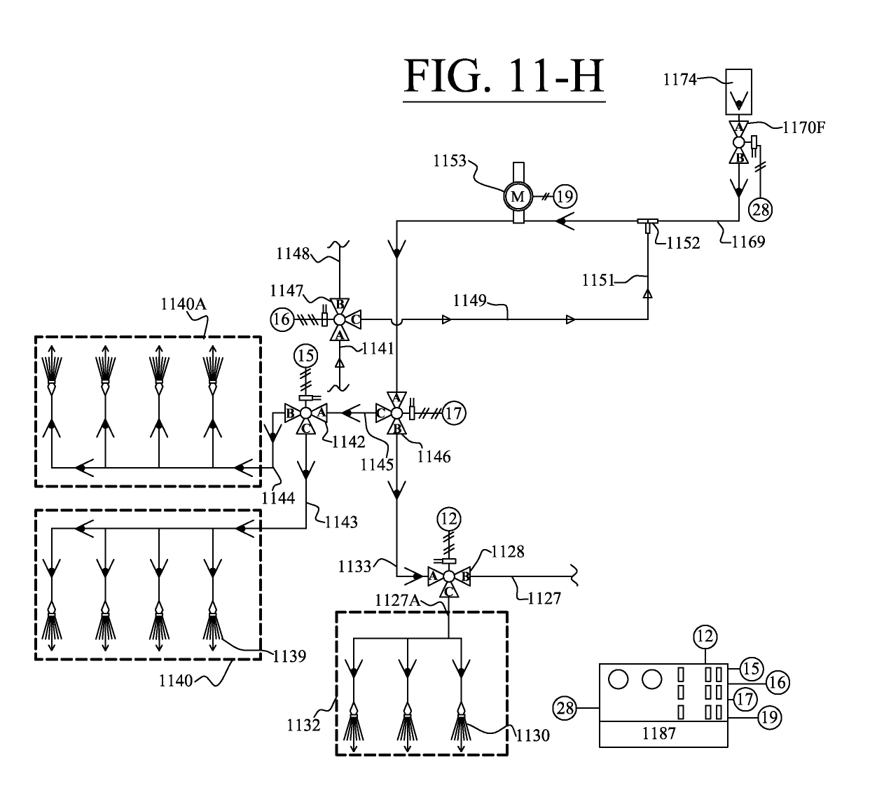

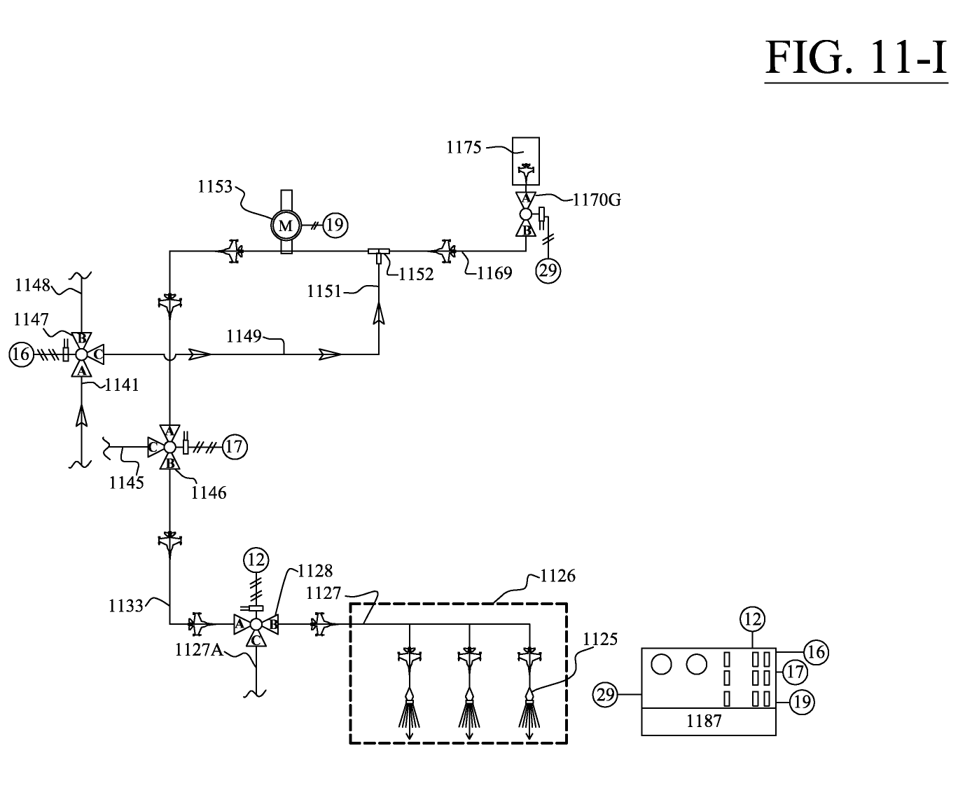

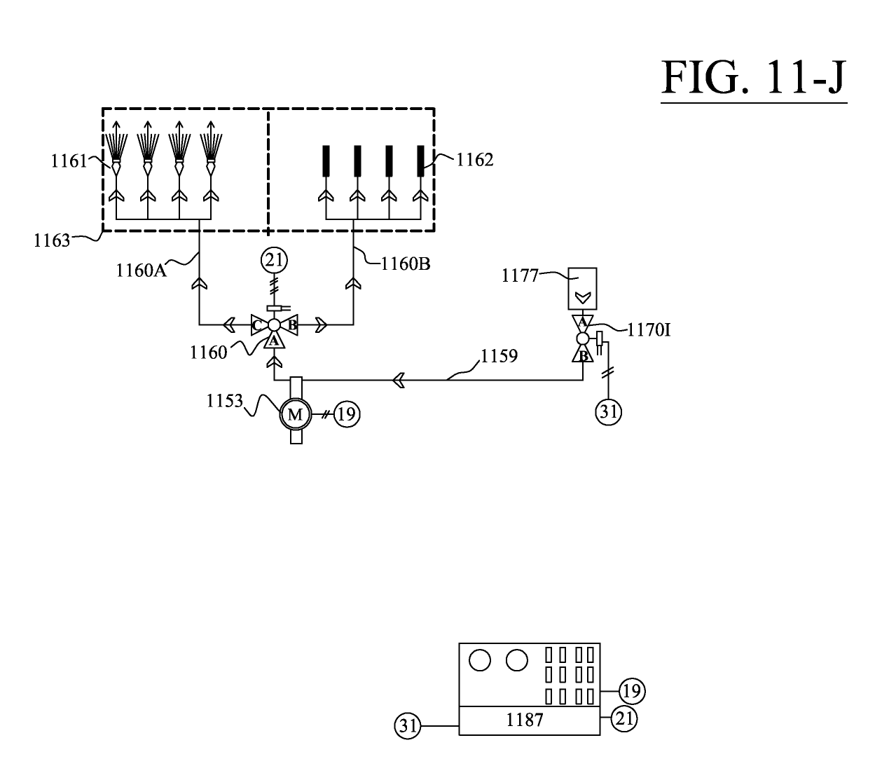

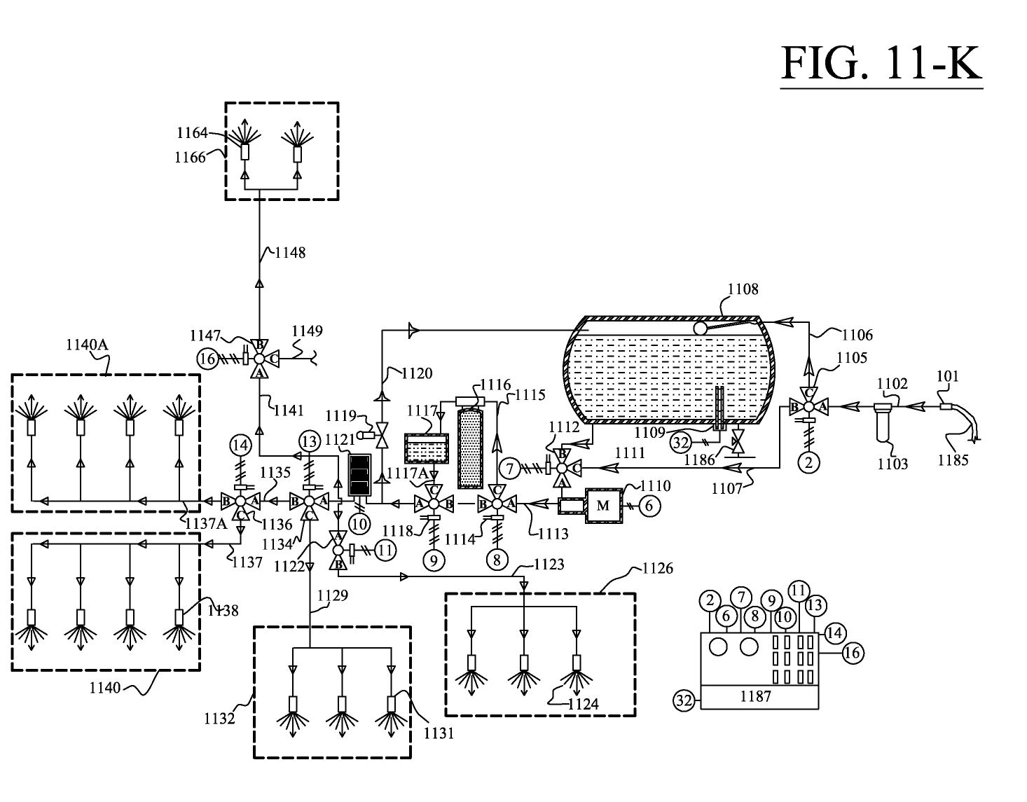

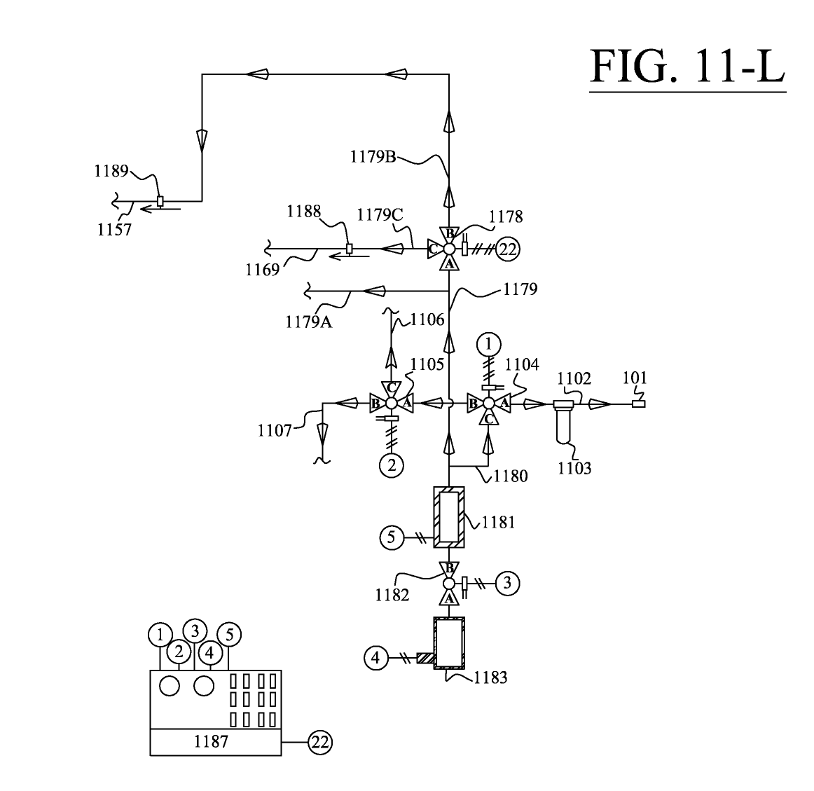

FIG. 11A is a diagram of a layout of an automated vehicle washing system according to an embodiment of the present invention. In FIG. 11A, a multiple nozzle system is illustrated. Many of the components in FIG. 11A are similar to the components described above in other embodiments, but are arranged in a more extensive, but effective, manner. The components illustrated in FIG. 11A are individually described in Table 2.

TABLE 2
FIG. 11A exemplary component identification

| | |
|---|---|
| 101 | Water inlet line coupling. |
| 1102 | Water line. |
| 1103 | Strainer, sediment filter, simple filter etc. |
| 1104 | Solenoid operated 3way valve for compressed air feed into water lines. |
| 1105 | Solenoid operated 3way valve for water distribution to water storage tank or to bypass |
| | water storage tank completely. |
| 1106 | Water supply line to water storage tank. |
| 1107 | Water supply line to water pump bypassing water storage tank completely. |
| 1108 | Water storage tank. |
| 1109 | Water storage tank heater. |
| 1110 | Water pump and motor combination. |
| 1111 | Water supply line from water storage tank. |
| 1112 | Solenoid operated 3way valve to supply water to entire system either from water |
| | storage tank or from external hook up source. |
| 1113 | Water supply line from water pump. |
| 1114 | Solenoid operated 3way valve to direct flow of water via the water filter/reverse |
| | osmosis filter/water softener or to bypass the filter altogether. |
| 1115 | Water supply line to water filter/softener/reverse osmosis filter. |
| 1116 | Water filter/softener/reverse osmosis filter or combination there off. |
| 1117 | Filtered/Softened water storage tank (optional). |
| 1117A | Filtered water line from filtered water storage tank to solenoid operated 3way valve. |
| 1118 | Solenoid operated 3way valve to supply either filtered water from water filter or from |
| | unfiltered water supply (depending on requirements of the current cycle). |
| 1119 | Pressure relief valve with integrated pressure sensor. |
| 1120 | Pressure released water recycle line back to water storage tank. |
| 1121 | Instantaneous hot water heater - heating via a heat exchanger slaved to hot engine |
| | exhaust gases or electrically operated to heat water in the range of 140° F. Also water |
| | may be heated via heat exchanger going through the engine block of engine coolant. |
| | Unit to have built in adjustable thermostat and thermal overload relay. |
| 1122 | Solenoid operated 2way valve to enable or disable water flow to bank of high pressure |
| | nozzles located at under side of the vehicle (i.e. Wheel wells, belly and under |
| | carriage). |
| 1123 | Water supply line to bank of nozzles located on the under side of the vehicle. |
| 1124 | High pressure water spray nozzles located on the under side of the vehicle. |
| 1125 | Medium to low pressure chemical spray nozzles (60 to 100 PSI pressure) located on |
| | the under side of the vehicle (nozzles to spray soap, under body protectants etc). |
| 1126 | Bank of high, medium to low pressure chemical and water spray nozzles located on |
| | under side of the vehicle. |
| 1127 | Chemical supply line to bank of chemical spray nozzles located on the underside of the |
| | vehicle. |
| 1127A | Chemical supply line to bank of chemical spray nozzles located at heavy duty cleaning |
| | areas (i.e. nose of vehicle, windshield, mirror housings, rocker panels and all vertical |
| | or near vertical surfaces. |
| 1128 | Solenoid operated 3 way valve to direct flow of cleaning and preserving chemicals to |
| | under side of vehicle as well to the areas requiring heavy duty cleaning (i.e. nose |
| | wind shield, mirror housing and rocker panels). |
| 1129 | Water supply line to spray nozzles located in the heavy duty cleaning areas of vehicle |
| | (i.e. vertical or near vertical surfaces in front of vehicle as well as to nose, |
| | windshield, mirror housings, rocker panels etc.). |
| 1130 | Medium to low pressure chemical spray nozzles (60 to 100 PSI pressure) located on |
| | the heavy duty cleaning areas (i.e. vertical or near vertical surfaces in front of vehicle |
| | as well as nose, windshield, mirror housings, rocker panels etc.). |
| 1131 | High pressure water spray nozzle for areas requiring heavy duty cleaning (500 to 1,500 |
| | PSI pressure). |
| 1132 | Bank of chemical & water spray nozzles for areas requiring heavy duty cleaning (i.e. |
| | vertical or near vertical surfaces in front of vehicle as well as to nose, windshield, |
| | mirror housings, rocker panels etc.). There are separate spray nozzles for water and |
| | chemical applications in this arrangement. In other arrangements same nozzles may |
| | be used. |
| 1133 | Chemical supply line for distribution of cleaning and preserving chemicals to under |
| | side of the vehicle as well as heavy duty cleaning areas. |
| 1134 | Solenoid operated 3 way valve to direct flow of water to various areas of vehicle. |
| 1135 | Water supply line to 3way solenoid operated valve supplying water to spray nozzles |
| | located on the left & right side of the vehicle. |
| 1136 | Solenoid operated 3 way valve to direct flow of water to high and medium pressure |
| | spray nozzles on the right side of vehicle. |
| 1137 | Water supply line or manifold to bank of spray nozzles on the right side of vehicle |
| | (Note: - left side identical). |
| 1137A | Water supply line or manifold to bank of spray nozzles on the left side of vehicle. |
| | (Note: - Right side identical). |
| 1138 | Medium to high pressure (500 to 1,500 PSI pressure) water spray nozzles located on |
| | the right side of vehicle (Note: - Left side identical). |
| 1139 | Medium to low pressure chemical spray nozzles (60-100 PSI pressure) located on the |
| | right side of vehicle. |
| 1140 | Bank of water & chemical spray nozzles located on right side of vehicle (Note: - Left |
| | side identical). |
| 1140A | Bank of water & chemical spray nozzles located on left side of vehicle (Note: - Right |
| | side identical). |
| 1141 | Water supply line to solenoid operated 3 way valve to supply water to spray nozzles in |
| | the engine compartment and to chemical and water mixing/proportioning device. |
| 1142 | Solenoid operated 3way valve to distribute chemicals to chemical spray nozzles |
| | located on the left and right side of vehicle. |
| 1143 | Chemical (cleaning & preserving fluids) supply line to nozzles located on the right side |
| | of vehicle. |
| 1144 | Chemical (cleaning & preserving fluids) supply line to nozzles located on the left side |
| | of vehicle. |
| 1145 | Chemical supply line between 2 way solenoid valves controlling supply of various |
| | chemicals to different parts of vehicle. |
| 1146 | Solenoid operated 3 way valve to distribute chemicals to chemicals spray nozzles |
| | located on the left & right side of vehicle as well as to under side of vehicle and to |
| | chemicals spray nozzles located on areas requiring heavy duty cleaning. |
| 1147 | Solenoid operated 3 way valve directing flow of water to engine compartment and to |
| | chemical proportioning/mixing devices. |
| 1148 | Water supply line to nozzles located in the engine compartment. |
| 1149 | Trunk line to supply water to proportioning/mixing devices for automatic mixing of |
| | water and chemical. |
| 1150 | Branch line to supply water to proportioning/mixing devices for automatic mixing of |
| | water and chemical. |
| 1151 | Branch line to supply water to proportioning/mixing devices for automatic mixing of |
| | water and chemical. |
| 1152 | Proportioning device/valve for automatic mixing of water and chemicals. |
| 1153 | Low pressure pump and motor combination unit to pump chemical at low pressure (60 |
| | to 100 PSI pressure). |
| 1154 | Foam generator for turning diluted chemical and water mixture into foam before |
| | application of chemicals to vehicle surface by introducing compress air into chamber |
| | containing chemical mixture. (Note: - this unit may be eliminated in the even self |
| | aspirating nozzles are used to turn chemicals into form just as chemical are sprayed |
| | onto vehicle surface). |
| 1155 | Solenoid operated 3way valve to direct flow of tire & engine cleaning chemical to |
| | engine compartment as well as dedicated or shared spray nozzles for each tire. |
| 1156 | Solenoid operated 2way valve to direct supply of compressed air from compressed air |
| | supply line into foam generator. |
| 1157 | Supply line for engine and tire cleaning chemicals. |
| 1158 | Automatic proportioning and mixing device to mix tire & engine shampoo chemicals |
| | with water. |
| 1159 | Supply line for tire dressing/preserving/shining chemical to spray nozzles or |
| | applicator roller/brushes/sponges etc. |
| 1160 | Solenoid operated 3 way valve to direct flow of tire shine chemical to either spray |
| | nozzles or to applicator sponges (Note: - Vehicle equipped with only one option, |
| | either spray on or foam/brush applicators may not have this solenoid valve) |
| 1160A | Branch line to supply tire shine chemical to spray nozzles. |
| 1160B | Branch line to supply tire shine chemicals to pop out applicator sponges/brushes. |
| 1161 | Low pressure (60 to 100 PSI pressure) chemical spray nozzles for each tire. |
| 1162 | Tire shine extendible applicator sponges. |
| 1163 | Group of spray nozzles and applicator sponges dedicated to applying tire shine |
| | chemicals. |
| 1164 | High pressure water spray nozzles located in the engine compartment of vehicle. |
| 1165 | Medium to low pressure chemical spray nozzles (60 to 100 PSI pressure) to spray |
| | engine shampoo in the engine compartment. |
| 1166 | Bank of chemical & water spray nozzles located in the engine compartment. |
| 1167 | Dedicated spray nozzles to apply tire shampoo chemical on each tire. |
| 1168 | Group of 4 dedicated tire shampoo spray nozzle. |
| 1169 | Supply line to transmit various cleaning and preserving chemicals to different parts of |
| | vehicle (Note: - Each chemical may have it's own dedicated line or a common line |
| | through which the respective chemical will be transmitted depending on the current |
| | cycle). |
| 1170 | A to I - Series of 9 solenoid operated 2 way valves attached to supply tanks to allow |
| | chemicals flow out of each tank and into transmission line. |
| 1171 | A to C - Triple color wax supply tank (each tank with different color). Depending on |
| | the design each tank may have hydrominder automatic mixing device (if item # 152 |
| | & 158 are not used to mix water and chemical) and eductors to mix liquids if settled |
| | in tank (optional). Triply wax may also be used undiluted. Triply waxes may be the |
| | type by turtle wax or the kind supplied by simonize or similar formulation by others. |
| 1172 | Presoak chemical tank (soap). |
| 1173 | Bug, road tar and tree sap cleaning chemical tank. |
| 1174 | Total body protectant chemical tank. |
| 1175 | Under body protectant - rust inhabiting chemical tank. |
| 1176 | Tank for tire & engine cleaning chemical. |
| 1177 | Tank for tire shine liquid - may be the type supplied by Armorall ™ or similar product |
| | or silicone based type supplied by Viper Shine ™. Silicone tire dressing and other |
| | types of tire dressing chemicals may be the type that are sprayed on or applied using a |
| | sponge or a brush. Tire shine/dressing chemical may be similar formulation to the |
| | above name brands. |
| 1178 | Solenoid operated 3 way valve to distribute compressed air through chemical lines to |
| | purge all lines of residual chemicals. |
| 1179 | Compressed air trunk supply line. |
| 1179A | Compressed air branch line to foam generator (Note: - Not needed in design if self |
| | aspirating nozzles are used to generate foam at time of discharge of chemical from |
| | spray nozzles onto surface of vehicle. |
| 1179B | Compressed air supply line to chemical lines hook up to be used to purge chemical |
| | lines of residual chemicals. |
| 1179C | Compressed air supply line to chemical lines hook up to be used to purge chemical |
| | lines of off residual chemicals. |
| 1180 | Compressed air branch lines to solenoid vale. |
| 1181 | Compressed air heater. |
| 1182 | Solenoid operated 2 way valve to control compressed air feed from air compressor |
| | tank into distribution lines. |
| 1183 | Air compressor motor and storage tank unit. |
| 1185 | External water supply hook up via an ordinary garden hose with quick disconnect |
| | coupling or equal. |
| 1186 | Water storage tank drain valve. |
| 1187 | Controller (mechanical or electronic). |
| 1188 | One way valve/coupling to connect chemical lines with compress air line thus |
| | allowing compressed air to flow into chemical lines. Chemical flow into air lines will |
| | be restricted as the coupling/valve combo allows flow into only one direction. |
| 1189 | One way valve/coupling to connect chemical lines with compress air line thus |
| | allowing compressed air to flow into chemical lines. Chemical flow into air lines will |
| | be restricted as the coupling/valve combo allows flow into only one direction. |

Various components of FIG. 11A and identified in Table 2 work together in forming subsystems. The system of FIG. 11A includes subsystems for each of a 1^{st} rinse cycle, bug chemical cycle, soap cycle, tire and engine shampoo cycle, triple wax cycle, reverse osmosis water rinse (spot free rinse) cycle, total body protectant cycle, underbody protectant cycle, tire shine cycle, RO rinse cycle, an air drying and line purging cycle, and a de-icing cycle. Any particular system implemented in a vehicle may take advantage of any one or more of the illustrated cycles. Modifications can be readily implemented after review of and/or based on the present disclosure to implement variations of any of the above that do not significantly depart from the spirit and intended scope of the invention, but it is not possible to list all possible variations that do not significantly impact the structure or functionality of the subsystems or overall operation of the invention as described herein.

FIG. 11B is a diagram of a layout of components in an exemplary 1^{st} rinse cycle according to an embodiment of the present invention. The components illustrated in FIG. 11B are arranged to provide lines and nozzles suited to rinse the vehicle upon command from the controller (e.g., commands sent from the controller to activate valves allocating rinse fluids and pressurizing the system according to the rinse cycle). The components illustrated in FIG. 11B are individually described in Table 3A.

TABLE 3A
Exemplary Rinse Cycle Components (identification of exemplary components in FIG. 11B)

| | |
|---|---|
| 101 | Water inlet line coupling. |
| 1102 | Water line. |
| 1103 | Strainer, sediment filter, simple filter etc. |
| 1105 | Solenoid operated 3way valve for water distribution to water storage tank or to bypass |
| | water storage tank completely. |
| 1106 | Water supply line to water storage tank. |
| 1107 | Water supply line to water pump bypassing water storage tank completely. |
| 1108 | Water storage tank. |
| 1109 | Water storage tank heater. |
| 1110 | Water pump and motor combination. |
| 1111 | Water supply line from water storage tank. |
| 1112 | Solenoid operated 3way valve to supply water to entire system either from water |
| | storage tank or from external hook up source. |
| 1113 | Water supply line from water pump. |
| 1114 | Solenoid operated 3 way valve to direct flow of water via the water filter/reverse |
| | osmosis filter/water softener or to bypass the filter altogether. |
| 1115 | Water supply line to water filter/softener/reverse osmosis filter. |
| 1117A | Filtered water line from filtered water storage tank to solenoid operated 3way valve. |
| 1118 | Solenoid operated 3way valve to supply either filtered water from water filter or from |
| | unfiltered water supply (depending on requirements of the current cycle). |
| 1119 | Pressure relief valve with integrated pressure sensor. |
| 1120 | Pressure released water recycle line back to water storage tank. |
| 1121 | Instantaneous hot water heater - heating via a heat exchanger slaved to hot engine |
| | exhaust gases or electrically operated to heat water in the range of 140° F. Also water |
| | may be heated via heat exchanger going through the engine block of engine coolant. |
| | Unit to have built in adjustable thermostat and thermal overload relay. |
| 1122 | Solenoid operated 2way valve to enable or disable water flow to bank of high pressure |
| | nozzles located at under side of the vehicle (i.e. Wheel wells, belly and under |
| | carriage). |
| 1123 | Water supply line to bank of nozzles located on the under side of the vehicle. |
| 1124 | High pressure water spray nozzles located on the under side of the vehicle. |
| 1126 | Bank of high, medium to low pressure chemical (Not used in this cycle, not shown) |
| | and water spray nozzles located on under side of the vehicle. |
| 1129 | Water supply line to spray nozzles located in the heavy duty cleaning areas of vehicle |
| | (i.e. vertical or near vertical surfaces in front of vehicle as well as to nose, |
| | windshield, mirror housings, rocker panels etc.). |
| 1131 | High pressure water spray nozzle for areas requiring heavy duty cleaning (500 to 1,500 |
| | PSI pressure). |
| 1132 | Bank of chemical (Not used in this cycle, not shown) & water spray nozzles for areas |
| | requiring heavy duty cleaning (i.e. vertical or near vertical surfaces in front of vehicle |
| | as well as to nose, windshield, mirror housings, rocker panels etc.). There are |
| | separate spray nozzles for water and chemical applications in this arrangement, |
| | however, same nozzles may be used. |
| 1134 | Solenoid operated 3way valve to direct flow of water to various areas of vehicle. |
| 1135 | Water supply line to 3way solenoid operated valve supplying water to spray nozzles |
| | located on the left & right side of the vehicle. |
| 1136 | Solenoid operated 3way valve to direct flow of water to high and medium pressure |
| | spray nozzles on the right side of vehicle. |
| 1137 | Water supply line or manifold to bank of spray nozzles on the right side of vehicle. |
| | (Note: - Left side identical). |
| 1137A | Water supply line or manifold to bank of spray nozzles on the left side of vehicle. |
| | (Note: - Right side identical). |
| 1138 | Medium to high pressure (500 to 1,500 PSI pressure) water spray nozzles located on |
| | the right side of vehicle (Note: - Left side identical). |
| 1140 | Bank of water & chemical spray nozzles (Not used in this cycle, not shown) for right |
| | side of vehicle (Note: - Left side identical). |
| 1140A | Bank of water & chemical spray nozzles (Not used in this cycle, not shown) for left |
| | side of vehicle (Note: - Right side identical). |
| 1141 | Water supply line to solenoid operated 3 way valve to supply water to spray nozzles in |
| | the engine compartment and to chemical and water mixing/proportioning device. |
| 1147 | Solenoid operated 3 way valve directing flow of water to engine compartment and to |
| | chemical proportioning/mixing devices. |
| 1148 | Water supply line to nozzles located in the engine compartment. |
| 1149 | Trunk line to supply water to proportioning/mixing devices for automatic mixing of |
| | water and chemical. |
| 1164 | High pressure water spray nozzles located in the engine compartment of vehicle. |
| 1166 | Bank of chemical (Not used in this cycle, not shown) & water spray nozzles located in |
| | the engine compartment. |
| 1185 | External water supply hook up via an ordinary garden hose with quick disconnect |
| | coupling or equal. |
| 1187 | Controller (mechanical or electronic). |

The various controlled components (e.g., valves, etc.) identified in FIG. 11B and as further described in the corresponding table are set according to programming of the controller or other control mechanism (e.g., electronics, such as a Field Programmable Gate Array, computer device, controller, etc.). The controlled components are set, for example, for a first rinse cycle with water from an external source, as described in Table 3B.

TABLE 3B

| Equip | Equipment | Used | Power | Port | Port | Port | Equip |
|---|---|---|---|---|---|---|---|
| # | Type | For | Status | A | B | C | Status |
| 1 | 3Way Valve | Air/Water | | Open | Open | Closed | |
| 2 | 3Way Valve | Water | | Open | Open | Closed | |
| 3 | 2Way Valve | Air | | Open | Closed | * | X |
| 4 | Pressurizer | Pump | ON | | | | |
| 5 | Air Heater | Heater | OFF | | | | X |
| 6 | Pump Motor | Pumping | ON | | | | |
| 7 | Water | Water | | Open | Closed | Open | |
| 8 | Water | Water | | Open | Open | Closed | |
| 9 | Water | Water | | Open | Open | Closed | |
| 10 | Water heater | Heater | ON | * | * | * | |
| 11 | 2Way Valve | Water | | Open | Open | * | |
| 12 | 3Way Valve | Chemical | | Open | Closed | Closed | X |
| 13 | 3Way Valve | Water | | Open | Open | Open | |
| 14 | 3Way Valve | Water | | Open | Open | Open | |
| 15 | 3Way Valve | Chemical | | Open | Closed | Closed | X |
| 16 | 3Way Valve | Water | | Open | Open | Closed | |
| 17 | 3Way Valve | Chemical | | Open | Closed | Closed | X |
| 18 | 2Way Valve | Air | | Open | Closed | * | X |
| 19 | Pump motor | Pumping | OFF | * | * | * | X |
| 20 | 3Way Valve | Chemical | | Open | Closed | Closed | X |
| 21 | 3Way Valve | Chemical | | Open | Closed | Closed | X |
| 22 | 3Way Valve | Air | | Open | Closed | Closed | X |
| 23 | 2Way Valve | Chemical | | Open | Closed | * | X |
| 24 | 2Way Valve | Chemical | | Open | Closed | * | X |
| 25 | 2Way Valve | Chemical | | Open | Closed | * | X |
| 26 | 2Way Valve | Chemical | | Open | Closed | * | X |
| 27 | 2Way Valve | Chemical | | Open | Closed | * | X |
| 28 | 2Way Valve | Chemical | | Open | Closed | * | X |
| 29 | 2Way Valve | Chemical | | Open | Closed | * | X |
| 30 | 2Way Valve | Chemical | | Open | Closed | * | X |
| 31 | 2Way Valve | Chemical | | Open | Closed | * | X |
| 32 | Tank Heater | Heater | OFF | * | * | * | X |

FIG. 11C is a diagram of a layout of components in an exemplary bug, tar, and tree sap chemical cleaning cycle according to an embodiment of the present invention. The components illustrated in FIG. 11C are arranged to provide lines and nozzles suited to a bug chemical wash cycle upon command from the controller (e.g., commands sent from the controller to activate valves allocating rinse fluids and pressurizing the system according to the bug chemical cycle). The bug chemical cycle is, for example, preferably applied to leading edges of the vehicle particularly near headlamps and other areas prone to impacts with insects, road tar, and/or tree sap during vehicle operation. The components illustrated in FIG. 11C are individually described in Table 4A.

TABLE 4A
Exemplary Rinse Cycle Components

| | |
|---|---|
| 1127 | Chemical supply line to bank of chemical spray nozzles located on the underside of |
| | the vehicle. |
| 1127A | Chemical supply line to bank of chemical spray nozzles located at heavy duty |
| | cleaning areas (i.e. nose of vehicle, windshield, mirror housings, rocker panels |
| | and all vertical or near vertical surfaces. |
| 1128 | Solenoid operated 3 way valve to direct flow of cleaning and preserving chemicals |
| | to under side of vehicle as well to the areas requiring heavy duty cleaning (i.e. |
| | nose wind shield, mirror housing and rocker panels). |
| 1130 | Medium to low pressure chemical spray nozzles (60 to 100 PSI pressure) located |
| | on the heavy duty cleaning areas (i.e. vertical or near vertical surfaces in front of |
| | vehicle as well as nose, windshield, mirror housings, rocker panels etc.). |
| 1132 | Bank of chemical & water spray nozzles (Not used in this cycle, not shown) for |
| | areas requiring heavy duty cleaning (i.e. vertical or near vertical surfaces in front |
| | of vehicle as well as to nose, windshield, mirror housings, rocker panels etc.). |
| | There are separate spray nozzles for water and chemical applications. |
| 1133 | Chemical supply line for distribution of cleaning and preserving chemicals to under |
| | side of the vehicle as well as heavy duty cleaning areas. |
| 1141 | Water supply line to solenoid operated 3 way valve to supply water to spray |
| | nozzles in the engine compartment and to chemical and water mixing/ |
| | proportioning device. |
| 1145 | Chemical supply line between 2 way solenoid valves controlling supply of various |
| | chemicals to different parts of vehicle. |
| 1146 | Solenoid operated 3 way valve to distribute chemicals to chemicals spray nozzles |
| | located on the left & right side of vehicle as well as to under side of vehicle and to |
| | chemicals spray nozzles located on areas requiring heavy duty cleaning. |
| 1147 | Solenoid operated 3 way valve directing flow of water to engine compartment and |
| | to chemical proportioning/mixing devices. |
| 1148 | Water supply line to nozzles located in the engine compartment. |
| 1149 | Trunk line to supply water to proportioning/mixing devices for automatic mixing |
| | of water and chemical. |
| 1151 | Branch line to supply water to proportioning/mixing devices for automatic mixing |
| | of water and chemical. |
| 1152 | Proportioning device/valve for automatic mixing of water and chemicals. |
| 1153. | Low pressure pump and motor combination unit to pump chemical at low pressure |
| | (60 to 100 PSI pressure). |
| 1169 | Supply line to transmit various cleaning and preserving chemicals to different parts |
| | the vehicle. (Note:- Each chemical may have it's own dedicated line or a common |
| | line through which the respective chemical will be transmitted depending on the |
| | current cycle). In this cycle bug cleaning chemical is being transmitted to vehicle |
| | surface through spray nozzles. |
| 1170E | Solenoid operated 2 way valve to allow bug cleaning chemical to flow from storage |
| | tank into line transmitting the same to vehicle surface via spray nozzles. |
| 1173 | Bug, road tar and tree sap cleaning chemical tank. |
| 1187 | Controller (mechanical or electronic). |

The various controlled components (e.g., valves, etc.) identified in FIG. 11C and as further described in the corresponding table are set according to programming of the controller or other control mechanism (e.g., electronics, such as a Field Programmable Gate Array, computer device, controller, etc.). The controlled components are set, for example, for a bug cleaning cycle with water from an external source, as described in Table 4B.

TABLE 4B

| | Equipment | Used | Power | | | | Equip |
|---|---|---|---|---|---|---|---|
| Equip # | Type | For | Status | Port A | Port B | Port C | Status |
| 1 | 3 Way Valve | Air/Water | | Open | Closed | Closed | X |
| 2 | 3 Way Valve | Water | | Open | Open | Closed | |
| 3 | 2 Way Valve | Air | | Open | Closed | * | X |
| 4 | Pressurizer | Pump | ON | | | | |
| 5 | Air Heater | Heater | OFF | | | | X |
| 6 | Pump Motor | Pumping | ON | | | | |
| 7 | Water | Water | | Open | Closed | Open | |
| 8 | Water | Water | | Open | Closed | Open | |
| 9 | Water | Water | | Open | Closed | Open | |
| 10 | Water heater | Heater | ON | | | | |
| 11 | 2 Way Valve | Water | | Open | Closed | * | X |
| 12 | 3 Way Valve | Chemical | | Open | Closed | Open | |
| 13 | 3 Way Valve | Water | | Open | Closed | Open | |
| 14 | 3 Way Valve | Water | | Open | Closed | Closed | X |
| 15 | 3 Way Valve | Chemical | | Open | Closed | Closed | X |
| 16 | 3 Way Valve | Water | | Open | Closed | Open | |
| 17 | 3 Way Valve | Chemical | | Open | Open | Closed | |
| 18 | 2 Way Valve | Air | | Open | Closed | * | X |
| 19 | Pump motor | Pumping | ON | | | | |
| 20 | 3 Way Valve | Chemical | | Open | Closed | Closed | X |
| 21 | 3 Way Valve | Chemical | | Open | Closed | Closed | X |
| 22 | 3 Way Valve | Air | | Open | Closed | Closed | X |
| 23 | 2 Way Valve | Chemical | | Open | Closed | * | X |
| 24 | 2 Way Valve | Chemical | | Open | Closed | * | X |
| 25 | 2 Way Valve | Chemical | | Open | Closed | * | X |
| 26 | 2 Way Valve | Chemical | | Open | Closed | * | X |
| 27 | 2 Way Valve | Chemical | | Open | Open | * | |
| 28 | 2 Way Valve | Chemical | | Open | Closed | * | X |
| 29 | 2 Way Valve | Chemical | | Open | Closed | * | X |
| 30 | 2 Way Valve | Chemical | | Open | Closed | * | X |
| 31 | 2 Way Valve | Chemical | | Open | Closed | * | X |
| 32 | Tank heater | Heater | OFF | * | * | * | X |

FIG. 11D is a diagram of a layout of components in an exemplary soap cycle according to an embodiment of the present invention. The components illustrated in FIG. 11D are arranged to provide lines and nozzles suited to a soap cycle upon command from the controller (e.g., commands sent from the controller to activate valves allocating soaping fluids and pressurizing the system according to the soap cycle). The soap cycle is, for example, preferably applied to exterior painted and glass body surfaces and others. The components illustrated in FIG. 11D are individually described in Table 5A.

TABLE 5A
Exemplary Soap Cycle Components

| | |
|---|---|
| 1125 | Medium to low pressure chemical spray nozzles (60 to 100 PSI pressure) located on |
| | the under side of the vehicle (nozzles to spray soap, under body protectants etc). |
| 1126 | Bank of high, medium to low pressure chemical and water (Not used in this cycle, not |
| | shown) spray nozzles located on under side of the vehicle. |
| 1127 | Chemical supply line to bank of chemical spray nozzles located on the underside of the |
| | vehicle. |
| 1127A | Chemical supply line to bank of chemical spray nozzles located at heavy duty cleaning |
| | areas (i.e. nose of vehicle, windshield, mirror housings, rocker panels and all vertical |
| | or near vertical surfaces. |
| 1128 | Solenoid operated 3 way valve to direct flow of cleaning and preserving chemicals to |
| | under side of vehicle as well to the areas requiring heavy duty cleaning (i.e. nose |
| | wind shield, mirror housing and rocker panels). |
| 1130 | Medium to low pressure chemical spray nozzles (60 to 100 PSI pressure) located on |
| | the heavy duty cleaning areas (i.e. vertical or near vertical surfaces in front of vehicle |
| | as well as nose, windshield, mirror housings, rocker panels etc.). |
| 1132 | Bank of chemical & water spray nozzles (not shown) for areas requiring heavy duty |
| | cleaning (i.e. vertical or near vertical surfaces in front of vehicle as well as to nose, |
| | windshield, mirror housings, rocker panels etc.). There are separate spray nozzles for |
| | water and chemical applications in this arrangement. In other arrangements same |
| | nozzles may be used. |
| 1133 | Chemical supply line for distribution of cleaning and preserving chemicals to under |
| | side of the vehicle as well as heavy duty cleaning areas. |
| 1139 | Medium to low pressure chemical spray nozzles (60100 PSI pressure) located on the |
| | right side of vehicle. |
| 1140 | Bank of water (Not used in this cycle, not shown) & chemical spray nozzles for right |
| | side of vehicle (Note:- Left side identical). |
| 1140A | Bank of water (Not used in this cycle, not shown) & chemical spray nozzles located on |
| | left side of vehicle (Note:- Right side identical). |
| 1141 | Water supply line to solenoid operated 3 way valve to supply water to spray nozzles in |
| | the engine compartment and to chemical and water mixing/proportioning device. |
| 1142 | Solenoid operated 3 way valve to distribute chemicals to chemical spray nozzles |
| | located on the left and right side of vehicle. |
| 1143 | Chemical (cleaning & preserving fluids) supply line to nozzles located on the right side |
| | of vehicle. |
| 1144 | Chemical (cleaning & preserving fluids) supply line to nozzles located on the left side |
| | of vehicle. |
| 1146 | Solenoid operated 3 way valve to distribute chemicals to chemicals spray nozzles |
| | located on the left & right side of vehicle as well as to under side of vehicle and to |
| | chemicals spray nozzles located on areas requiring heavy duty cleaning. |
| 1147 | Solenoid operated 3 way valve directing flow of water to engine compartment and to |
| | chemical proportioning/mixing devices. |
| 1149 | Trunk line to supply water to proportioning/mixing devices for automatic mixing of |
| | water and chemical. |
| 1151 | Branch line to supply water to proportioning/mixing devices for automatic mixing of |
| | water and chemical. |
| 1152 | Proportioning device/valve for automatic mixing of water and chemicals. |
| 1153 | Low pressure pump and motor combination unit to pump chemical at low pressure (60 |
| | to 100 PSI pressure). |
| 1154 | Foam generator for turning diluted chemical and water mixture into foam before |
| | application of chemicals to vehicle surface by introducing compress air into chamber |
| | containing chemical mixture. (Note: This unit may be eliminated in the even self |
| | aspirating nozzles are used to turn chemicals into foam just as the chemical is sprayed |
| | onto vehicle surface). |
| 1156 | Solenoid operated 2 way valve to direct supply of compressed air from compressed air |
| | supply line into foam generator. |
| 1170D | Solenoid operated 2 way valves attached to supply tank of pre-soak solution (soap) to |
| | allow soap to flow from storage tank into line transmitting the same to vehicle surface |
| | through spray nozzles. |
| 1172 | Presoak chemical tank (soap). |
| 1179A | Compressed air branch line to foam generator (Note:- Not needed in design if self |
| | aspirating nozzles are used to generate foam at time of discharge of chemical from |
| | spray nozzles onto surface of vehicle. |
| 1187 | Controller (mechanical or electronic). |

The various controlled components (e.g., valves) identified in FIG. 11D and as further described in the corresponding table are set according to programming of the controller or other control mechanism (e.g., electronics, such as a Field Programmable Gate Array, computer device, controller, etc.). The controlled components are set, for example as described in Table 5B.

TABLE 5B

| Equip | Equipment | Used | Power | Port | Port | Port | Equip |
|---|---|---|---|---|---|---|---|
| # | Type | For | Status | A | B | C | Status |
| 1 | 3Way Valve | Air/Water | | Open | Open | Closed | |
| 2 | 3Way Valve | Water | | Open | Open | Closed | |
| 3 | 2Way Valve | Air | | Open | Open | * | |
| 4 | Pressurizer | Pump | ON | | | | |
| 5 | Air Heater | Heater | ON | | | | |
| 6 | Pump Motor | Pumping | ON | | | | |
| 7 | Water | Water | | Open | Closed | Open | |
| 8 | Water | Water | | Open | Closed | Open | |
| 9 | Water | Water | | Open | Closed | Open | |
| 10 | Water heater | Heater | ON | | | | |
| 11 | 2Way Valve | Water | | Open | Closed | * | X |
| 12 | 3Way Valve | Chemical | | Open | Open | Open | |
| 13 | 3Way Valve | Water | | Open | Closed | Closed | X |
| 14 | 3Way Valve | Water | | Open | Closed | Closed | X |
| 15 | 3Way Valve | Chemical | | Open | Open | Open | |
| 16 | 3Way Valve | Water | | Open | Closed | Open | |
| 17 | 3Way Valve | Chemical | | Open | Open | Open | |
| 18 | 2Way Valve | Air | | Open | Open | * | |
| 19 | Pump motor | Pumping | ON | | | | |
| 20 | 3Way Valve | Chemical | | Open | Closed | Closed | X |
| 21 | 3Way Valve | Chemical | | Open | Closed | Closed | X |
| 22 | 3Way Valve | Air | | Open | Closed | Closed | X |
| 23 | 2Way Valve | Chemical | | Open | Closed | * | X |
| 24 | 2Way Valve | Chemical | | Open | Closed | * | X |
| 25 | 2Way Valve | Chemical | | Open | Closed | * | X |
| 26 | 2Way Valve | Chemical | | Open | Open | * | |
| 27 | 2Way Valve | Chemical | | Open | Closed | * | X |
| 28 | 2Way Valve | Chemical | | Open | Closed | * | X |
| 29 | 2Way Valve | Chemical | | Open | Closed | * | X |
| 30 | 2Way Valve | Chemical | | Open | Closed | * | X |
| 31 | 2Way Valve | Chemical | | Open | Closed | * | X |
| 32 | Tank heater | Heater | OFF | | | | X |

FIG. 11E is a diagram of a layout of components in an exemplary tire and engine shampoo cycle according to an embodiment of the present invention. The components illustrated in FIG. 11E are arranged to provide lines and nozzles suited to a tire and engine shampoo cycle upon command from the controller (e.g., commands sent from the controller to activate valves allocating tire and engine shampoo fluids and pressurizing the system according to the tire and engine shampoo cycle). The tire and engine shampoo cycle is, for example, preferably applied to all tires and wheels (e.g., any of nozzles, brushes, etc.), and to an engine/engine compartment of the vehicle. The components illustrated in FIG. 11E are individually described in Table 6A.

TABLE 6A
Exemplary Tire and Engine Shampoo Cycle Components

| | |
|---|---|
| 1141 | Water supply line to solenoid operated 3 way valve to supply water to spray nozzles in |
| | the engine compartment and to chemical and water mixing/proportioning device. |
| 1147 | Solenoid operated 3 way valve directing flow of water to engine compartment and to |
| | chemical proportioning/mixing devices. |
| 1148 | Water supply line to nozzles located in the engine compartment. |
| 1149 | Trunk line to supply water to proportioning/mixing devices for automatic mixing of |
| | water and chemical. |
| 1150 | Branch line to supply water to proportioning/mixing devices for automatic mixing of |
| | water and chemical. |
| 1153 | Low pressure pump and motor combination unit to pump chemical at low pressure (60 |
| | to 100 PSI pressure). |
| 1154 | Foam generator for turning diluted chemical and water mixture into foam before |
| | application of chemicals to vehicle surface by introducing compress air into chamber |
| | containing chemical mixture. (Note:- this unit may be eliminated in the even self |
| | aspirating nozzles are used to turn chemicals into form just as chemical are sprayed |
| | onto vehicle surface). |
| 1155 | Solenoid operated 3 way valve to direct flow of tire & engine cleaning chemical to |
| | engine compartment as well as dedicated spray nozzles for each tire. |
| 1156 | Solenoid operated 2 way valve to direct supply of compressed air from compressed air |
| | supply line into foam generator. |
| 1157 | Supply line for engine and tire cleaning chemicals. |
| 1158 | Automatic proportioning and mixing device to mix tire & engine shampoo chemicals |
| | with water. |
| 1165 | Medium to low pressure chemical spray nozzles (60 to 100 PSI pressure) to spray |
| | engine shampoo in the engine compartment. |
| 1166 | Bank of chemical & water spray nozzles located in the engine compartment. |
| 1167 | Dedicated spray nozzles to apply tire shampoo chemical on each tire. |
| 1168 | Group of 4 dedicated tire shampoo spray nozzle. |
| 1170H | Solenoid operated 2 way valves attached to supply tanks for tire and engine cleaning |
| | chemical to allow chemicals to flow out of tank and into transmission line to be |
| | deposited on to vehicle surface via spray nozzles. |
| 1176 | Tank for tire & engine cleaning chemical. |
| 1179A | Compressed air branch line to foam generator (Note:- Not needed in design if self |
| | aspirating nozzles are used to generate foam at time of discharge of chemical from |
| | spray nozzles onto surface of vehicle. |
| 1187 | Controller (mechanical or electronic). |

The various controlled components (e.g., valves, etc.) identified in FIG. 11E and as further described in the corresponding table are set according to programming of the controller or other control mechanism (e.g., electronics, such as an Field Programmable Gate Array, computer device, controller, etc.). The controlled components are set, for example, for a tire and engine shampoo cycle with water from an external source, as described in Table 6B.

TABLE 6B

| Equip | Equipment | Used | Power | Port | Port | Port | Equip |
|---|---|---|---|---|---|---|---|
| # | Type | For | Status | A | B | C | Status |
| 1 | 3Way Valve | Air/Water | | Open | Open | Closed | |
| 2 | 3Way Valve | Water | | Open | Open | Closed | |
| 3 | 2Way Valve | Air | | Open | Open | * | |
| 4 | Pressurizer | Pump | ON | | | | |
| 5 | Air Heater | Heater | ON | | | | |
| 6 | Pump Motor | Pumping | ON | | | | |
| 7 | Water | Water | | Open | Closed | Open | |
| 8 | Water | Water | | Open | Closed | Open | |
| 9 | Water | Water | | Open | Closed | Open | |
| 10 | Water heater | Heater | ON | | | | |
| 11 | 2Way Valve | Water | | Open | Closed | * | X |
| 12 | 3Way Valve | Chemical | | Open | Closed | Closed | X |
| 13 | 3Way Valve | Water | | Open | Closed | Closed | X |
| 14 | 3Way Valve | Water | | Open | Closed | Closed | X |
| 15 | 3Way Valve | Chemical | | Open | Closed | Closed | X |
| 16 | 3Way Valve | Water | | Open | Closed | Open | |
| 17 | 3Way Valve | Chemical | | Open | Closed | Closed | X |
| 18 | 2Way Valve | Air | | Open | Open | * | |
| 19 | Pump motor | Pumping | ON | | | | |
| 20 | 3Way Valve | Chemical | | Open | Open | Open | |
| 21 | 3Way Valve | Chemical | | Open | Closed | Closed | X |
| 22 | 3Way Valve | Air | | Open | Closed | Closed | X |
| 23 | 2Way Valve | Chemical | | Open | Closed | * | X |
| 24 | 2Way Valve | Chemical | | Open | Closed | * | X |
| 25 | 2Way Valve | Chemical | | Open | Closed | * | X |
| 26 | 2Way Valve | Chemical | | Open | Closed | * | X |
| 27 | 2Way Valve | Chemical | | Open | Closed | * | X |
| 28 | 2Way Valve | Chemical | | Open | Closed | * | X |
| 29 | 2Way Valve | Chemical | | Open | Closed | * | X |
| 30 | 2Way Valve | Chemical | | Open | Open | * | |
| 31 | 2Way Valve | Chemical | | Open | Closed | * | X |
| 32 | Tank heater | Heater | OFF | | | | X |

FIG. 11F is a diagram of a layout of components in an exemplary triple wax cycle according to an embodiment of the present invention. The components illustrated in FIG. 11F are arranged to provide lines and nozzles suited to provide a triple wax cycle upon command from the controller (e.g., commands sent from the controller to activate valves allocating wax fluids and pressurizing the system according to the triple wax cycle). The triple wax cycle is applied to all surfaces. The components illustrated in FIG. 11F are individually described in Table 7A.

TABLE 7A
Exemplary Triple Wax Cycle Components

| | |
|---|---|
| 1127 | Chemical supply line to bank of chemical spray nozzles located on the underside of the |
| | vehicle. |
| 1127A | Chemical supply line to bank of chemical spray nozzles located at heavy duty cleaning |
| | areas (i.e. nose of vehicle, windshield, mirror housings, rocker panels and all vertical |
| | or near vertical surfaces. |
| 1128 | Solenoid operated 3 way valve to direct flow of cleaning and preserving chemicals to |
| | under side of vehicle as well to the areas requiring heavy duty cleaning (i.e. nose |
| | wind shield, mirror housing and rocker panels). |
| 1130 | Medium to low pressure chemical spray nozzles (60 to 100 PSI pressure) located on |
| | the heavy duty cleaning areas (i.e. vertical or near vertical surfaces in front of vehicle |
| | as well as nose, windshield, mirror housings, rocker panels etc.). |
| 1132 | Bank of chemical & water spray nozzles (Not used in this cycle, not shown) for areas |
| | requiring heavy duty cleaning (i.e. vertical or near vertical surfaces in front of vehicle |
| | as well as nose, windshield, mirror housings, rocker panels etc.). There are separate |
| | spray nozzles for water and chemical applications. |
| 1133 | Chemical supply line for distribution of cleaning and preserving chemicals to under |
| | side of the vehicle as well as heavy duty cleaning areas. |
| 1139 | Medium to low pressure chemical spray nozzles (60100 PSI pressure) located on the |
| | right side of vehicle. |
| 1140 | Bank of chemical & water spray nozzles (Not used in this cycle, not shown) for right |
| | side of vehicle (Note:- Left side identical). |
| 1140A | Bank of chemical & water (Not used in this cycle, not shown) for left side of vehicle. |
| | (Note:- Right side identical). |
| 1141 | Water supply line to solenoid operated 3 way valve to supply water to spray nozzles in |
| | the engine compartment and to chemical and water mixing/proportioning device. |
| 1142 | Solenoid operated 3 way valve to distribute chemicals to chemical spray nozzles |
| | located on the left and right side of vehicle. |
| 1144 | Chemical (cleaning & preserving fluids) supply line to nozzles located on the left side |
| | of vehicle. |
| 1145 | Chemical supply line between 2 way solenoid valves controlling supply of various |
| | chemicals to different parts of vehicle. |
| 1146 | Solenoid operated 3 way valve to distribute chemicals to chemicals spray nozzles |
| | located on the left & right side of vehicle as well as to under side of vehicle and to |
| | chemicals spray nozzles located on areas requiring heavy duty cleaning. |
| 1147 | Solenoid operated 3 way valve directing flow of water to engine compartment and to |
| | chemical proportioning/mixing devices. |
| 1148 | Water supply line to nozzles located in the engine compartment. |
| 1149 | Trunk line to supply water to proportioning/mixing devices for automatic mixing of |
| | water and chemical. |
| 1151 | Branch line to supply water to proportioning/mixing devices for automatic mixing of |
| | water and chemical. |
| 1152 | Proportioning device/valve for automatic mixing of water and chemicals. |
| 1153 | Low pressure pump and motor combination unit to pump chemical at low pressure (60 |
| | to 100 PSI pressure). |
| 1154 | Foam generator for turning diluted chemical and water mixture into foam before |
| | application of chemicals to vehicle surface by introducing compress air into chamber |
| | containing chemical mixture. (Note:- This unit may be eliminated in the even self |
| | aspirating nozzles are used to turn chemicals into form just as chemical are sprayed |
| | onto vehicle surface). |
| 1156 | Solenoid operated 2 way valve to direct supply of compressed air from compressed air |
| | supply line into foam generator. |
| 1169 | Supply line to transmit various cleaning and preserving chemicals to different parts of |
| | vehicle (Note:- Each chemical may have it's own dedicated line or a common line |
| | through which the respective chemical will be transmitted depending on the current |
| | cycle). In this cycle triple wax is being transmitted through the line. |
| 1170A | Solenoid operated 2 way valves attached to No. 1 supply tanks to allow chemicals flow |
| | out of tank and into transmission line taking chemicals to final destination through |
| | spray nozzles. |
| 1170B | Solenoid operated 2 way valves attached to No. 2 supply tanks to allow chemicals flow |
| | out of tank and into transmission line taking chemicals to final destination through |
| | spray nozzles. |
| 1170C | Solenoid operated 2 way valves attached to No. 3 supply tanks to allow chemicals flow |
| | out of tank and into transmission line taking chemicals to final destination through |
| | spray nozzles. |
| 1171A | Triple color wax supply tank No. 1 (each tank with different color). Depending on the |
| | design each tank may have hydrominder automatic mixing device (if item # 152 & |
| | 158 are not used to mix water and chemical) and eductors to mix liquids if settled in |
| | tank (optional). Triply wax may also be used undiluted. Triply waxes may be the |
| | type supplied by turtle wax or the kind supplied by simonize or similar formulation |
| | by others. |
| 1171B | Triple color wax supply tank No. 2. Contents same/similar as tank No. 1 with the |
| | exception of color. |
| 1171C | Triple color wax supply tank No. 3. Contents same/similar as tank No. 1 & 2 with the |
| | exception of color. |
| 1179A | Compressed air branch line to foam generator (Note:- Not needed in design if self |
| | aspirating nozzles are used to generate foam at time of discharge of chemical from |
| | spray nozzles onto surface of vehicle. |
| 1187 | Controller (mechanical or electronic). |

The various controlled components (e.g., valves, etc.) identified in FIG. 11F and as further described in the corresponding table are set according to programming of the controller or other control mechanism (e.g., electronics, such as a Field Programmable Gate Array (FPGA), computer device, controller, etc.). The controlled components are set, for example, for a triple wax as described in Table 7B.

TABLE 7B

| Equip | Equipment | Used | Power | Port | Port | Port | Equip |
|---|---|---|---|---|---|---|---|
| # | Type | For | Status | A | B | C | Status |
| 1 | 3Way Valve | Air/Water | | Open | Open | Closed | |
| 2 | 3Way Valve | Water | | Open | Open | Closed | |
| 3 | 2Way Valve | Air | | Open | Open | * | |
| 4 | Pressurizer | Pump | ON | | | | |
| 5 | Air Heater | Heater | ON | | | | |
| 6 | Pump Motor | Pumping | ON | | | | |
| 7 | Water | Water | | Open | Closed | Open | |
| 8 | Water | Water | | Open | Closed | Open | |
| 9 | Water | Water | | Open | Closed | Open | |
| 10 | Water heater | Heater | ON | * | * | * | |
| 11 | 2Way Valve | Water | | Open | Closed | * | X |
| 12 | 3Way Valve | Chemical | | Open | Closed | Open | |
| 13 | 3Way Valve | Water | | Open | Closed | Closed | X |
| 14 | 3Way Valve | Water | | Open | Closed | Closed | X |
| 15 | 3Way Valve | Chemical | | Open | Open | Open | |
| 16 | 3Way Valve | Water | | Open | Closed | Open | |
| 17 | 3Way Valve | Chemical | | Open | Open | Open | |
| 18 | 2Way Valve | Air | | Open | Open | * | |
| 19 | Pump motor | Pumping | ON | * | * | * | |
| 20 | 3Way Valve | Chemical | | Open | Closed | Closed | X |
| 21 | 3Way Valve | Chemical | | Open | Closed | Closed | X |
| 22 | 3Way Valve | Air | | Open | Closed | Closed | X |
| 23 | 2Way Valve | Chemical | | Open | Open | * | |
| 24 | 2Way Valve | Chemical | | Open | Open | * | |
| 25 | 2Way Valve | Chemical | | Open | Open | * | |
| 26 | 2Way Valve | Chemical | | Open | Closed | * | X |
| 27 | 2Way Valve | Chemical | | Open | Closed | * | X |
| 28 | 2Way Valve | Chemical | | Open | Closed | * | X |
| 29 | 2Way Valve | Chemical | | Open | Closed | * | X |
| 30 | 2Way Valve | Chemical | | Open | Closed | * | X |
| 31 | 2Way Valve | Chemical | | Open | Closed | * | X |
| 32 | Tank heater | Heater | OFF | * | * | * | X |

FIG. 11G is a diagram of a layout of components in an exemplary reverse osmosis water rinse (spot free rinse) cycle according to an embodiment of the present invention. The components illustrated in FIG. 11G are arranged to provide lines and nozzles suited to a rinse cycle upon command from the controller (e.g., commands sent from the controller to activate valves allocating rinse fluids and pressurizing the system according to the reverse osmosis water rinse cycle). As discussed above, using RO'ed water in the rinse cycle produces a more spot free rinse. In one embodiment, a high quality filter or water purifier is substituted for a reverse osmosis device in the system. The reverse osmosis rinse cycle is, for example, preferably applied to exterior (visible) surfaces of the vehicle being washed. In one embodiment, water for the rinse cycle routed to underbody and other non-visible surfaces (non-visible surfaces are defined as surfaces that are not normally viewed by the general public when the vehicle is in use in public areas). The components illustrated in FIG. 11G are individually described in Table 8A.

TABLE 8A
Exemplary Rinse Cycle Components

| | |
|---|---|
| 101 | Water inlet line coupling. |
| 1102 | Water line. |
| 1103 | Strainer, sediment filter, simple filter etc. |
| 1105 | Solenoid operated 3 way valve for water distribution to water storage tank or to bypass |
| | water storage tank completely. |
| 1106 | Water supply line to water storage tank. |
| 1107 | Water supply line to water pump bypassing water storage tank. |
| 1108 | Water storage tank. |
| 1109 | Water storage tank heater. |
| 1110 | Water pump and motor combination. |
| 1111 | Water supply line from water storage tank. |
| 1112 | Solenoid operated 3 way valve to supply water to entire system either from water |
| | storage tank or from external hook up source. |
| 1113 | Water supply line from water pump. |
| 1114 | Solenoid operated 3 way valve to direct flow of water via the water filter/reverse |
| | osmosis filter/water softener or to bypass the filter altogether. |
| 1115 | Water supply line to water filter/softener/reverse osmosis filter. |
| 1116 | Water filter/softener/reverse osmosis filter or combination there off. |
| 1117 | Filtered/Softened water storage tank (optional). |
| 1117A | Filtered water line from filtered water storage tank to solenoid operated 3 way valve. |
| 1118 | Solenoid operated 3 way valve to supply either filtered water from water filter or from |
| | un-filtered water supply (depending on requirements of the current cycle). |
| 1119 | Pressure relief valve with integrated pressure sensor. |
| 1120 | Pressure released water recycle line back to water storage tank. |
| 1121 | Instantaneous hot water heater - heating via a heat exchanger slaved to hot engine |
| | exhaust gases or electrically operated to heat water in the range of 140° F. Unit to |
| | have built in adjustable thermostat and thermal overload relay. |
| 1122 | Solenoid operated 2 way valve to enable or disable water flow to bank of high pressure |
| | nozzles located at under side of the vehicle (i.e. Wheel wells, belly and under |
| | carriage). |
| 1123 | Water supply line to bank of nozzles located on the under side of the vehicle. |
| 1124 | High pressure water spray nozzles located on the under side of the vehicle. |
| 1126 | Bank of high, medium to low pressure water and chemical spray nozzles (Not used in |
| | this cycle, not shown) located on under side of the vehicle. |
| 1129 | Water supply line to spray nozzles located in the heavy duty cleaning areas of vehicle |
| | (i.e. vertical or near vertical surfaces in front of vehicle as well as nose, windshield, |
| | mirror housings, rocker panels etc.). |
| 1131 | High pressure water spray nozzle for areas requiring heavy duty cleaning (500 to 1,500 PSI |
| | pressure). |
| 1132 | Bank of chemical (Not used in this cycle, not shown) & water spray nozzles for areas |
| | requiring heavy duty cleaning (i.e. vertical or near vertical surfaces in front of vehicle |
| | as well as to nose, windshield, mirror housings, rocker panels etc.). In this design |
| | there are separate spray nozzles for water and chemical applications, however same |
| | nozzles may be used. |
| 1134 | Solenoid operated 3 way valve to direct flow of water to various areas of vehicle. |
| 1135 | Water supply line to 3 way solenoid operated valve supplying water to spray nozzles |
| | located on the left & right side of the vehicle. |
| 1136 | Solenoid operated 3 way valve to direct water to high and medium pressure spray |
| | nozzles on the right side of vehicle. |
| 1137 | Water supply line or manifold to bank of spray nozzles on the right side of vehicle |
| | (Note:- Left side identical). |
| 1137A | Water supply line or manifold to bank of spray nozzles on the right side of vehicle |
| | (Note:- Right side identical). |
| 1138 | Medium to high pressure (500 to 1,500 PSI pressure) water spray nozzles located on |
| | the right side of vehicle (Note:- Left side identical). |
| 1140 | Bank of water & chemical spray nozzles (Not shown, not used in this cycle) for right |
| | side of vehicle (Note:- Left side identical). |
| 1140A | Bank of water & chemical spray nozzles (Not shown, not used in this cycle) for left |
| | side of vehicle (Note:- Right side identical). |
| 1141 | Water supply line to solenoid operated 3 way valve to supply water to spray nozzles in |
| | the engine compartment and to chemical and water mixing/proportioning device. |
| 1147 | Solenoid operated 3 way valve directing flow of water to engine compartment and to |
| | chemical proportioning/mixing devices. |
| 1148 | Water supply line to nozzles located in the engine compartment. |
| 1149 | Trunk line to supply water to proportioning/mixing devices for automatic mixing of |
| | water and chemical. |
| 1164 | High pressure water spray nozzles located in the engine compartment of vehicle. |
| 1166 | Bank of chemical (Not shown, not used in this cycle) & water spray nozzles located in |
| | the engine compartment. |
| 1185 | External water supply hook up via an ordinary garden hose with quick disconnect |
| | coupling or equal. |
| 1186 | Water storage tank drain valve. |
| 1187 | Controller (mechanical or electronic). |

The various controlled components (e.g., valves, etc.) identified in FIG. 11G and as further described in the corresponding table are set according to programming of the controller or other control mechanism (e.g., electronics, such as a Field Programmable Gate Array (FPGA), computer device, controller, etc.). The controlled components may be set, for example, for final reverse osmosis rinse (water from external source) as described in Table 8B.

TABLE 8B

| Equip | Equipment | Used | Power | Port | Port | Port | Equip |
|---|---|---|---|---|---|---|---|
| # | Type | For | Status | A | B | C | Status |
| 1 | 3Way Valve | Air/Water | | Open | Open | Closed | |
| 2 | 3Way Valve | Water | | Open | Open | Closed | |
| 3 | 2Way Valve | Air | | Open | Open | * | |
| 4 | Pressurizer | Pump | ON | | | | |
| 5 | Air Heater | Heater | OFF | | | | X |
| 6 | Pump Motor | Pumping | ON | | | | |
| 7 | Water | Water | | Open | Closed | Open | |
| 8 | Water | Water | | Open | Closed | Open | |
| 9 | Water | Water | | Open | Closed | Open | |
| 10 | Water heater | Heater | ON | | | | |
| 11 | 2Way Valve | Water | | Open | Open | * | |
| 12 | 3Way Valve | Chemical | | Open | Closed | Closed | X |
| 13 | 3Way Valve | Water | | Open | Open | Open | |
| 14 | 3Way Valve | Water | | Open | Open | Open | |
| 15 | 3Way Valve | Chemical | | Open | Closed | Closed | X |
| 16 | 3Way Valve | Water | | Open | Open | Closed | |
| 17 | 3Way Valve | Chemical | | Open | Closed | Closed | X |
| 18 | 2Way Valve | Air | | Open | Closed | * | X |
| 19 | Pump motor | Pumping | OFF | | | | X |
| 20 | 3Way Valve | Chemical | | Open | Closed | Closed | X |
| 21 | 3Way Valve | Chemical | | Open | Closed | Closed | X |
| 22 | 3Way Valve | Air | | Open | Closed | Closed | X |
| 23 | 2Way Valve | Chemical | | Open | Closed | * | X |
| 24 | 2Way Valve | Chemical | | Open | Closed | * | X |
| 25 | 2Way Valve | Chemical | | Open | Closed | * | X |
| 26 | 2Way Valve | Chemical | | Open | Closed | * | X |
| 27 | 2Way Valve | Chemical | | Open | Closed | * | X |
| 28 | 2Way Valve | Chemical | | Open | Closed | * | X |
| 29 | 2Way Valve | Chemical | | Open | Closed | * | X |
| 30 | 2Way Valve | Chemical | | Open | Closed | * | X |
| 31 | 2Way Valve | Chemical | | Open | Closed | * | X |
| 32 | Tank heater | Heater | OFF | | | | X |

FIG. 11H is a diagram of a layout of components in an exemplary total body protectant cycle according to an embodiment of the present invention. The components illustrated in FIG. 11H are arranged to provide lines and nozzles suited to a total body protectorant cycle upon command from the controller (e.g., commands sent from the controller to activate valves allocating appropriate protectorant fluids and pressurizing the system according to the total body protectorant cycle). The total body protectorant cycle is, for example, preferably applied to visible exterior surfaces of the vehicle. The components illustrated in FIG. 11H are individually described in Table 9A.

TABLE 9A
Exemplary Total Body Protectorant Components

| | |
|---|---|
| 1127 | Chemical supply line to bank of chemical spray nozzles located on the underside of the |
| | vehicle. |
| 1127A | Chemical supply line to bank of chemical spray nozzles located at heavy duty cleaning |
| | areas (i.e. nose of vehicle, windshield, mirror housings, rocker panels and all vertical |
| | or near vertical surfaces. |
| 1128 | Solenoid operated 3 way valve to direct flow of cleaning and preserving chemicals to |
| | under side of vehicle as well to the areas requiring heavy duty cleaning (i.e. nose |
| | wind shield, mirror housing and rocker panels). |
| 1130 | Medium to low pressure chemical spray nozzles (60 to 100 PSI pressure) located on |
| | the heavy duty cleaning areas (i.e. vertical or near vertical surfaces in front of vehicle |
| | as well as to nose, windshield, mirror housings, rocker panels etc.). |
| 1132 | Bank of chemical & water spray nozzles (Not shown, not used in this cycle) for areas |
| | requiring heavy duty cleaning (i.e. vertical or near vertical surfaces in front of vehicle |
| | as well as to nose, windshield, mirror housings, rocker panels etc.). In this design |
| | there are separate spray nozzles for water and chemical applications, however, same |
| | nozzles may be used. |
| 1133 | Chemical supply line for distribution of cleaning and preserving chemicals to under |
| | side of the vehicle as well as heavy duty cleaning areas. |
| 1139 | Medium to low pressure chemical spray nozzles (60100 PSI pressure) located on the |
| | right side of vehicle. |
| 1140 | Bank of water (Not shown, not used in this cycle) & chemical spray nozzles for right |
| | side of vehicle (Note:- Left side identical). |
| 1140A | Bank of water (Not shown, not used in this cycle) & chemical spray nozzles for left |
| | side of vehicle (Note:- Right side identical). |
| 1141 | Water supply line to solenoid operated 3 way valve to supply water to spray nozzles in |
| | the engine compartment and to chemical and water mixing/proportioning device. |
| 1142 | Solenoid operated 3 way valve to distribute chemicals to chemical spray nozzles |
| | located on the left and right side of vehicle. |
| 1143 | Chemical (cleaning & preserving fluids) supply line to nozzles located on the right side |
| | of vehicle. |
| 1144 | Chemical (cleaning & preserving fluids) supply line to nozzles located on the left side |
| | of vehicle. |
| 1145 | Chemical supply line between 2 way solenoid valves controlling supply of various |
| | chemicals to different parts of vehicle. |
| 1146 | Solenoid operated 3 way valve to distribute chemicals to chemicals spray nozzles |
| | located on the left & right side of vehicle as well as to under side of vehicle and to |
| | chemicals spray nozzles located on areas requiring heavy duty cleaning. |
| 1147 | Solenoid operated 3 way valve directing flow of water to engine compartment and to |
| | chemical proportioning/mixing devices. |
| 1148 | Water supply line to nozzles located in the engine compartment. |
| 1149 | Trunk line to supply water to proportioning/mixing devices for automatic mixing of |
| | water and chemical. |
| 1151 | Branch line to supply water to proportioning/mixing devices for automatic mixing of |
| | water and chemical. |
| 1152 | Proportioning device/valve for automatic mixing of water and chemicals. |
| 1153 | Low pressure pump and motor combination unit to pump chemical at low pressure (60 |
| | to 100 PSI pressure). |
| 1169 | Supply line to transmit various cleaning and preserving chemicals to different parts of |
| | vehicle (Note:- Each chemical may have it's own dedicated line or a common line |
| | through which each chemical will be transmitted depending on the current cycle). In |
| | this arrangement total body protectant is being supplied. |
| 1170F | Solenoid operated 2 way valves attached to supply tank to allow chemicals to flow out |
| | of tank and into transmission line to final destination through spray nozzles. |
| 1174 | Total body protectant chemical tank. |
| 1187 | Controller (mechanical or electronic). |

The various controlled components (e.g., valves, etc.) identified in FIG. 11H and as further described in the corresponding table are set according to programming of the controller or other control mechanism (e.g., electronics, such as a Field Programmable Gate Array (FPGA), computer device, controller, etc.). The controlled components may be set, for example, for the application of a total body protectant (e.g., any one or more of Rain-X, Simonize, others, etc.) as described in Table 9B.

TABLE 9B

| Equip | Equipment | Used | Power | Port | Port | Port | Equip |
|---|---|---|---|---|---|---|---|
| # | Type | For | Status | A | B | C | Status |
| 1 | 3Way Valve | Air/Water | | Open | Open | Closed | |
| 2 | 3Way Valve | Water | | Open | Open | Closed | |
| 3 | 2Way Valve | Air | | Open | Closed | * | X |
| 4 | Pressurizer | Pump | ON | | | | |
| 5 | Air Heater | Heater | OFF | | | | X |
| 6 | Pump Motor | Pumping | ON | | | | |
| 7 | Water | Water | | Open | Closed | Open | |
| 8 | Water | Water | | Open | Closed | Open | |
| 9 | Water | Water | | Open | Closed | Open | |
| 10 | Water heater | Heater | ON | | | | |
| 11 | 2Way Valve | Water | | Open | Closed | * | X |
| 12 | 3Way Valve | Chemical | | Open | Closed | Open | |
| 13 | 3Way Valve | Water | | Open | Closed | Closed | X |
| 14 | 3Way Valve | Water | | Open | Closed | Closed | X |
| 15 | 3Way Valve | Chemical | | Open | Open | Open | |
| 16 | 3Way Valve | Water | | Open | Open | Closed | |
| 17 | 3Way Valve | Chemical | | Open | Open | Open | |
| 18 | 2Way Valve | Air | | Open | Closed | * | X |
| 19 | Pump motor | Pumping | ON | * | * | * | |
| 20 | 3Way Valve | Chemical | | Open | Closed | Closed | X |
| 21 | 3Way Valve | Chemical | | Open | Closed | Closed | X |
| 22 | 3Way Valve | Air | | Open | Closed | * | X |
| 23 | 2Way Valve | Chemical | | Open | Closed | * | X |
| 24 | 2Way Valve | Chemical | | Open | Closed | * | X |
| 25 | 2Way Valve | Chemical | | Open | Closed | * | X |
| 26 | 2Way Valve | Chemical | | Open | Closed | * | X |
| 27 | 2Way Valve | Chemical | | Open | Closed | * | X |
| 28 | 2Way Valve | Chemical | | Open | Open | * | |
| 29 | 2Way Valve | Chemical | | Open | Closed | * | X |
| 30 | 2Way Valve | Chemical | | Open | Closed | * | X |
| 31 | 2Way Valve | Chemical | | Open | Closed | * | X |
| 32 | Tank heater | Heater | OFF | | | | X |

FIG. 11I is a diagram of a layout of components in an exemplary underbody protectant cycle according to an embodiment of the present invention. The components illustrated in FIG. 11I are arranged to provide lines and nozzles suited to a underbody protectant cycle upon command from the controller (e.g., commands sent from the controller to activate valves allocating appropriate protectorant fluids and pressurizing the system according to the underbody protectant cycle). The components illustrated in FIG. 11I are individually described in Table 10A.

TABLE 10A
Exemplary Underbody Protectant Components

| | |
|---|---|
| 1125 | Medium to low pressure chemical spray nozzles (60 to 100 PSI pressure) located on |
| | the under side of the vehicle (nozzles to spray soap, body protectants etc.) |
| 1126 | Bank of high, medium to low pressure chemical and water spray nozzles (Not used in |
| | this cycle, not shown) located on under side of the vehicle. |
| 1127 | Chemical supply line to bank of chemical spray nozzles located on the underside of the |
| | vehicle. |
| 1127A | Chemical supply line to bank of chemical spray nozzles located at heavy duty cleaning |
| | areas (i.e. nose of vehicle, windshield, mirror housings, rocker panels and all vertical |
| | or near vertical surfaces. |
| 1128 | Solenoid operated 3 way valve to direct flow of cleaning and preserving chemicals to |
| | under side of vehicle as well to the areas requiring heavy duty cleaning (i.e. nose |
| | wind shield, mirror housing and rocker panels). |
| 1133 | Chemical supply line for distribution of cleaning and preserving chemicals to under |
| | side of the vehicle as well as heavy duty cleaning areas. |
| 1141 | Water supply line to solenoid operated 3 way valve to supply water to spray nozzles in |
| | the engine compartment and to chemical and water mixing/proportioning device. |
| 1145 | Chemical supply line between 2 way solenoid valves controlling supply of various |
| | chemicals to different parts of vehicle. |
| 1146 | Solenoid operated 3 way valve to distribute chemicals to chemicals spray nozzles |
| | located on the left & right side of vehicle as well as to under side of vehicle and to |
| | chemicals spray nozzles located on areas requiring heavy duty cleaning. |
| 1147 | Solenoid operated 3 way valve directing flow of water to engine compartment and to |
| | chemical proportioning/mixing devices. |
| 1148 | Water supply line to nozzles located in the engine compartment. |
| 1149 | Trunk line to supply water to proportioning/mixing devices for automatic mixing of |
| | water and chemical. |
| 1151 | Branch line to supply water to proportioning/mixing devices for automatic mixing of |
| | water and chemical. |
| 1152 | Proportioning device/valve for automatic mixing of water and chemicals. |
| 1153 | Low pressure pump and motor combination unit to pump chemical at low pressure (60 |
| | to 100 PSI pressure). |
| 1169 | Supply line to transmit various cleaning and preserving chemicals to different parts of |
| | vehicle (Note:- Each chemical may have it's own dedicated line or a common line |
| | through which the chemical will be transmitted depending on the current cycle). In |
| | this arrangement under body protectant is being transmitted to vehicle surface via |
| | spray nozzles. |
| 1170G | Solenoid operated 2 way valves attached to supply tank for under body protectant to |
| | allow chemicals flow into transmission line to final destination through spray nozzles. |
| 1175 | Under body protectant - rust inhabiting chemical tank. |
| 1187 | Controller (mechanical or electronic). |

The various controlled components (e.g., valves, etc.) identified in FIG. 11I and as further described in the corresponding table are set according to programming of the controller or other control mechanism (e.g., electronics, such as a Field Programmable Gate Array (FPGA), computer device, controller, etc.). The controlled components may be set, for example, for the application of an under body protectorant as described in Table 10B.

TABLE 10B

| Equip | Equipment | Used | Power | Port | Port | Port | Equip |
|---|---|---|---|---|---|---|---|
| # | Type | For | Status | A | B | C | Status |
| 1 | 3Way Valve | Air/Water | | Open | Open | Closed | |
| 2 | 3Way Valve | Water | | Open | Open | Closed | |
| 3 | 2Way Valve | Air | | Open | Closed | * | X |
| 4 | Pressurizer | Pump | ON | | | | |
| 5 | Air Heater | Heater | OFF | | | | X |
| 6 | Pump Motor | Pumping | ON | | | | |
| 7 | Water | Water | | Open | Closed | Open | |
| 8 | Water | Water | | Open | Closed | Open | |
| 9 | Water | Water | | Open | Closed | Open | |
| 10 | Water heater | Heater | ON | | | | |
| 11 | 2Way Valve | Water | | Open | Closed | * | X |
| 12 | 3Way Valve | Chemical | | Open | Open | Closed | |
| 13 | 3Way Valve | Water | | Open | Closed | Closed | X |
| 14 | 3Way Valve | Water | | Open | Closed | Closed | X |
| 15 | 3Way Valve | Chemical | | Open | Closed | Closed | X |
| 16 | 3Way Valve | Water | | Open | Closed | Open | |
| 17 | 3Way Valve | Chemical | | Open | Open | Closed | |
| 18 | 2Way Valve | Air | | Open | Closed | * | X |
| 19 | Pump motor | Pumping | ON | | | | |
| 20 | 3Way Valve | Chemical | | Open | Closed | Closed | X |
| 21 | 3Way Valve | Chemical | | Open | Closed | Closed | X |
| 22 | 3Way Valve | Air | | Open | Closed | Closed | X |
| 23 | 2Way Valve | Chemical | | Open | Closed | * | X |
| 24 | 2Way Valve | Chemical | | Open | Closed | * | X |
| 25 | 2Way Valve | Chemical | | Open | Closed | * | X |
| 26 | 2Way Valve | Chemical | | Open | Closed | * | X |
| 27 | 2Way Valve | Chemical | | Open | Closed | * | X |
| 28 | 2Way Valve | Chemical | | Open | Closed | * | X |
| 29 | 2Way Valve | Chemical | | Open | Open | * | |
| 30 | 2Way Valve | Chemical | | Open | Closed | * | X |
| 31 | 2Way Valve | Chemical | | Open | Closed | * | X |
| 32 | Tank heater | Heater | OFF | | | | X |

FIG. 11J is a diagram of a layout of components in an exemplary tire shine cycle according to an embodiment of the present invention. The components illustrated in FIG. 11J are arranged to provide lines and nozzles suited to a tire shine cycle upon command from the controller (e.g., commands sent from the controller to activate valves allocating appropriate fluids and pressurizing the system according to the tire shine cycle). The fluids of the tire shine cycle are applied to tires of the vehicle.

FIG. 11J represents an extension of the basic tire shine applicators shown in FIGS. 1A and 1B (152A-152D). As shown in FIG. 11J, tank 117 can be a tire shine liquid of various types that are best suited to be applied by different applicators. If tank 1177 is identified as, for example, a silicone based spray-on tire shine, then the controller utilized spray nozzles 1161 to apply it to the tires. If the controller identifies tank 1177 as containing, for example, a wipe-on tire shine then the controller utilized sponges 1162 to apply the tire shine.

The components illustrated in FIG. 11J are individually described in Table 11A.

TABLE 11A
Exemplary Tire Shine Cycle Components

| | |
|---|---|
| 1153 | Low pressure pump and motor combination unit to pump chemical at low pressure (60 |
| | to 100 PSI pressure). |
| 1159 | Supply line for tire dressing/preserving/shining chemical to spray nozzles or |
| | applicator roller/brushes/sponges etc. |
| 1160 | Solenoid operated 3 way valve to direct flow of tire shine chemical to either spray |
| | nozzles or to applicator sponges (Note:- Vehicle equipped with only one option may |
| | not have this solenoid valve. |
| 1160A | Branch line to supply tire shine chemical to spray nozzles. |
| 1160B | Branch line to supply tire shine chemicals to pop out applicator sponges/brushes. |
| 1161 | Low pressure (60 to 100 PSI pressure, ideally 80 PSI) chemical spray nozzles for each |
| | tire. |
| 1162 | Tire shine extendible applicator sponges. |
| 1163 | Group of spray nozzles and applicator sponges dedicated to applying tire shine |
| | chemicals. |
| 1170I | Solenoid operated 2 way valves attached to supply tanks to allow chemicals flow out |
| | of tank and into transmission line. |
| 1177 | Tank for tire shine liquid - may be the type supplied by Armorall ™ or similar product |
| | or silicone based type supplied by Viper Shine ™. Silicone tire dressing and other |
| | types of tire dressing chemicals my be the type that are sprayed on or applied using a |
| | sponge or a brush. |
| 1187 | Controller (mechanical or electronic). |

The various controlled components (e.g., valves, etc.) identified in FIG. 11J and as further described in the corresponding table are set according to programming of the controller or other control mechanism (e.g., electronics, such as a Field Programmable Gate Array (FPGA), computer device, controller, etc.). The controlled components may be set, for example, for the application of a tire shine cycle as described in Table 11B.

TABLE 11B

| Equip | Equipment | Used | Power | Port | Port | Port | Equip |
|---|---|---|---|---|---|---|---|
| # | Type | For | Status | A | B | C | Status |
| 1 | 3Way Valve | Air/Water | | Open | Closed | Closed | X |
| 2 | 3Way Valve | Water | | Open | Closed | Closed | X |
| 3 | 2Way Valve | Air | | Open | Closed | * | X |
| 4 | Pressurizer | Pump | ON | | | | |
| 5 | Air Heater | Heater | OFF | | | | X |
| 6 | Pump Motor | Pumping | OFF | | | | X |
| 7 | Water | Water | | Open | Closed | Closed | X |
| 8 | Water | Water | | Open | Closed | Open | |
| 9 | Water | Water | | Open | Closed | Open | |
| 10 | Water heater | Heater | OFF | | | | X |
| 11 | 2Way Valve | Water | | Open | Closed | * | X |
| 12 | 3Way Valve | Chemical | | Open | Closed | Closed | X |
| 13 | 3Way Valve | Water | | Open | Closed | Open | |
| 14 | 3Way Valve | Water | | Open | Closed | Closed | X |
| 15 | 3Way Valve | Chemical | | Open | Closed | Closed | X |
| 16 | 3Way Valve | Water | | Open | Closed | Closed | X |
| 17 | 3Way Valve | Chemical | | Open | Closed | Closed | X |
| 18 | 2Way Valve | Air | | Open | Closed | * | X |
| 19 | Pump motor | Pumping | ON | | | | |
| 20 | 3Way Valve | Chemical | | Open | Closed | Closed | X |
| 21 | 3Way Valve | Chemical | | Open | Closed | Closed | X |
| 22 | 3Way Valve | Air | | Open | Closed | Closed | X |
| 23 | 2Way Valve | Chemical | | Open | Closed | * | X |
| 24 | 2Way Valve | Chemical | | Open | Closed | * | X |
| 25 | 2Way Valve | Chemical | | Open | Closed | * | X |
| 26 | 2Way Valve | Chemical | | Open | Closed | * | X |
| 27 | 2Way Valve | Chemical | | Open | Closed | * | X |
| 28 | 2Way Valve | Chemical | | Open | Closed | * | X |
| 29 | 2Way Valve | Chemical | | Open | Closed | * | X |
| 30 | 2Way Valve | Chemical | | Open | Closed | * | X |
| 31 | 2Way Valve | Chemical | | Open | Open | * | |
| 32 | Tank heater | Heater | OFF | | | | X |

FIG. 11K is a diagram of a layout of components in an exemplary final RO rinse cycle according to an embodiment of the present invention. The components illustrated in FIG. 11K are arranged to provide lines and nozzles suited to a final RO rinse cycle upon command from the controller (e.g., commands sent from the controller to activate valves allocating appropriate fluids and pressurizing the system according to the final RO rinse cycle). The final RO rinse cycle is, for example, preferably applied to all visible surfaces (or alternatively all surfaces) the vehicle being washed. The components illustrated in FIG. 11K are individually described in Table 12A.

TABLE 12A
Exemplary Final RO Rinse Cycle Components

| | |
|---|---|
| 101 | Water inlet line coupling. |
| 1102 | Water line. |
| 1103 | Strainer, sediment filter, simple filter etc. |
| 1105 | Solenoid operated 3 way valve for water distribution to water storage tank or to bypass |
| | water storage tank completely. |
| 1106 | Water supply line to water storage tank. |
| 1107 | Water supply line to water pump bypassing water storage tank. |
| 1108 | Water storage tank. |
| 1109 | Water storage tank heater. |
| 1110 | Water pump and motor combination. |
| 1111 | Water supply line from water storage tank. |
| 1112 | Solenoid operated 3 way valve to supply water to entire system either from water |
| | storage tank or from external hook up source. |
| 1113 | Water supply line from water pump. |
| 1114 | Solenoid operated 3 way valve to direct flow of water via the water filter/reverse |
| | osmosis filter/water softener or to bypass the filter altogether. |
| 1115 | Water supply line to water filter/softener/reverse osmosis filter. |
| 1116 | Water filter/softener/reverse osmosis filter or combination there off |
| 1117 | Filtered/Softened water storage tank (optional). |
| 1117A | Filtered water line from filtered water storage tank to solenoid operated 3 way valve. |
| 1118 | Solenoid operated 3 way valve to supply either filtered water from water filter or from |
| | un-filtered water supply (depending on requirements of the current cycle). |
| 1119 | Pressure relief valve with integrated pressure sensor. |
| 1120 | Pressure released water recycle line back to water storage tank. |
| 1121 | Instantaneous hot water heater - heating via a heat exchanger slaved to hot engine |
| | exhaust gases or electrically operated to heat water in the range of 140° F. Unit has, |
| | for example, a built in adjustable thermostat and thermal overload relay. |
| 1122 | Solenoid operated 2 way valve to enable or disable water flow to bank of high pressure |
| | nozzles located at under side of the vehicle (i.e. Wheel wells, belly and under |
| | carriage). |
| 1123 | Water supply line to bank of nozzles located on the under side of the vehicle. |
| 1124 | High pressure water spray nozzles located on the under side of the vehicle. |
| 1126 | Bank of high, medium to low pressure water and chemical spray nozzles (Not used in |
| | this cycle, not shown) located on under side of the vehicle. |
| 1129 | Water supply line to spray nozzles located in the heavy duty cleaning areas of vehicle |
| | (i.e. vertical or near vertical surfaces in front of vehicle as well as to nose, |
| | windshield, mirror housings, rocker panels etc.). |
| 1131 | High pressure water spray nozzle for areas requiring heavy duty cleaning (500 to 1,500 PSI |
| | pressure). |
| 1132 | Bank of chemical (Not used in this cycle, not shown) & water spray nozzles for areas |
| | requiring heavy duty cleaning (i.e. vertical or near vertical surfaces in front of vehicle |
| | as well as to nose, windshield, mirror housings, rocker panels etc.). In this design |
| | there are separate spray nozzles for water and chemical applications, however same |
| | nozzles may be used. |
| 1134 | Solenoid operated 3 way valve to direct flow of water to various areas of vehicle. |
| 1135 | Water supply line to 3 way solenoid operated valve supplying water to spray nozzles |
| | located on the left & right side of the vehicle. |
| 1136 | Solenoid operated 3 way valve to direct water to high and medium pressure spray |
| | nozzles on the right side of vehicle. |
| 1137 | Water supply line or manifold to bank of spray nozzles on the right side of vehicle |
| | (Note:- Left side identical). |
| 1137A | Water supply line or manifold to bank of spray nozzles on the right side of vehicle |
| | (Note:- Right side identical). |
| 1138 | Medium to high pressure (500 to 1,500 PSI pressure) water spray nozzles located on |
| | the right side of vehicle (Note:- Left side identical). |
| 1140 | Bank of water & chemical spray nozzles (Not shown, not used in this cycle) for right |
| | side of vehicle (Note:- Left side identical). |
| 1140A | Bank of water & chemical spray nozzles (Not shown, not used in this cycle) for left |
| | side of vehicle (Note:- Right side identical). |
| 1141 | Water supply line to solenoid operated 3 way valve to supply water to spray nozzles in |
| | the engine compartment and to chemical and water mixing/proportioning device. |
| 1147 | Solenoid operated 3 way valve directing flow of water to engine compartment and to |
| | chemical proportioning/mixing devices. |
| 1148 | Water supply line to nozzles located in the engine compartment. |
| 1149 | Trunk line to supply water to proportioning/mixing devices for automatic mixing of |
| | water and chemical. |
| 1164 | High pressure water spray nozzles located in the engine compartment of vehicle. |
| 1166 | Bank of chemical (Not shown, not used in this cycle) & water spray nozzles located in |
| | the engine compartment. |
| 1185 | External water supply hook up via an ordinary garden hose with quick disconnect |
| | coupling or equal. |
| 1186 | Water storage tank drain valve. |
| 1187 | Controller (mechanical or electronic). |

The various controlled components (e.g., valves, etc.) identified in FIG. 11K and as further described in the corresponding table are set according to programming of the controller or other control mechanism (e.g., electronics, such as a Field Programmable Gate Array (FPGA), computer device, controller, etc.). The controlled components may be set, for example, for the application of a final reverse osmosis rinse (water from external source)as described in Table 12B.

TABLE 12B

| Equip | Equipment | Used | Power | Port | Port | Port | Equip |
|---|---|---|---|---|---|---|---|
| # | Type | For | Status | A | B | C | Status |
| 1 | 3Way Valve | Air/Water | | Open | Open | Closed | |
| 2 | 3Way Valve | Water | | Open | Open | Closed | |
| 3 | 2Way Valve | Air | | Open | Open | * | |
| 4 | Pressurizer | Pump | ON | | | | |
| 5 | Air Heater | Heater | OFF | | | | X |
| 6 | Pump Motor | Pumping | ON | | | | |
| 7 | Water | Water | | Open | Closed | Open | |
| 8 | Water | Water | | Open | Closed | Open | |
| 9 | Water | Water | | Open | Closed | Open | |
| 10 | Water heater | Heater | ON | | | | |
| 11 | 2Way Valve | Water | | Open | Open | * | |
| 12 | 3Way Valve | Chemical | | Open | Closed | Closed | X |
| 13 | 3Way Valve | Water | | Open | Open | Open | |
| 14 | 3Way Valve | Water | | Open | Open | Open | |
| 15 | 3Way Valve | Chemical | | Open | Closed | Closed | X |
| 16 | 3Way Valve | Water | | Open | Open | Closed | |
| 17 | 3Way Valve | Chemical | | Open | Closed | Closed | X |
| 18 | 2Way Valve | Air | | Open | Closed | * | X |
| 19 | Pump motor | Pumping | OFF | | | | X |
| 20 | 3Way Valve | Chemical | | Open | Closed | Closed | X |
| 21 | 3Way Valve | Chemical | | Open | Closed | Closed | X |
| 22 | 3Way Valve | Air | | Open | Closed | Closed | X |
| 23 | 2Way Valve | Chemical | | Open | Closed | * | X |
| 24 | 2Way Valve | Chemical | | Open | Closed | * | X |
| 25 | 2Way Valve | Chemical | | Open | Closed | * | X |
| 26 | 2Way Valve | Chemical | | Open | Closed | * | X |
| 27 | 2Way Valve | Chemical | | Open | Closed | * | X |
| 28 | 2Way Valve | Chemical | | Open | Closed | * | X |
| 29 | 2Way Valve | Chemical | | Open | Closed | * | X |
| 30 | 2Way Valve | Chemical | | Open | Closed | * | X |
| 31 | 2Way Valve | Chemical | | Open | Closed | * | X |
| 32 | Tank heater | Heater | OFF | | | | X |

FIG. 11L is a diagram of a layout of components in an exemplary air drying and line purging cycle according to an embodiment of the present invention. The components illustrated in FIG. 11L are arranged to provide lines and nozzles suited to a air drying and line purging cycle upon command from the controller (e.g., commands sent from the controller to activate valves allocating airs (air, heated air, etc.) and pressurizing the system according to the air drying and line purging cycle). The air drying and line purging cycle is, for example, preferably applied to all lines ending in a nozzle or other final distribution point in the system. The components illustrated in FIG. 11L are individually described in Table 13A.

TABLE 13A
Exemplary Air Dry/Line Purge Cycle Components

| | |
|---|---|
| 101 | Water inlet line coupling. |
| 1102 | Water line. |
| 1103 | Strainer, sediment filter, simple filter etc. |
| 1104 | Solenoid operated 3 way valve for compressed air feed into water lines. |
| 1105 | Solenoid operated 3 way valve for water distribution to water storage tank or to bypass |
| | water storage tank completely. |
| 1106 | Water supply line to water storage tank. |
| 1107 | Water supply line to water pump bypassing water storage tank. |
| 1157 | Supply line for engine and tire cleaning chemicals. |
| 1169 | Supply line to transmit different cleaning and preserving chemicals to various part of |
| | vehicle. |
| 1178 | Solenoid operated 3 way valve to distribute compressed air through chemical lines to |
| | purge all lines of residual chemicals. |
| 1179 | Compressed air supply line. |
| 1179A | Compressed air branch line to foam generator (Note:- Not needed in design if self |
| | aspirating nozzles are used to generate foam at time of discharge of chemical from |
| | spray nozzles onto surface of vehicle. |
| 1179B | Compressed air supply line to chemical lines hookup to be used to purge chemical lines |
| | of off residual chemicals. |
| 1179C | Compressed air supply line to chemical lines hookup to be used to purge chemical lines |
| | of off residual chemicals. |
| 1180 | Compressed air branch lines to solenoid vale. |
| 1181 | Compressed air heater. |
| 1182 | Solenoid operated 2 way valve to control compressed air feed from air compressor tank |
| | into distribution lines. |
| 1183 | Air compressor motor and storage tank unit. |
| 1187 | Controller (mechanical or electronic). |
| 1188 | One way valve/coupling to connect chemical lines with compress air line thus |
| | allowing compressed air to flow into chemical lines. Chemical flow into airlines will |
| | be restricted as the coupling/valve combo allows flow only one direction. |
| 1189 | One way valve/coupling to connect chemical lines with compress air line thus |
| | allowing compressed air to flow into chemical lines. Chemical flow into air lines will |
| | be restricted as the coupling/valve combo allows flow only one direction. |

The various controlled components (e.g., valves, etc.) identified in FIG. 11L and as further described in the corresponding table are set according to programming of the controller or other control mechanism (e.g., electronics, such as a Field Programmable Gate Array (FPGA), computer device, controller, etc.). The controlled components may be set, for example, for the application of an air dry & purge water and chemical lines cycle as described in Table 13B.

TABLE 13B

| Equip | Equipment | Used | Power | Port | Port | Port | Equip |
|---|---|---|---|---|---|---|---|
| # | Type | For | Status | A | B | C | Status |
| 1 | 3Way Valve | Air/Water | | Open | Open | Open | |
| 2 | 3Way Valve | Water | | Open | Open | Closed | |
| 3 | 2Way Valve | Air | | Open | Open | * | |
| 4 | Pressurizer | Pump | ON | | | | |
| 5 | Air Heater | Heater | ON | | | | |
| 6 | Pump Motor | Pumping | OFF | | | | X |
| 7 | Water | Water | | Open | Closed | Open | |
| 8 | Water | Water | | Open | Open | Closed | |
| 9 | Water | Water | | Open | Open | Closed | |
| 10 | Water heater | Heater | OFF | | Open | | X |
| 11 | 2Way Valve | Water | | Open | Open | * | |
| 12 | 3Way Valve | Chemical | | Open | Open | Open | |
| 13 | 3Way Valve | Water | | Open | Open | Open | |
| 14 | 3Way Valve | Water | | Open | Open | Open | |
| 15 | 3Way Valve | Chemical | | Open | Open | Open | |
| 16 | 3Way Valve | Water | | Open | Open | Open | |
| 17 | 3Way Valve | Chemical | | Open | Open | Open | |
| 18 | 2Way Valve | Air | | Open | Open | * | |
| 19 | Pump motor | Pumping | OFF | | | | X |
| 20 | 3Way Valve | Chemical | | Open | Open | Open | |
| 21 | 3Way Valve | Chemical | | Open | Open | Open | |
| 22 | 3Way Valve | Air | | Open | Open | Open | |
| 23 | 2Way Valve | Chemical | | Open | Closed | * | X |
| 24 | 2Way Valve | Chemical | | Open | Closed | * | X |
| 25 | 2Way Valve | Chemical | | Open | Closed | * | X |
| 26 | 2Way Valve | Chemical | | Open | Closed | * | X |
| 27 | 2Way Valve | Chemical | | Open | Closed | * | X |
| 28 | 2Way Valve | Chemical | | Open | Closed | * | X |
| 29 | 2Way Valve | Chemical | | Open | Closed | * | X |
| 30 | 2Way Valve | Chemical | | Open | Closed | * | X |
| 31 | 2Way Valve | Chemical | | Open | Closed | * | X |
| 32 | Tank heater | Heater | OFF | * | * | * | X |

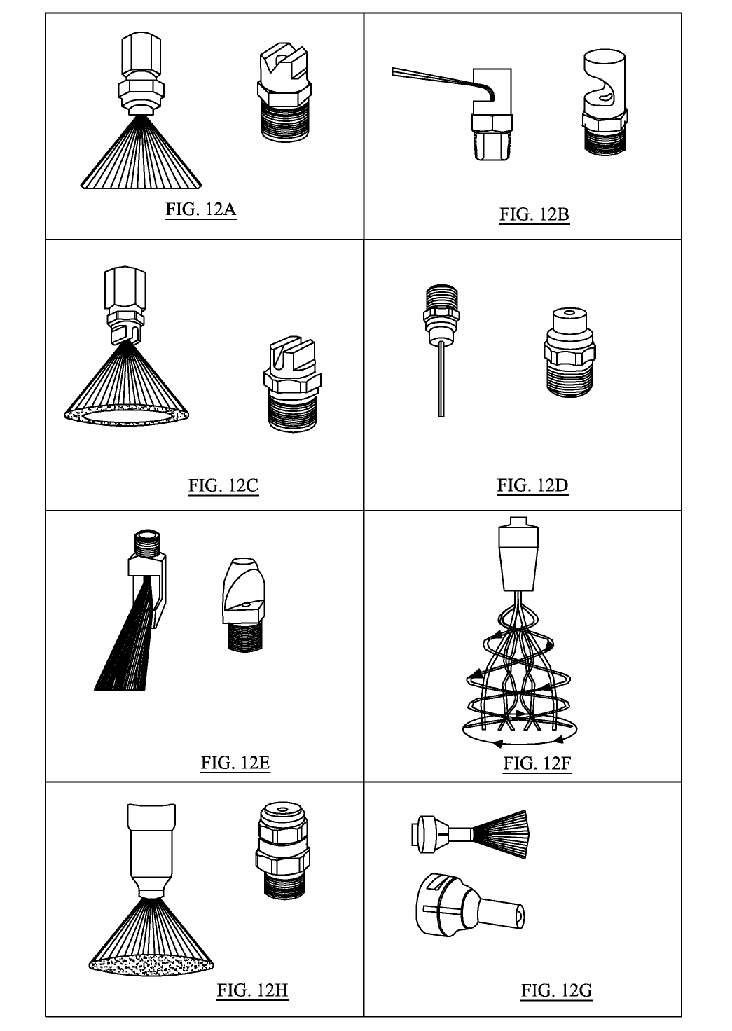

FIGS. 12A-12G are a series of drawings illustrating exemplary nozzle types that may be used alone or in any combination in various embodiments of the invention. As shown in FIG. 12A, a high impact flat fan type nozzle is provided. The high impact flat fan nozzle is utilized, for example, on lines that wash/rinse large surface areas such as any of the nozzles directed toward car body surfaces, particularly relatively large areas of flat surface. As shown in FIG. 12B, a flooding nozzle is provided. The flooding nozzle is utilized, for example, where larger volumes of liquid are required (e.g., rinse operations).

As shown in FIG. 12C, a hollow cone nozzle is provided. The hollow cone nozzle provides a circular spray pattern and is utilized, for example, on surfaces that can benefit from more than a single stream of wash/rinse fluids. The more concentrated nozzles are more effective at cleaning, but cover less surface area.

As shown in FIG. 12D, a solid stream zero degree nozzle is provided. The solid stream zero degree nozzle is utilized on surfaces that need a specific point or points to be hit with a highly directed stream (e.g., a stream directed at a crevice or spot that is typically either difficult to clean or naturally collects more residue/debris.

As shown in FIG. 12E, a high impact deflector nozzle is provided. The high impact deflector nozzle provides a deflected stream and is utilized, for example, for cleaning surfaces where the surface is at a level at or near the location of the nozzle (such that the deflected stream can reach the surface, where other nozzles would not be appropriately directed toward the surface). As shown in FIG. 12F, a high speed turbo rotating nozzle is provided. The high speed rotating turbo nozzle provides a turbulent flow of water which impacts any surfaces from different angles initiating a “brushing” like motion of the water impacting the surface. The high speed turbo rotating nozzle is utilized, for example, on surfaces that require an additional scrubbing like action for cleaning/rinsing, such as, for example, undersides or rocker arm panels of a vehicle (and/or bug strike areas, front of bumper, for mud & brake dust removal etc.). The rotation of rotating nozzles is caused by, for example, an inlet turbine wheel attached to the nozzle outlet.

As shown in FIG. 12G, a self aspirating foam generating nozzle is provided. The self aspirating foam generating nozzle provides an outlet for chemicals and liquids that, for example, should be “foamed” prior to application to vehicle surfaces, and/or for self foaming solutions that might benefit from foaming caused by design of the nozzle (e.g., foam sticking to the surface longer). As shown in FIG. 12H, a full cone (aka solid cone) nozzle is provided. The full cone nozzle is utilized, for example, where a combination of full inundation over a specific area is preferred. Such areas include, for example, wheel well interiors or other surfaces that can be effectively inundated with a full cone spray. As with all of the exemplary nozzles discussed herein, other equivalent nozzles are known in the art. The application of these specific nozzles in a self-contained automatic vehicle washing system as described herein includes specifically identified and other equivalent combinations of such nozzles and/or their equivalents provide an efficient and effective automated self contained washing system.

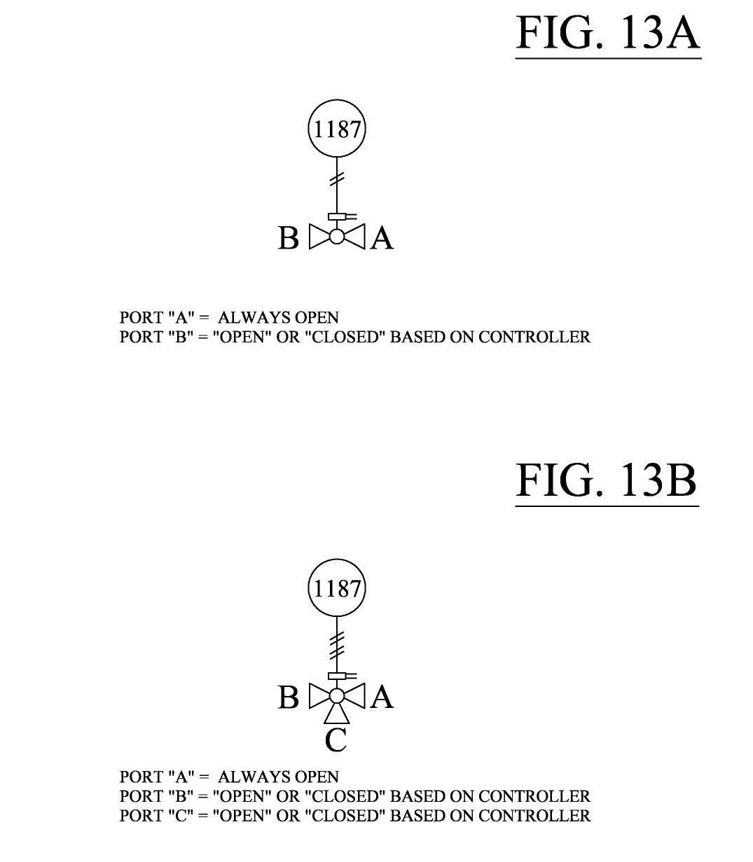

FIG. 13A is a diagram of a two-way valve (e.g., solenoid operated) utilized as a component in various parts of different embodiments of the present invention. Other types of valves may be utilized, for example, motor, pneumatic, or hydraulically driven valves.

FIG. 13B is a diagram of an exemplary 3-way solenoid valve utilized as a component in various parts of different embodiments of the present invention. The valve is, for example, a Johnson Controls 3-way valve ½″ with solenoid activation. Other 3-way valves, or configurations of two-way valves appropriately configured may be substituted therewith.

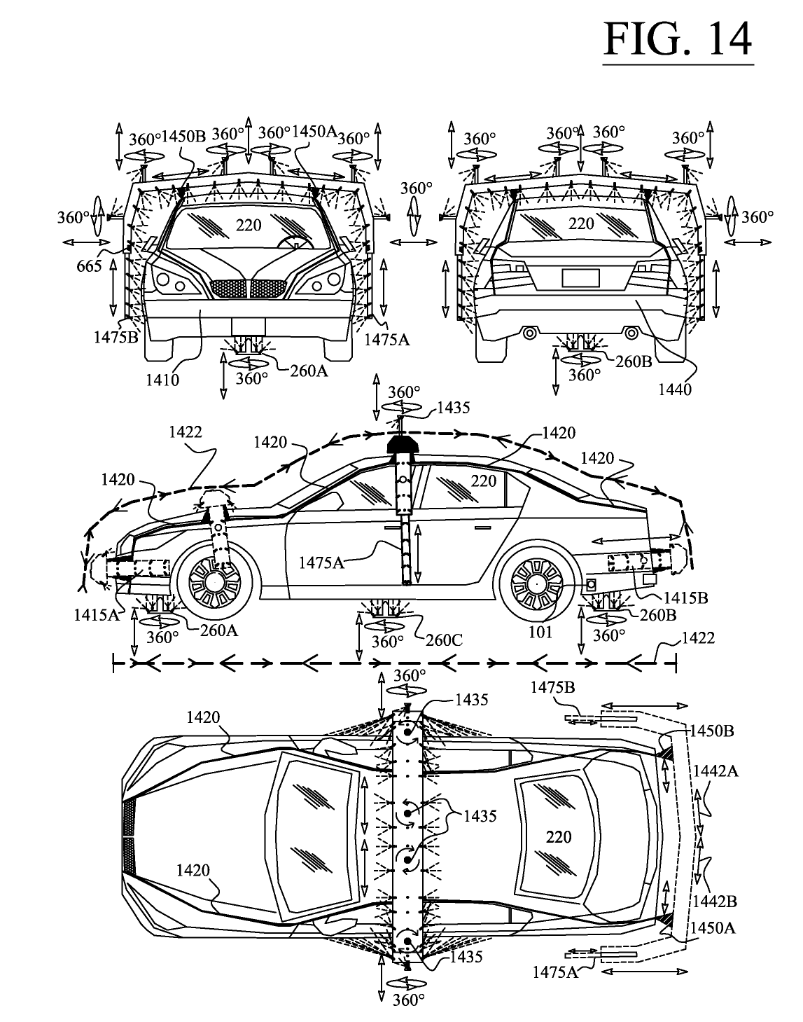

FIG. 14 is a diagram of a front/rear bumper stored washing system according to an embodiment of the present invention. A front bumper 1410 is fitted with a moveable arm 1415 that is set on a track 1420. The moveable arm 1415 is stored, for example, in a storage area 1415A in the front bumper. The moveable arm 1415 includes spray nozzles attached to one or more lines of a washing system similar to other spray lines discussed above. The washing system is operated so that the spray nozzle discharge the appropriate fluids (according to the current cycle) and the entire arm is moved across the surface of the vehicle being washed (essentially traveling all or part of path 1422).

The moveable arm may include, for example, extensions 1475 (1475A and 1475B, for example) that drop downward so that vertical surfaces are also washed. The drop down portions of the moveable arm are extended using programmable stops such that the extensions 1475 are made to match the height of vertical surfaces of the vehicle as the arm moves across the top surface of the vehicle. The programmable stops are controlled, for example, by programming in the controller and instructions sent from the controller to solenoids or other devices to control the stops. The drop downs are extended, for example, by water/air pressure that forces one or more drop downs into position once their corresponding stops release them. The drop downs retract, for example, via a spring or other return mechanism once water pressure is removed.

In one embodiment, turbo rotating nozzles 1435 pop-up, or, alternatively, pop-down from the arm. At the end of the cycle, the moveable arm is returned to the front bumper storage area, or, alternatively, is stored in a similar storage area 1415B of the rear bumper 1440.

As shown in FIG. 14, track 1420 includes one or more rails rollably affixed to the arm 1415. The rails are not necessarily equidistant for the entire length of the track. For this reason, arm 1415 is preferably constructed in sections that can slide in and out to accommodate amounts of expansion (e.g. width expansion as illustrated by arrows 1442A and 1442B) at least equivalent to differences in spacing of the rails of track 1420. Legs 1450A and 1450B are slidably attached to the track to carry the arm in its movement 1422 across the vehicle's surface.

Although the present invention has been described herein with reference to a more general vehicle washing system, it should be evident that the description provided herein has great advantages for cars and other vehicles (e.g., all types of road and off-road vehicles, and marine/aviation applications), particularly those that operate in environments where frequent washes or rinses not only keep the vehicle or other equipment clean, but in better operable condition. Such examples include northern climates where various chemicals and salts are utilized to remove ice from road surfaces (and being very caustic to car bodies). Other climates include desert environments where granular sand particles cause great wear and tear on mechanical parts. All such environments benefit greatly from the ability of quick wash, rinse, and/or application of a protectorant extending the life of components and keeping the vehicle in top condition. The extension of component lifetimes could allow manufacturers to offer increased warranties or reduce payments to service vehicles in warranty.

Thus, in a very useful and specific embodiment, the present invention is generally applied to automobiles, specifically upper end market cars which are meticulously maintained, and commercial, industrial and military vehicles where maintenance, reliability in demanding environments are valued at a premium. Nevertheless, less extensive implementations of the invention are clearly advantageous for lower end automobile markets as well where similar advantages will accrue. Other applications may also be provided for watercraft (and/or watercraft trailers), including ships, combat vehicles, tanks, and armored personnel carriers, etc., aircraft, including fixed wing and helicopters, trucks, and other vehicles. In aircraft applications, de-icing fluid can be sprayed on wings and rotor(s) or rotor blade surfaces in icing conditions. De-icing applications whether for aircraft, automobiles, or other vehicles may utilize de-icing fluid(s) stored in a tank (external or internal) and/or a hot air blast (e.g., from engine bleed air, exhaust manifold heat transfer, heater, or other sources). Such other applications will, for example, utilize a specific feature of the invention and be at least partly constructed from the technologies described herein.

Further, the advantages of the invention, particularly reduced maintenance and improved appearance save money on repairs and improve the overall reputation for quality amongst fleet maintenance vehicles. The invention is therefore more advantageous to municipal vehicles or fleet vehicle operators such as rental car companies, utility companies, service companies, installers, trucking companies, etc.

Various embodiments include, for example, a self-contained built-in automatic vehicle washing system. The self-contained built-in automatic washing system may include many other features including, for example, a plurality of pop-up devices each having, for example, at least one spray nozzle attached to the pop-up, and a delivery line coupled to the pop-up. The system may also include a moveable bar assembly having a pressurizable liquid feed line coupled to a plurality of liquid spray nozzles, the moveable bar configured for storage in a compartment of the vehicle and to be automatically removed from the compartment and operated to spray washing liquids delivered via the pressurizable liquid feed line to the plurality of liquid spray nozzles according to at least one wash cycle implemented by a control device. The control device is, for example, a programmable controller and the compartment is located in a bumper of the vehicle.

In one embodiment, the invention comprises a self-contained built-in automatic vehicle washing system that includes a main wash reservoir, a plurality of wash nozzles, a delivery system coupled to the main wash reservoir and the wash nozzles and configured to deliver liquid from the main reservoir to the wash nozzles, a pressure mechanism configured to pressurize the delivery system, and a control device configured to operate the pressure mechanism and delivery system in a manner according to at least one wash cycle configured to wash at least one of an undercarriage and painted surfaces of the vehicle. In other embodiments all non-interior washable surfaces are cleaned, including about glass and non-painted surface (i.e. chrome, rubber, plastics, aluminum finish etc).

In one embodiment, the at least one wash nozzle comprises a plurality of wash nozzles, and the wash nozzles are arranged such that when pressurized liquid is delivered to the wash nozzles according to at least one wash cycle, all areas of the vehicle including non-glass exterior surfaces to be washed are inundated with liquid spray from the wash nozzles. In another embodiment, the control device is configured to operate the pressure mechanism and delivery system in a manner according to at least one wash cycle and at least one rinse cycle. In yet another embodiment, the at least one wash nozzle is mounted on a moveable support member. The moveable support member comprises, for example, a tube slidably mounted under and parallel to a rocker arm panel of the vehicle and/or an extension arm that rotates around a pivot point. In one embodiment, the moveable support member is mounted on a second moveable support member that is slidably mounted at a rocker arm area of the vehicle.

In various embodiments, the control device is configured to initiate a series of wash cycles. The series of wash cycles include, for example, an undercarriage wash cycle engaging a plurality of wash nozzles under the vehicle, an exterior wash cycle that washes all exterior surfaces of the vehicle normally visible to the general public (public bystanders), a tire cleaning cycle, and a wax cycle. The exterior wash cycle includes, for example, pre-soak and wash phases. At least one wash cycle includes, for example, impact area wash times wherein system pressure and washing power are concentrated on difficult cleaning areas of the vehicle including a front impact areas (such as a front bumper, grille, front of side rear view mirror, etc.) and lower panel impact areas.

In various embodiments, the invention can be practiced as a method (or embodied as a device capable of performing the method). The method comprising, for example, the steps of pressurizing a self-contained built-in vehicle washing system configured to wash at least one of exterior painted surfaces of the vehicle and an undercarriage area of the vehicle, and activating at least one wash cycle for the wash. The at least one wash cycle may comprise, for example, a plurality of cycles including, for example, a pre-soak cycle, an exterior surfaces wash cycle, an undercarriage wash cycle, a tire wash cycle, a dry cycle, and a protectorant cycle. Any of the cycles may include sub-cycles. For example, the wash cycle may include sub-cycles of soaking, washing and rinsing. The step of activating at least one wash cycle may include, for example, activating at least one wash head.

The step of pressurizing may include, for example, activating a pressurizer attached to assorted lines connecting a wash tank to a plurality of wash heads. The at least one wash cycle may include, for example, activation of a rotatable feed mechanism having a series of wash heads mounted thereon which are fed liquid from the pressurized system through a channel in the rotatable feed mechanism, and the rotating feed mechanism is slidably mounted underneath the vehicle and configured to slide out from underneath the vehicle and rotate causing the mounted wash heads to rotate and impact predetermined areas of the vehicle. The step of activating at least one wash cycle may comprise, for example, activating a series of wash cycles including chemical pre-soak, wash, engine shampoo, rinse, total body protectorant, and wax cycles.

The methods according to the present invention may be embodied, for example, in a set of computer instructions stored on a computer readable media. The computer instructions, when loaded into a computer, cause the computer to monitor pressure in the system and activate a pressurizer to maintain system pressure at an operational level consistent with a current wash cycle, activate a series of wash cycles comprising opening valves to allow specific chemicals including at least one of solvents, cleansers, and waxes consistent with a current wash cycle to flow through selected wash heads in time per the current wash cycle. In one embodiment, the set of instructions, when loaded into the control device, further cause the control device to issue instructions to each of a heater and a pressurizer according to at least one of the wash cycles. In yet another embodiment, the set of instruction control pressurization and flow of fluids to a moveable washing arm or wand in a stationary position under the car as part of an undercarriage wash cycle. The control device is, for example, one of a computer, a commercially available controller, and a set of programmable electronics.

Typically, the computer instructions are either compiled computer instructions stored as an executable program on the computer readable media or line item interpretable instructions, and may, for example, comprise a controller specific program language or instructions. As such, in another embodiment, the invention may be aptly described as a readable media having a set of instructions stored thereon that, when loaded into a control device, cause the control device to issue instructions to a plurality of control valves so as to implement a plurality of wash cycles in a self-contained built-in vehicle washing system.

In another embodiment, the invention is a self-contained, built-in, automatic vehicle washing system, having a wash reservoir, wash nozzles disposed at various locations relative to the vehicle, a delivery mechanism coupling the wash reservoir and the wash nozzles, chemical reservoirs configured to interject at least one chemical into a flow from the wash reservoir to the wash nozzles, a water treatment device configured to treat liquid prior to exiting at least one wash nozzle, a pressurizer configured to pressurize the vehicle washing system, a series of valves configured to turn-on and shut-off channels within the delivery system, and a controller configured to activate the pressurizer according to an amount of pressure in the vehicle washing system and activate the series of valves to supply the wash heads with high pressure flow from the reservoirs according to a wash cycle. The delivery system includes, for example, at least one moveable arm assembly having a plurality of wash heads mounted thereon and configured to move across at least one surface of the vehicle.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing a wash nozzle, a rotating turbo wash nozzle is utilized as an example. However, any other equivalent device in the general category of wash nozzles, spray heads, sponges, brushes, or other devices having an equivalent function or capability, whether or not listed herein, may be substituted therewith. All other described items, including, but not limited to compressors, pressurizers, pressure boosters, pumps, connectors, valves, controllers, displays, buttons, wireless communications, foam generators, hoses, high pressure hoses, lines, pipes, and fittings, nozzles, fluids, tanks, etc. should also be considered in light of any and all available equivalents.

Portions of the present invention may be conveniently implemented using a conventional general purpose or a specialized digital computer, microprocessor, or controller programmed according to the teachings of the present disclosure, as will be apparent to those skilled in the computer art.

Appropriate software coding can readily be prepared by skilled programmers based on the teachings of the present disclosure, as will be apparent to those skilled in the software art. Portions of the invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CD or DVD RW+/−, micro-drive, and magneto-optical disks, ROMs, RAMs, EPROMs, EEPROMs, DRAMs, VRAMs, flash memory devices (including flash cards, memory sticks), magnetic or optical cards, SIM cards, MEMS, nanosystems (including molecular memory ICs), RAID devices, remote data storage/archive/warehousing, or any type of media or device suitable for storing instructions and/or data. The computer program product is, for example a memory chip located in (or external and coupled to) the controller.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, pressurizing a self-contained built-in vehicle washing system, activating one or more wash cycles, sub-cycles and/or phases according to pre-determined timing, activating at least one wash head, controlling valves according to a desired activation (e.g., on/off, flow/pressure control, etc), rotating wash heads according to a predetermined pattern, moving wash heads according to a predetermined pattern and rotating the heads to a desired spray pattern and to avoid obstructions protruding from a vehicle (such programming works, for example, to prevent any impact of the washing system (other than application of the treatment) with the protrusion), activating a series of wash cycles including chemical pre-soak, wash, rinse, and wax cycles, opening valves to allow specific chemicals including at least one of solvents, cleansers, and waxes consistent with a current wash cycle to flow through selected wash heads in time per the current wash cycle, and the display, storage, or communication of results according to the processes of the present invention.

Other variations are possible on the above-described embodiments. Examples of such variations include, among other things, the following:
1. Moisture sensors inside vehicles:—Within remote spaces, e.g., body panels and inaccessible compartments i.e. inside wings, body panels, door panels, electrical boxes, trunk, and the like, moisture sensors may be used to monitor trapped moisture or humid air inside these spaces known trap moisture that accelerates the rate of corrosion. If moisture and humidity levels exceed programmed perimeters due to blocked drain holes or a high humidity environment then the system can activate a suction pump to draw out trapped moisture through placement of suction tubes or heads within the panels, and once the moisture is drawn out, dehumidified hot or cold air can be pumped in to the panels through the same drain tubes for drying and dehumidification function. This feature will ensure a dry and humidity free environment within the panels and reduce or eliminate the rate of corrosion, before evacuation of moisture or periodically, especially after usage in high humidity environment, snow and wet road surfaces, panels can be washed/rinsed prior to moisture evacuation to wash away the salts and corrosion causing contaminants followed by drying. Final function may employ the application of moisture displacement and corrosion control coatings within the panels. Exception to this would be electrical panels, which can be de-humidified and sprayed with moisture repellent coatings, and the wash/rinse function can be skipped altogether. The same battery of spray heads and tubes can achieve all functions.
2. Temperature sensors and temperature control devices (e.g., heating or cooling mechanisms) placed in all the above noted panels may be used to control/maintain preprogrammed temperatures inside the vehicle and within the panels will eliminate damage caused to wiring, seals and panel interior and exterior coating finishes as a result of temperature extremes, and contraction and expansion for example interior of panels coated with rust proofing during low temperatures may experience shrinkage, cracking and brittleness, cracks expose the structure and trap moisture which accelerated the rate corrosion. During high temperature metal body panels conduct heat at a greater rate then the rust proofing resulting in higher expansion than the rust proofing thus compromising the bond and again resulting in cracks. These cracks expose the panels to moisture and humidity leading to corrosion. Cracked seals due to expansion and contraction in temperature extremes cause the seal function to fail with damaging effects by allowing moisture and humid air to penetrate the protected areas and cause corrosion or leakage. Case in point the space shuttle disaster in 1985 was caused by failed seals in the solid rocket boosters due to temperature extremes caused a seals to crack. Military and civilian aircraft require millions of dollars a year of replacement seals and corrosion repairs due to water and moisture penetration around failed seals of antennas.
3. Both of the above noted functions can be powered by the on board equipment or by external hook up of suction pumps, spray pumps, dehumidified air source and temperature controlled air functions will be useful during short and long term storage of military and commercial vehicles, and aircrafts and equipment whereby a central system can be hooked up to multiple vehicles, aircrafts and equipment can undergo continuous corrosion control treatment.
4. The de-icing function described above may include the use of hot water, e.g., to melt snow, in addition to hot air and de-icing fluid.
5. Embodiments of this system are important for Aircraft washing as well as military ground and marine equipment as opposed to only for commercial vehicles and passenger cars.

Furthermore, it is worth noting that aircraft often experience extreme temperature and humidity environments. For example when flying at cruising altitude extreme cold and dry conditions are encountered, say at 35,000 feet AGL minus −45° F. and perhaps 5% or less humidity. As the aircraft descends into warmer temperatures close to the ground temperatures as high as 90° F. and humidity in excess of 80% is experienced, this temperature and humidity change causes condensation on the surface as well as in interior panels of aircraft, while the aircraft is on the ground the trapped moisture starts to corrode interior surfaces. After landing if the interior panels are washed/rinsed and dried by a ground hook up unit the service life of the aircraft may be increased drastically and will eliminate costly tear down to inspect and repair interior surfaces. Inspection cameras may be installed in strategic locations inside body panels and wing panels to inspect the condition of those areas with out taking apart the panels.

The present invention may suitably comprise, consist of, or consist essentially of, any of element (the various parts or features of the invention as described herein and their equivalents. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

What is claimed is:

1. A self-contained built-in automatic washing system configured to wash all exterior surfaces of a vehicle, comprising:
a plurality of pop-up devices installed in a vehicle, each having, at least one spray nozzle attached to the pop-up, and a delivery line coupled to the pop-up; and
one or more moisture sensors located inside one or more remote spaces inside a vehicle.

2. The self-contained built-in automatic vehicle washing system of claim 1, further comprising means operable in response to said moisture sensors for removing trapped moisture from the one or more remote spaces inside the vehicle.

3. The self-contained built-in automatic vehicle washing system of claim 2 further comprising means for supplying de-humidified air to said one or more spaces inside the vehicle.

4. The self-contained built-in automatic vehicle washing system according to claim 1, further comprising one or more temperature sensors and one or more temperature control devices placed in one or more remote spaces inside the vehicle, wherein the temperature sensors and temperature control devices are configured to control or maintain predetermined temperatures inside the vehicle and within the remote spaces.

5. The self-contained built-in automatic vehicle washing system according to any of claim 1, 2, 3 or 4, further comprising one or more fluid passages coupled at a first end to the one or more remote spaces and configured to be coupled at a second end to a spray pump, suction source, temperature controlled air source or moisture controlled air source.

6. The self-contained built-in automatic vehicle washing system according to claim 1, further comprising means for introducing de-icing liquids or hot air to one or more surfaces of the vehicle.

7. A self-contained built-in automatic vehicle washing system, comprising:
a moveable bar assembly having a pressurizable liquid feed line coupled to a plurality of liquid spray nozzles, the moveable bar configured for storage in a compartment of the vehicle and to be automatically removed from the compartment and operated to spray washing liquids delivered via the pressurizable liquid feed line to the plurality of liquid spray nozzles according to at least one wash cycle implemented by a control device; and
one or more moisture sensors located inside one or more remote spaces inside the vehicle.

8. The self-contained built-in automatic vehicle washing system of claim 7, further comprising means operable in response to said moisture sensors for removing trapped moisture from the one or more remote spaces inside the vehicle.

9. The self-contained built-in automatic vehicle washing system of claim 8 further comprising means for supplying de-humidified air to said one or more spaces inside the vehicle.

10. The self-contained built-in automatic vehicle washing system according to claim 7, further comprising one or more temperature sensors and one or more temperature control devices placed in one or more remote spaces inside the vehicle, wherein the temperature sensors and temperature control devices all the above noted panels are configured to control or maintain predetermined temperatures inside the vehicle and within the remote spaces.

11. The self-contained built-in automatic vehicle washing system according to any of claim 7, 8, 9 or 10, further comprising one or more fluid passages coupled at a first end to the one or more remote spaces and configured to be coupled at a second end to a spray pump, suction source, temperature controlled air source or moisture controlled air source.

12. The self-contained built-in automatic vehicle washing system according to claim 7, further comprising means for introducing de-icing liquids or hot air to one or more surfaces of the vehicle.

13. A self-contained built-in automatic vehicle washing system, comprising:
a main wash reservoir installed in a vehicle;
a plurality of wash nozzles installed in the vehicle;
a delivery system coupled to the main wash reservoir and the wash nozzles and configured to deliver liquid from the main reservoir to the wash nozzles;
a pressure mechanism configured to pressurize the delivery system;
a control device configured to operate the pressure mechanism and delivery system in a manner according to at least one wash cycle configured to wash at least one of an undercarriage and painted surfaces of the vehicle; and
one or more moisture sensors located inside one or more remote spaces inside the vehicle.

14. The self-contained built-in automatic vehicle washing system of claim 13, further comprising means operable in response to said moisture sensors for removing trapped moisture from the one or more remote spaces inside the vehicle.

15. The self-contained built-in automatic vehicle washing system of claim 14 further comprising means for supplying de-humidified air to said one or more spaces inside the vehicle.

16. The self-contained built-in automatic vehicle washing system according to claim 13, further comprising one or more temperature sensors and one or more temperature control devices placed in one or more remote spaces inside the vehicle, wherein the temperature sensors and temperature control devices all the above noted panels are configured to control or maintain predetermined temperatures inside the vehicle and within the remote spaces.

17. The self-contained built-in automatic vehicle washing system according to any of claim 13, 14, 15, or 16, further comprising one or more fluid passages coupled at a first end to the one or more remote spaces and configured to be coupled at a second end to a spray pump, suction source, temperature controlled air source or moisture controlled air source.

18. The self-contained built-in automatic vehicle washing system according to claim 13, further comprising means for introducing de-icing liquids or hot air to one or more surfaces of the vehicle.
